(19) United States
(12) Patent Application Publication
(10) Pub. No.: US 2025/0043032 A1
(43) Pub. Date: Feb. 6, 2025

(54) FUNCTIONALIZED CYCLODEXTRIN MONOMER AND POLYMER FOR WATER REMEDIATION

(71) Applicants: Northwestern University, Evanston, IL (US); Cornell University, Ithaca, NY (US)

(72) Inventors: William Robert Dichtel, Evanston, IL (US); Damian E. Helbling, Ithaca, NY (US); Ri Wang, Ithaca, NY (US); Max Justin Klemes, Evanston, IL (US)

(21) Appl. No.: 18/716,928

(22) PCT Filed: Dec. 6, 2022
(86) PCT No.: PCT/US2022/081043

§ 371 Date: Jun. 5, 2024

Related U.S. Application Data
(60) Provisional application No. 63/265,022, filed on Dec. 6, 2021.

(51) Int. Cl. C08B 37/16; B01J 20/26; C02F 1/28; C02F 101/36; C08L 5/16

(52) U.S. Cl. CPC C08B 37/0012; B01J 20/267; C02F 1/285; C08L 5/16; C02F 2101/36

(57) ABSTRACT

Disclosed herein are mesoporous polymeric materials and methods for preparing and using the same. The mesoporous polymeric material comprises a network of cyclodextrin moieties crosslinked by a plurality of crosslinks.

### CROSS-REFERENCE TO RELATED APPLICATIONS

This application claims benefit of priority to U.S. Patent Application Ser. No. 63/265,022, filed Dec. 6, 2021, the contents of which is incorporated by reference in its entirety.

### STATEMENT REGARDING FEDERALLY FUNDED RESEARCH

This invention was made with government support under Grant No. ER18-1026 awarded by the Department of Defense. The government has certain rights in the invention.

### BACKGROUND

Per- and polyfluoroalkyl substances (PFASs) are fluorinated surfactants¹⁻⁴ applied in industrial processes⁵⁻⁷ (e.g., pesticide formulations, waterproofing textiles, and oil production) and consumer products⁸⁻⁹ (e.g., cosmetics, firefighting foams and food packaging). Their manufacture and use have contaminated water resources around the world, and their bioaccumulative nature, toxicity at low levels of chronic exposure, and environmental persistence motivate efforts to prevent and remediate PFAS contamination.^{4, 10-12} Anionic perfluorocarboxylic acids (PFCAs) and perfluorosulfonic acids (PFSAs) are the most widely detected classes of anionic PFASs, whose structures include long-chain derivatives, such as the eight carbon perfluorooctanoic acid (PFOA) and perfluorooctanesulfonic acid (PFOS), and short-chain derivatives, such as the four-carbon-containing perfluorobutanoic acid (PFBA) and perfluorobutanesulfonic acid (PFBS). The short-chain PFASs are now also widespread and are more mobile in the environment, and more resistant to degradation or removal efforts than long-chain PFASs.³ Conventional adsorbents, such as activated carbons (ACs),¹³⁻¹⁵ ion exchange resins,¹⁵⁻¹⁶ and inorganic minerals¹⁷⁻¹⁹ have been widely studied and applied for PFAS removal. However, these adsorbents generally suffer from shortcomings, such as moderate or low affinity for long- and short-chain PFASs, and fouling by dissolved natural organic matters and inorganic constituents found in natural and engineered water systems.²⁰⁻²³ As a result, there exists a need for new polymeric material as efficient adsorbents for per- and polyfluoroalkyl substances (PFASs).

### SUMMARY OF THE INVENTION

Disclosed herein are mesoporous polymeric materials and methods for preparing and using the same. One aspect of the invention provides for a mesoporous polymeric material comprising a network of cyclodextrin moieties crosslinked by a plurality of crosslinks. The network comprises

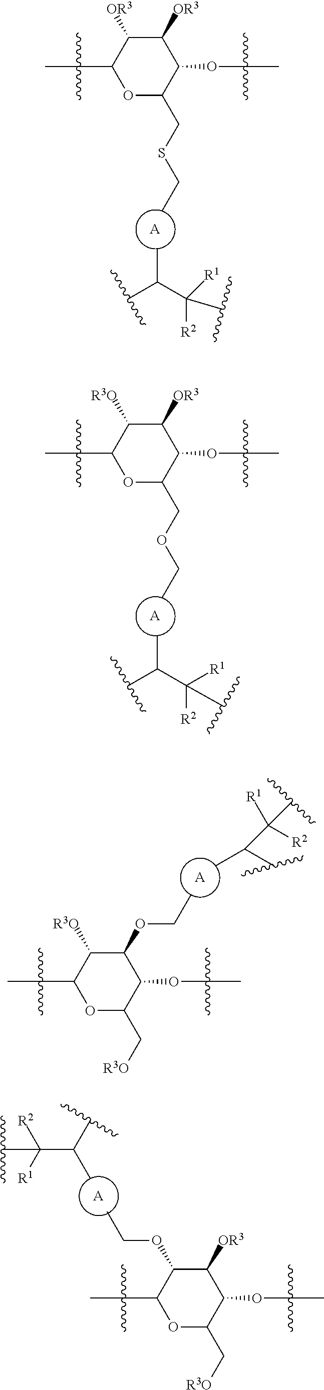

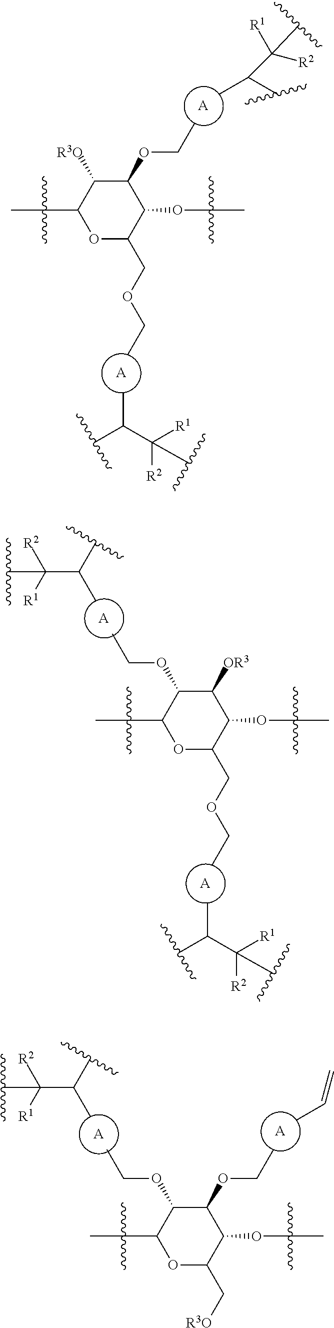

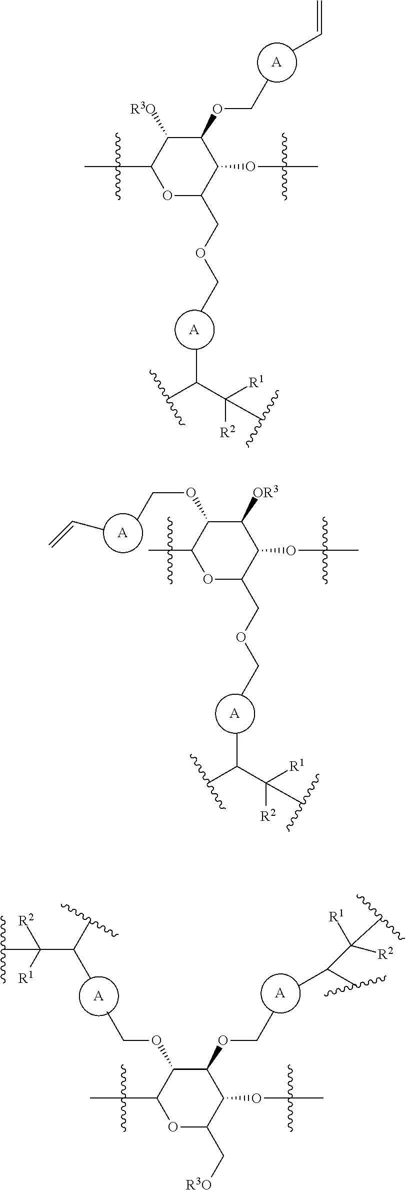

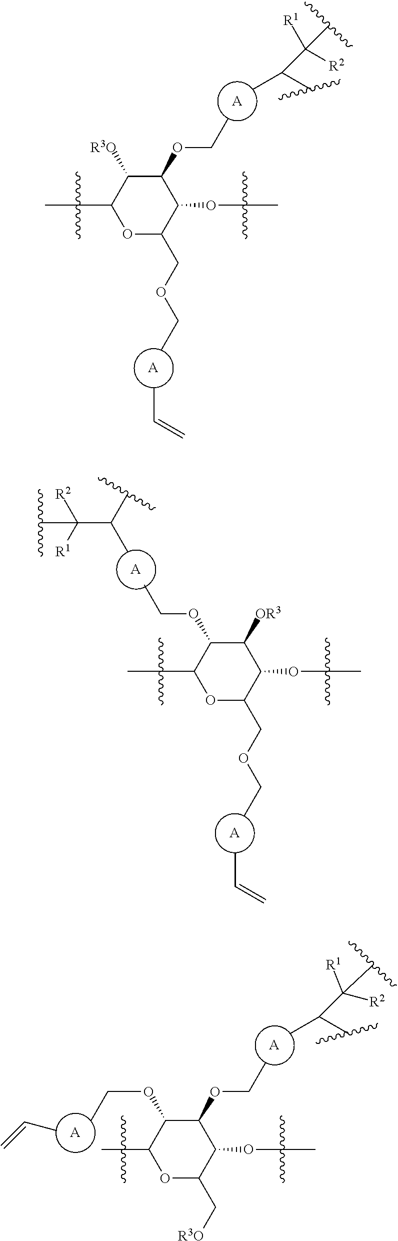

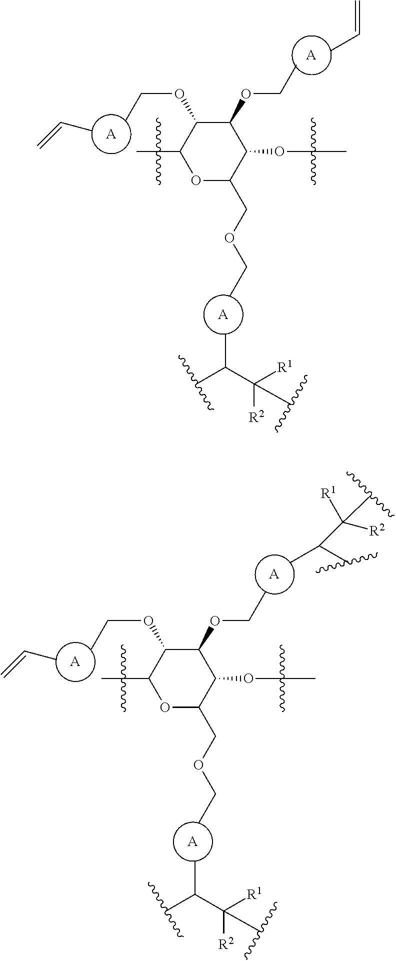

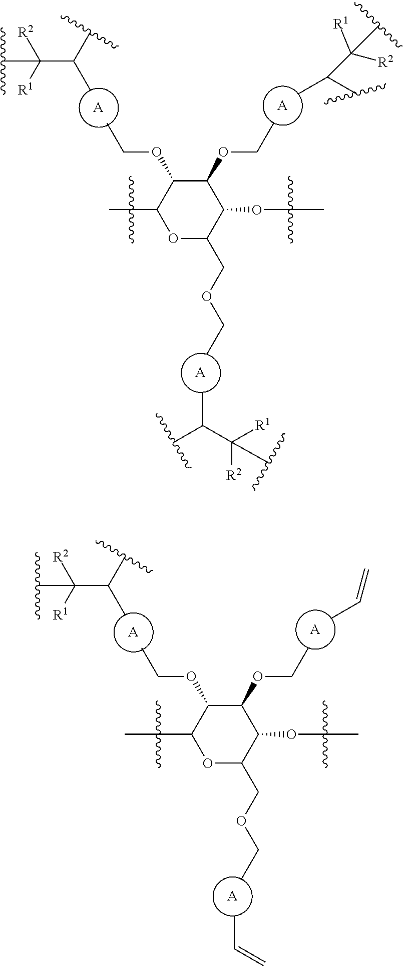

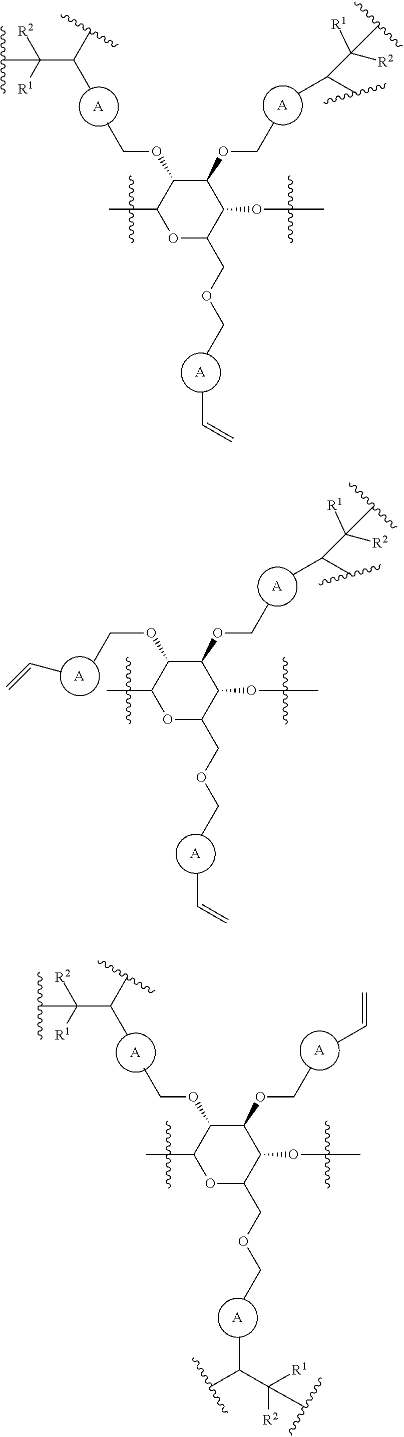

or any combination thereof. A is an unsubstituted or substituted aryl or unsubstituted or substituted heteroaryl. R¹ and R² are independently —C(═O)OR⁴, an unsubstituted or substituted alkyl, an unsubstituted or substituted aryl, an unsubstituted or substituted heteroaryl, or hydrogen. R³ is independently selected from hydrogen, alkyl, hydroxyalkyl, alkanoyl, or carboxyalkyl. R⁴ is a substituted or unsubstituted alkyl,

Another aspect of the invention provides for purifying a fluid sample comprising one or more pollutants. The method comprises contacting the fluid sample with the mesoporous polymeric material as described herein. The methods disclosed herein may be used to adsorb at least 50 wt % of the total amount of the one or more pollutants in the fluid sample.

Another aspect of the invention provides for a method of preparing a mesoporous polymeric material comprising a network of cyclodextrin moieties crosslinked by a plurality of crosslinks. The method comprises contacting a functionalized cyclodextrin monomer with a comonomer in the presence of a free radical initiator under conditions sufficient to prepare the network of cyclodextrin moieties crosslinked by a plurality of crosslinks. The functionalized cyclodextrin monomer comprises

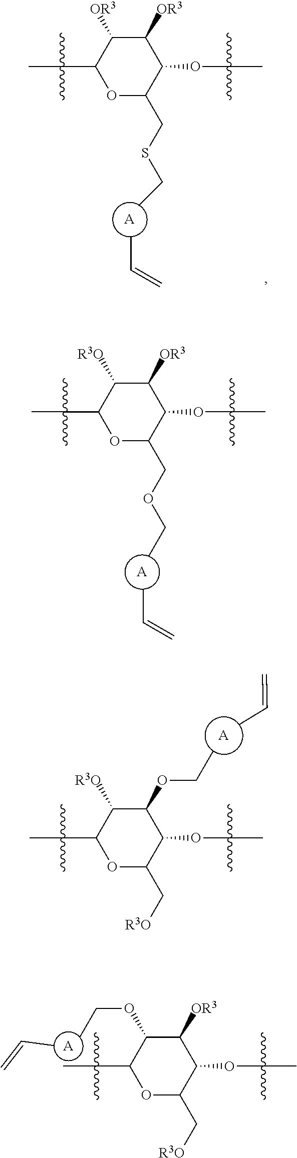

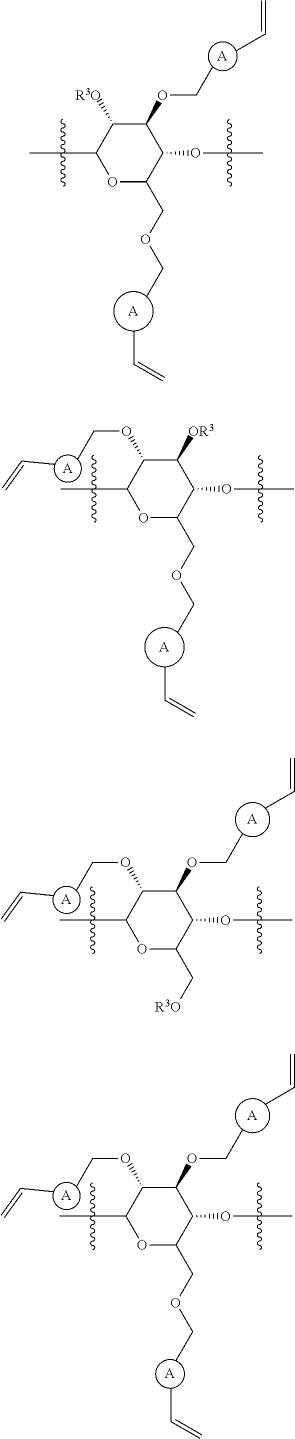

or any combination thereof. The comonomer comprises a formula of

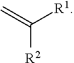

A is an unsubstituted or substituted aryl or unsubstituted or substituted heteroaryl. R¹ and R² are independently —C(═O)OR⁴, an unsubstituted or substituted alkyl, an unsubstituted or substituted aryl, an unsubstituted or substituted heteroaryl, or hydrogen. R³ is independently selected from hydrogen, alkyl, hydroxyalkyl, alkanoyl, or carboxyalkyl. R⁴ is a substituted or unsubstituted alkyl,

These and other aspects and embodiments of the invention will be further described herein.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 shows the removal of 1 μg L⁻¹ PFCAs by 10 mg L⁻¹ of (A) 4, (B) 5, and (C) 6 in nanopure water (NP, blue bar) and 1 mM Na₂SO₄ (SS, purple bar) after 48 h of contact time. The x-axis denotes PFCAs of different chain lengths. For example, C4 refers to PFBA.

FIG. 2 illustrates the removal of 1 μg L⁻¹ PFCAs and PFSAs by 1 mg L⁻¹ of 6 in nanopure water (NP, blue bar) and 1 mM Na₂SO₄ (SS, purple bar) after 48 h of contact time. The x-axis denotes PFASs of different chain lengths. For example, C4 refers to PFBA for (A) and PFBS for (B).

FIG. 3 shows the removal of 1 μg L⁻¹ PFCAs by 1 mg L⁻¹⁶ in nanopure water (NP, blue bar), 1 mM Na₂SO₄ (SS, purple bar), 2 mM NaCl (SC, green bar), and 1 mM CaCl₂ (CC, yellow bar) after 48 h contact time. The x-axis denotes PFCAs of different chain lengths. For example, C4 refers to PFBA.

FIG. 4 shows ¹H NMR spectrum (500 MHz, 298K, DMSO-d₆) of 3.

FIG. 5 shows ¹³C NMR spectrum (126 MHz, 298K, DMSO-d₆) of 3.

FIG. 6 shows HRMS of 3 in chloroform.

FIG. 7 shows solid State ¹³C NMR spectrum (400 MHz, 298K, Adamantane/KBr) of 4 (bottom) with respect to solution ¹³C NMR spectra of 3 (top) and comonomer styrene (middle). The lack of vinyl carbons of 3 and comonomer (113 ppm) and broadened alkane region of polymer backbone (55-20 ppm) in the spectrum of 4 indicates successful polymerization. Black dotted line was added for clarity.

FIG. 8 shows solid State ¹³C NMR spectrum (400 MHz, 298K, Adamantane/KBr) of 5 (bottom) with respect to solution ¹³C NMR spectra of 3 (top) and comonomer methyl methacrylate (middle). The presence of carbonyl carbon of comonomer (180 ppm), the lack of vinyl carbon of 3 (113 ppm), broadened alkane region of polymer backbone (55-20 ppm), and the lack of vinyl carbon of comonomer (20 ppm) in the spectrum of 5 indicate successful polymerization. Black dotted lines were added for clarity.

FIG. 9 illustrates solid State ¹³C NMR spectrum (400 MHz, 298K, Adamantane/KBr) of 6 (bottom) with respect to solution ¹³C NMR spectra of 3 (top) and comonomer (2-(methacryloyloxy)ethyl]trimethylammonium chloride) (middle). The presence of carbonyl carbon of comonomer (180 ppm), the lack of vinyl carbon of 3 (113 ppm), the presence of N—(CH₃)₃ of comonomer (55 ppm), broadened alkane region of polymer backbone (55-20 ppm), and the lack of vinyl carbon of comonomer (20 ppm) in the spectrum of 6 indicate successful polymerization. Black dotted lines were added for clarity.

FIG. 10 shows FT-IR spectrum of 3.

FIG. 11 shows FT-IR spectrum of 4.

FIG. 12 shows FT-IR spectrum of 5.

FIG. 13 shows FT-IR spectrum of 6.

FIG. 14 shows N₂ adsorption and desorption isotherms of 4 at 77 K.

FIG. 15 shows N₂ adsorption and desorption isotherms of 5 at 77 K.

FIG. 16 shows N₂ adsorption and desorption isotherms of 6 at 77 K.

FIG. 17 shows the removal of 40 mg L⁻¹ PFOA by 40 mg L⁻¹ of 5 with various equivalencies of comonomer in nanopure (NP) water and in 1 mM Na₂SO₄ (SS) after 48 h of contact time. For example, 5_0.5 denotes half equivalent of MMA, respect to one equivalent of 3, used in the polymerization.

FIG. 18 shows the removal of a mixture of PFCAs at 1 μg L⁻¹ each by 100 mg L⁻¹ of (A) 4 and (B) 5 in nanopure water (NP) matrix and 1 mM Na₂SO₄ (SS) matrix after 48 h of contact time.

FIG. 19 illustrates the removal of a mixture of PFSAs at 1 μg L⁻¹ each by 100 mg L⁻¹ of (A) 4 and (B) 5 in nanopure water (NP) matrix and 1 mM Na₂SO₄ (SS) matrix after 48 h of contact time.

FIG. 20 illustrates Scheme 1, a synthetic scheme of styrene-functionalized cyclodextrin monomer and polymers.

FIG. 21 illustrates Scheme 2, a synthetic scheme of styrene-functionalized cyclodextrin (StyDex) monomer and polymers.

FIG. 22 shows TrOCs from this study fall under three general classes: (A) industrial surfactants and flame retardants, (B) food and beverage additives that are also common indicators of anthropogenic pollution, and (C) common household pharmaceuticals. The contaminants are depicted in their protonated and deprotonated states under neutral pH, along with their pKa values. TrOC background concentrations in different wastewater effluents prior to spike-addition are reported as a range in either ng L⁻¹ or g L⁻¹.

FIG. 23 shows equilibrium removal of TrOCs by Cationic StyDex (left bar), F600 (middle bar), and PSR2+ (right bar) in (A) nanopure water and (B) wastewater with a contact time of 24 h at room temperature. TrOCs were originally spiked at 500 ng L⁻¹, but the concentration in wastewater varies. Adsorbents were loaded at 100 mg L⁻¹. *denotes samples whose zero-point controls did not meet acceptable spike-recovery of ±20%.

FIG. 24 shows adsorption kinetics of TrOCs by Cationic StyDex (A & B), F600 (C & D), and PSR2+ (E & F) in nanopure water (left panel) and wastewater (right panel) with contact times from 5 min to 24 h at room temperature. TrOCs were originally spiked at 500 ng L⁻¹, but the concentration in wastewater varies. Adsorbents were loaded at 100 mg L⁻¹.

FIG. 25 shows selected adsorption isotherms of TrOCs by Cationic StyDex (left panels) and F600 (right panels) in wastewater with contact times of 24 h at room temperature. PFOA (A, B), PFHxS (C, D) and BEZ (E, F) were originally spiked at 10-10,000 ng L⁻¹. Adsorbents were loaded at 100 mg L⁻¹.

FIG. 26 shows (A) Regeneration and reuse of Cationic StyDex in wastewater over four cycles using methanol. Adsorbent loading was originally 100 mg L⁻¹ during the first removal cycle but the loading decreased due to sample handling after each subsequent cycle. (B) Recovery of TrOCs from Cationic StyDex using methanol. An aliquot of TrOCs extracted in methanol was evaporated and reconstituted in equal volume of nanopure water for quantification.

### DETAILED DESCRIPTION OF THE INVENTION

Disclosed herein are functionalized cyclodextrin monomers and polymers prepared from the same for water remediation. The present technology provides for a modular, permanently porous, and crosslinked functionalized CD polymers with a controllable binding environment and tunable compositions of comonomers to remove PFASs of different chain lengths and other micropollutants from water. The modularity of this platform and reliability of radical polymerization enabled a broad range of comonomers to be incorporated. This structural versatility in turn enables performance trends to be studied as a function of the adsorbent structure and water matrix.

As demonstrated in the Examples, the polymers achieved exceptional removal efficiencies of PFCAs and PFSAs at an adsorbent loading as low as 1 mg L⁻¹. The Examples also demonstrated that removal of shorter chain PFASs that are conventionally difficult to remove. These results demonstrate that functionalized CD polymers are useful adsorbents for the remediation of anionic PFAS. Furthermore, the unprecedented control afforded by the platform allows the polymers to be tailored to target other organic micropollutants, including cationic and neutral PFAS by varying the comonomer structures.

One aspect of the technology is a mesoporous polymeric material. The term “mesoporous polymeric material” refers to porous cyclodextrin polymeric materials (P-CDPs). The P-CDPs are comprised of insoluble polymers of cyclodextrin. Cyclodextrins are macrocycles that may be inexpensively and sustainably produced from glucose. The polymers of cyclodextrin are comprised of cyclodextrin moieties that are derived from cyclodextrins. The cyclodextrin moiety(s) can be derived from naturally occurring cyclodextrins (e.g., alpha-, beta-, and gamma-, comprising 6, 7, and 8 glucose units, respectively) or synthetic cyclodextrins. The cyclodextrin moiety has at least one —O— bond derived from an OH group on the cyclodextrin from which it is derived. The cyclodextrin moieties can comprise 3-20 glucose units, including 3, 4, 5, 6, 7, 8, 9, 10, 11, 12, 13, 14, 15, 16, 17, 18, 19, and 20 glucose units, inclusive of all ranges therebetween. In many embodiments, the cyclodextrin moieties are derived from starch, and comprise 6-9 glucose units. The polymeric materials may comprise two or more different cyclodextrin moieties. In particular embodiments, the P-CDP is comprised of insoluble polymers of beta-cyclodextrin (beta-CD).

The P-CDP can also comprise cyclodextrin derivatives or modified cyclodextrins. The derivatives of cyclodextrin consist mainly of molecules wherein some of the OH groups are converted to OR groups. The cyclodextrin derivatives can, for example, have one or more additional moieties that provide additional functionality, such as desirable solubility behavior and affinity characteristics. Examples of suitable cyclodextrin derivative materials include methylated cyclodextrins (e.g., RAMEB, randomly methylated beta-cyclodextrins), hydroxyalkylated cyclodextrins (e.g., hydroxypropyl-cyclodextrin and hydroxypropyl-gamma-cyclodextrin), acetylated cyclodextrins (e.g., acetyl-gamma-cyclodextrin), reactive cyclodextrins (e.g., chlorotriazinyl-CD), branched cyclodextrins (e.g., glucosyl-beta-cyclodextrin and maltosyl-cyclodextrin), sulfobutyl-cyclodextrin, and sulfated cyclodextrins. For example, the cyclodextrin moiety further comprises a moiety that binds (e.g., with specificity) a metal such as arsenic, cadmium, copper, or lead.

The P-CDP can also comprise cyclodextrin derivatives as disclosed in U.S. Pat. No. 6,881,712 including, e.g., cyclodextrin derivatives with short chain alkyl groups such as methylated cyclodextrins, and ethylated cyclodextrins, wherein R is a methyl or an ethyl group; those with hydroxyalkyl substituted groups, such as hydroxypropyl cyclodextrins and/or hydroxyethyl cyclodextrins, wherein R is a CH₂—CH(OH) CH₃ or a XH₂CH₂—OH group; branched cyclodextrins such as maltose-bonded cyclodextrins; cationic cyclodextrins such as those containing 2-hydroxy-3-(dimethylamino)propyl ether, wherein R is CH₂—CH(OH)—CH₂N(CH₃)₂ which is cationic at low pH; quaternary ammonium, e.g., 2-hydroxy-3-(trimethylammonio)propyl ether chloride groups, wherein R is CH₂—CH(OH) CH₂N⁺ (CH₃)₃Cl⁻; anionic cyclodextrins such as carboxymethyl cyclodextrins, cyclodextrin sulfates, and cyclodextrin succinylates; amphoteric cyclodextrins such as carboxymethyl/quaternary ammonium cyclodextrins; cyclodextrins wherein at least one glucopyranose unit has a 3-6-anhydro-cyclomaltostructure, e.g., the mono-3-6-anhydrocyclodextrins, as disclosed in “Optimal Performances with Minimal Chemical Modification of Cyclodextrins”, F. Diedaini-Pilard and B. Perly, The 7th International Cyclodextrin Symposium Abstracts, April 1994, p. 49 said references being incorporated herein by reference; and mixtures thereof. Other cyclodextrin derivatives are disclosed in U.S. Pat. No. 3,426,011, Parmerter et al., issued Feb. 4, 1969; U.S. Pat. Nos. 3,453,257; 3,453,258; 3,453,259; and 3,453,260, all in the names of Parmerter et al., and all issued Jul. 1, 1969; U.S. Pat. No. 3,459,731, Gramera et al., issued Aug. 5, 1969; U.S. Pat. No. 3,553,191, Parmerter et al., issued Jan. 5, 1971; U.S. Pat. No. 3,565,887, Parmerter et al., issued Feb. 23, 1971; U.S. Pat. No. 4,535,152, Szejtli et al., issued Aug. 13, 1985; U.S. Pat. No. 4,616,008, Hirai et al., issued Oct. 7, 1986; U.S. Pat. No. 4,678,598, Ogino et al., issued Jul. 7, 1987; U.S. Pat. No. 4,638,058, Brandt et al., issued Jan. 20, 1987; and U.S. Pat. No. 4,746,734, Tsuchiyama et al., issued May 24, 1988; all of said patents being incorporated herein by reference.

The term cyclodextrin may refer to any of the known cyclodextrins such as unsubstituted cyclodextrins containing from six to twelve glucose units, especially, alpha cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in donut-shaped rings. The specific coupling and conformation of the glucose units give the cyclodextrins rigid, conical molecular structures with hollow interiors of specific volumes. The “lining” of each internal cavity is formed by hydrogen atoms and glycosidic bridging oxygen atoms; therefore, this surface is fairly hydrophobic. The unique shape and physical chemical properties of the cavity enable the cyclodextrin molecules to absorb (form inclusion complexes with) organic molecules or parts of organic molecules which can fit into the cavity.

As used herein, the term “beta-cyclodextrin” refers to a cyclic oligosaccharide consisting of seven glucose subunits joined by α-(1,4)glycosidic bonds forming a truncated conical structure. Beta-cyclodextrin has a molecular structure of:

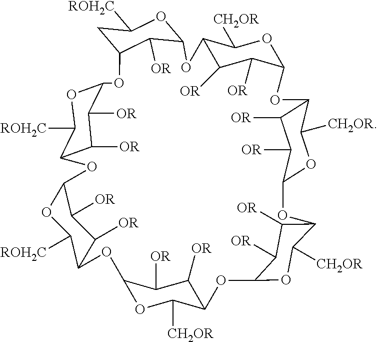

Each R may be independently selected from hydrogen, alkyl, hydroxyalkyl, alkanoyl, carboxyalkyl, or moiety capable of reacting to prepare the mesoporous polymeric material. In some embodiments, the moiety capable of reacting to prepare the mesoporous polymeric material is a stryenic double bond.

The terms “crosslink” refers to a monomer capable of forming a covalent linkage between one or more cyclodextrins or polymers. For example, if the crosslinker reacts at the end of the polymer it may covalently react with one cyclodextrin moiety of the polymer (e.g., via the styrenic double bond of the functionalized cyclodextrin described herein). The crosslink may or may not further react with other monomers or cyclodextrin units or polymers. For example, the crosslink may be bound to 1, 2, 3, or 4+ monomers or functionalized cyclodextrin units or polymers.

The mesoporous polymeric material comprises a network of cyclodextrin moieties crosslinked by a plurality of crosslinks. The network comprises

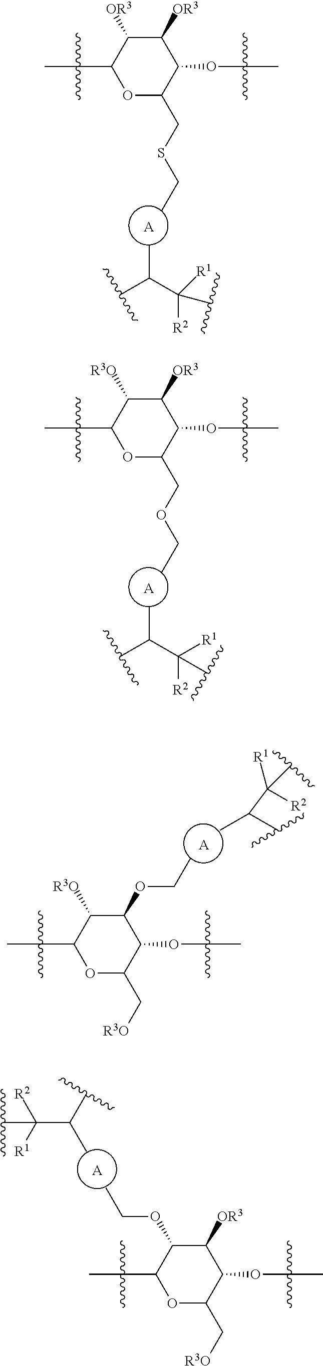

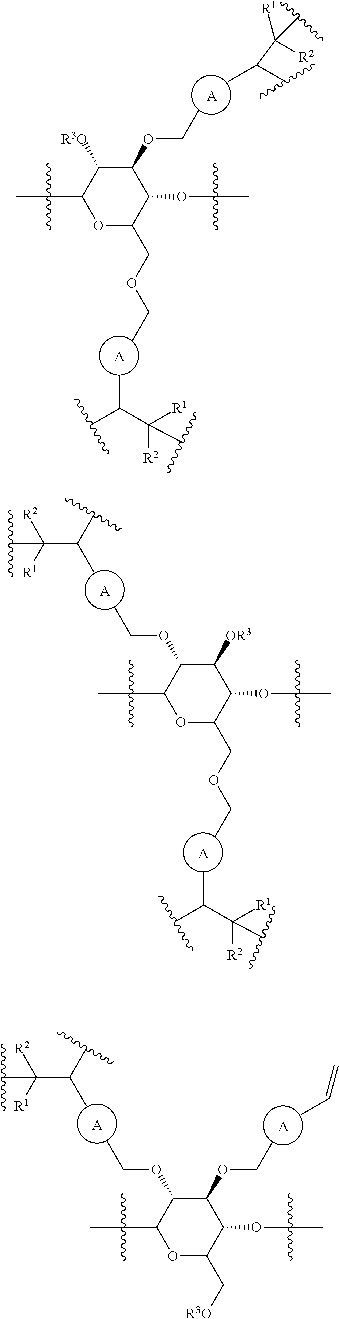

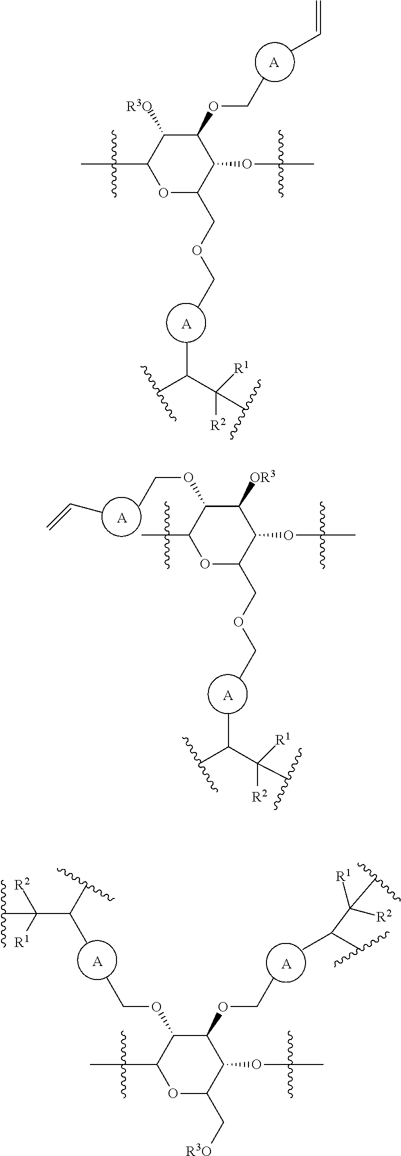

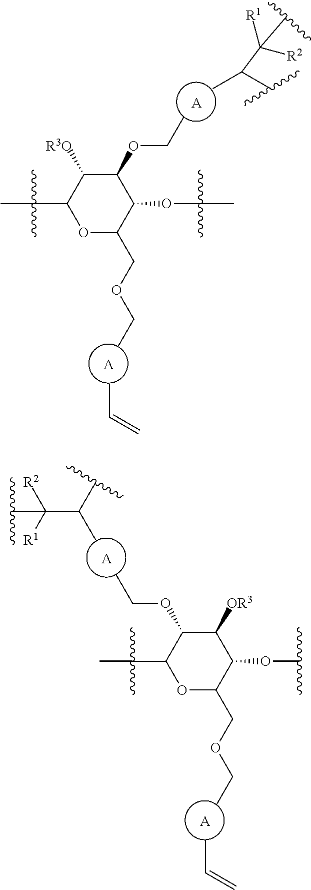

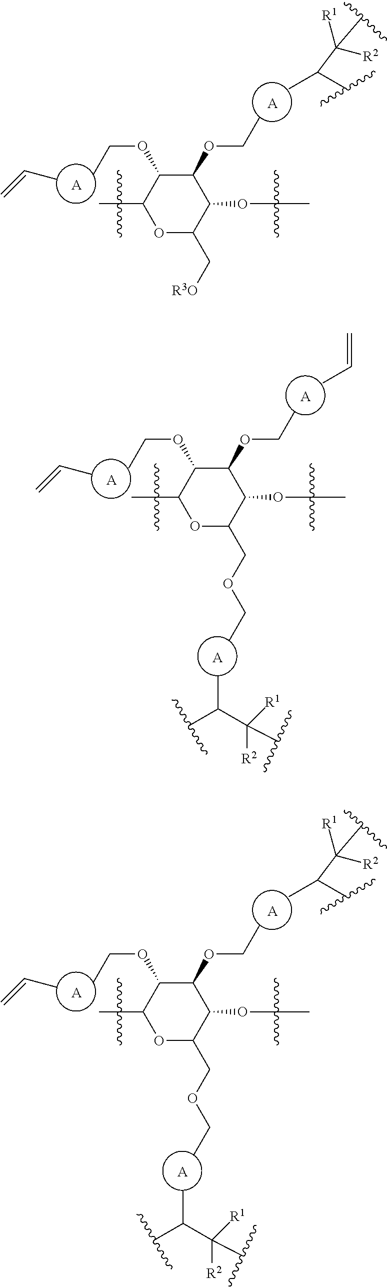

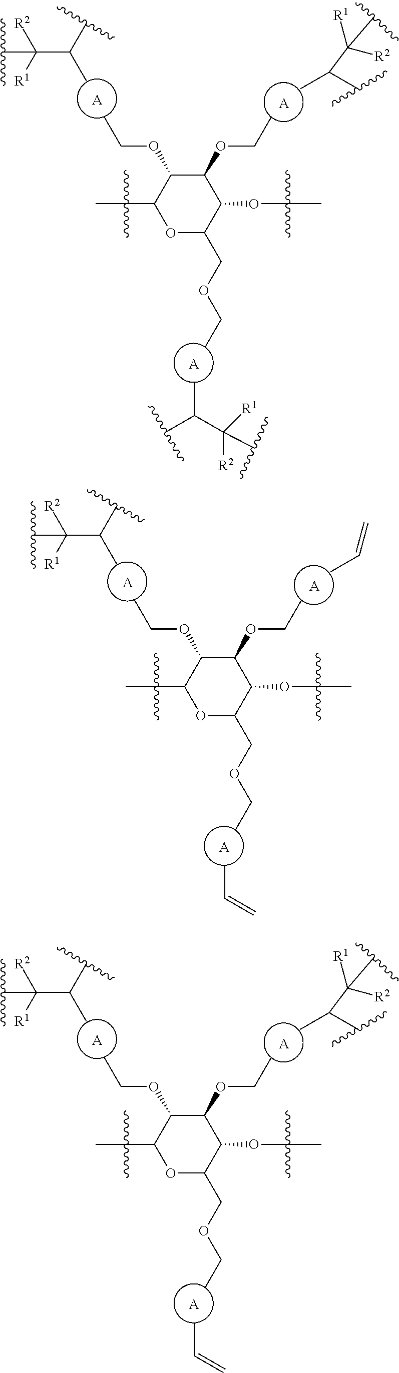

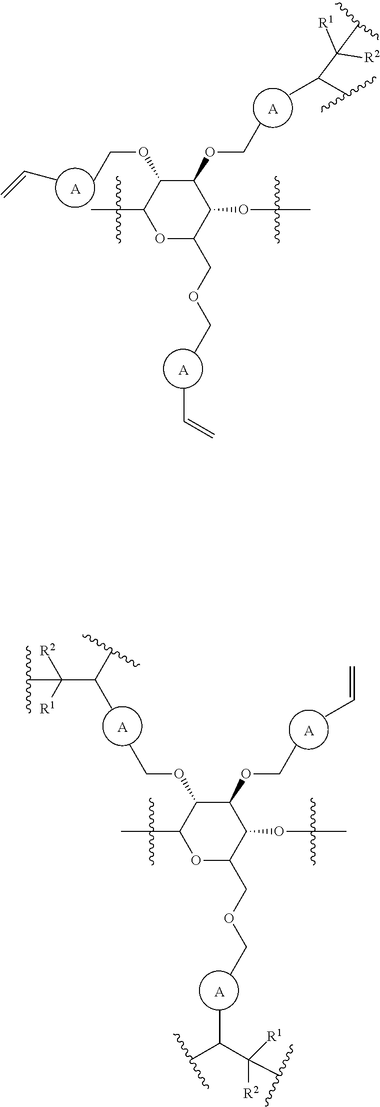

or any combination thereof. The wavy lines surrounding the glucose subunit of the cyclodextrin moiety indicate the points where the cyclodextrin moiety is repeated to form the CD moiety. Each of the glucose subunits may be independently functionalized. Suitably some or all of the glucose subunits may be functionalized with one or more reactive moieties for forming the network. The wavy lines surrounding the ethylene having pendant groups extending therefrom indicate the points where a polymeric unit may be repeated.

In some embodiments, A is an unsubstituted or substituted aryl or unsubstituted or substituted heteroaryl. In some embodiments, A is phenyl.

In some embodiments, R¹ and R² are independently —C(═O)OR⁴ an unsubstituted or substituted alkyl, an unsubstituted or substituted aryl, an unsubstituted or substituted heteroaryl, or hydrogen. R⁴ may be a substituted or unsubstituted alkyl. Optionally, R⁴ may be substituted with an amine or ammonium moiety. In some embodiments, R¹ and R² are independently selected from ethyltrimethylammonium, methyl, phenyl, or hydrogen. In some embodiments, R¹ and R² are methyl and —C(═O)OCH₂CH₂N(CH₃)₃. In some embodiments, R¹ and R² are methyl and —C(═O)OCH₃. In some embodiments, R¹ and R² are hydrogen and phenyl.

In some embodiments, R³ is independently selected from hydrogen, alkyl, hydroxyalkyl, or alkanoyl. In some embodiments, R³ is hydrogen.

The term “aryl” refers to cyclic, aromatic hydrocarbon groups that have 1 to 3 aromatic rings, including monocyclic or bicyclic groups such as phenyl, biphenyl or naphthyl. Where containing two aromatic rings (bicyclic, etc.), the aromatic rings of the aryl group may be joined at a single point (e.g., biphenyl), or fused (e.g., naphthyl). The aryl group may be optionally substituted by one or more substituents, e.g., 1 to 5 substituents, at any point of attachment. The substituents can themselves be optionally substituted. Furthermore, when containing two fused rings the aryl groups herein defined may have an unsaturated or partially saturated ring fused with a fully saturated ring. Exemplary ring systems of these aryl groups include, but are not limited to, phenyl, biphenyl, naphthyl, anthracenyl, phenalenyl, phenanthrenyl, indanyl, indenyl, tetrahydronaphthalenyl, tetrahydrobenzoannulenyl, and the like.

The term “heteroaryl” refers to a monovalent monocyclic or polycyclic aromatic radical of 5 to 18 ring atoms or a polycyclic aromatic radical, containing one or more ring heteroatoms selected from N, O, or S, the remaining ring atoms being C. Heteroaryl as herein defined also means a polycyclic (e.g., bicyclic) heteroaromatic group wherein the heteroatom is selected from N, O, or S. The aromatic radical is optionally substituted independently with one or more substituents described herein. The substituents can themselves be optionally substituted. Examples include, but are not limited to, benzothiophene, furyl, thienyl, pyrrolyl, pyridyl, pyrazinyl, pyrazolyl, pyridazinyl, pyrimidinyl, imidazolyl, isoxazolyl, oxazolyl, oxadiazolyl, pyrazinyl, indolyl, thiophen-2-yl, quinolyl, benzopyranyl, isothiazolyl, thiazolyl, thiadiazolyl, thieno[3,2-b]thiophene, triazolyl, triazinyl, imidazo[1,2-b]pyrazolyl, furo[2,3-c]pyridinyl, imidazo[1,2-a]pyridinyl, indazolyl, pyrrolo[2,3-c]pyridinyl, pyrrolo[3,2-c]pyridinyl, pyrazolo[3,4-c]pyridinyl, benzoimidazolyl, thieno[3,2-c]pyridinyl, thieno[2,3-c]pyridinyl, thieno[2,3-b]pyridinyl, benzothiazolyl, indolyl, indolinyl, indolinonyl, dihydrobenzothiophenyl, dihydrobenzofuranyl, benzofuran, chromanyl, thiochromanyl, tetrahydroquinolinyl, dihydrobenzothiazine, dihydrobenzoxanyl, quinolinyl, isoquinolinyl, 1,6-naphthyridinyl, benzo[de]isoquinolinyl, pyrido[4,3-b][1,6]naphthyridinyl, thieno[2,3-b]pyrazinyl, quinazolinyl, tetrazolo[1,5-a]pyridinyl, [1,2,4]triazolo[4,3-a]pyridinyl, isoindolyl, pyrrolo[2,3-b]pyridinyl, pyrrolo[3,4-b]pyridinyl, pyrrolo[3,2-b]pyridinyl, imidazo[5,4-b]pyridinyl, pyrrolo[1,2-a]pyrimidinyl, tetrahydropyrrolo[1,2-a]pyrimidinyl, 3,4-dihydro-2H-1/v-pyrrolo[2,1-bjpyrimidine, dibenzo[b,d]thiophene, pyridin-2-one, furo[3,2-c]pyridinyl, furo[2,3-c]pyridinyl, 1H-pyrido[3,4-b][1,4]thiazinyl, benzooxazolyl, benzoisoxazolyl, furo[2,3-b]pyridinyl, benzothiophenyl, 1,5-naphthyridinyl, furo[3,2-b]pyridine, [1,2,4]triazolo[1,5-a]pyridinyl, benzo[1,2,3]triazolyl, imidazo[1,2-a]pyrimidinyl, [1,2,4]triazolo[4,3-b]pyridazinyl, benzo[c][1,2,5]thiadiazolyl, benzo[c][1,2,5]oxadiazole, 1,3-dihydro-2H-benzo[d]imidazol-2-one, 3,4-dihydro-2H-pyrazolo[1,5-b][1,2]oxazinyl, 4,5,6,7-tetrahydropyrazolo[1,5-ajpyridinyl, thiazolo[5,4-d]thiazolyl, imidazo[2,1-b][1,3,4]thiadiazolyl, thieno[2,3-b]pyrrolyl, 3H-indolyl, and derivatives thereof. Furthermore, when containing two fused rings the heteroaryl groups herein defined may have an unsaturated or partially saturated ring fused with a fully saturated ring.

The term “alkyl” refers to a straight chain or branched saturated chain having from 1 to 10 carbon atoms. Representative saturated alkyl groups include, but are not limited to, methyl, ethyl, n-propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, butyl, isobutyl, t-butyl, n-pentyl, isopentyl, neopentyl, n-hexyl and the like, and longer alkyl groups, such as heptyl, and octyl and the like. An alkyl group can be unsubstituted or substituted. Alkyl groups containing three or more carbon atoms may be straight or branched. As used herein, “lower alkyl” means an alkyl having from 1 to 6 carbon atoms.

As used herein, the term “—C(═O)OR⁴” refers to a structural moiety of

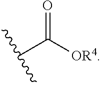

As used herein, the term “ethyltrimethylammonium” refers to a structural moiety of

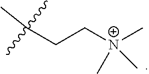 [SMILES: *CC[N+](C)(C)C]

As used herein, the term “hydroxyalkyl” refers to a hydroxy derivative of an alkylene group (-alkylene-OH).

The term “alkylene” or “alkylenyl” refers to a divalent radical derived from a straight or branched, saturated alkyl chain, for example, of 1 to 10 carbon atoms or of 1 to 6 carbon atoms (C₁-C₆ alkylenyl) or of 1 to 4 carbon atoms or of 1 to 3 carbon atoms (C₁-C₃ alkylenyl) or of 2 to 6 carbon atoms (C₂-C₆ alkylenyl). Examples of C₁-C₆ alkylenyl include, but are not limited to, —CH₂—, —CH₂CH₂—, —C(CH₃)₂CH₂CH₂CH₂—, —C(CH₃)₂CH₂CH₂—, —CH₂CH₂CH₂CH₂—, and —CH₂CH(CH₃)CH₂—.

As used herein, the term “alkanoyl” refers to a moiety having a structure of —C(═O)—R, wherein R group is an alkyl.

As used herein, the term “carboxyalkyl” refers to a carboxyl derivative of an alkylene group (-alkylene-C(═O)OH).

In some embodiments, the mesoporous polymeric material has a BET surface area greater than 200 m² g⁻¹. In some embodiments, the mesoporous polymeric material has a BET surface area greater than 210 m² g⁻¹, greater than 220 m² g⁻¹, greater than 230 m² g⁻¹, greater than 240 m² g⁻¹, greater than 250 m² g⁻¹, greater than 260 m² g⁻¹, greater than 270 m² g⁻¹, greater than 280 m² g⁻¹, greater than 290 m² g⁻¹, or greater than 3000 m² g⁻¹.

As used herein, the term “BET surface area” refers to the specific surface area of a material evaluated by the BET (Brunauer, Emmett and Teller) theory. The specific surface area is expressed in units of area per mass of sample (m²/g). The specific surface area of a material is determined by the physical adsorption of a gas (typically nitrogen, krypton, or argon) onto the surface of the sample at cryogenic temperatures (typically liquid nitrogen or liquid argon temperatures). The choice of gas to be used is dependent on the expected surface area and the properties of the sample. Once the amount of adsorbate gas has been measured (either by a volumetric or continuous flow technique), calculations which assume a monomolecular layer of the known gas are applied. BET surface area analysis must be done in the linear region of the BET plot, which could be systematically evaluated using the Rouquerol transform.

In some embodiments, the mesoporous polymeric material is prepared from a functionalized cyclodextrin monomer comprising

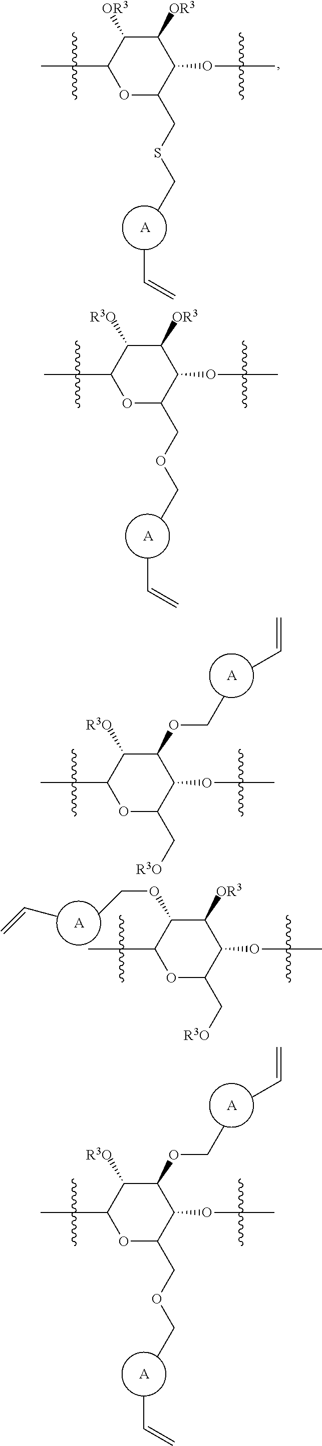

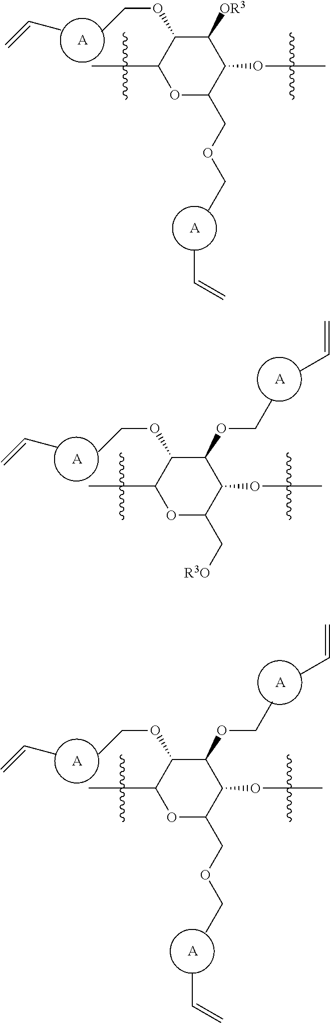

or any combination thereof and comonomer comprising

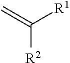

In some embodiments, the comonomer and functionalized cyclodextrin monomer are incorporated into the mesoporous polymeric material in a ratio of 1:1 to 4:1. In some embodiments, the comonomer and functionalized cyclodextrin monomer are incorporated in a ratio of 1.2:1 to 3.8:1, 1.4:1 to 3.6:1, 1.6:1 to 3.4:1, 1.8:1 to 3.2:1, 2:1 to 3:1, 2.2:1 to 2.8:1, or 2.4:1 to 2.6:1.

Another aspect of the technology is to provide a method of purifying a fluid sample comprising one or more pollutants. The method comprises contacting the fluid sample with the mesoporous polymeric material described herein. The methods allow for at least 50 wt % of the total amount of the one or more pollutants in the fluid sample is adsorbed by the mesoporous polymeric material. In some embodiments, at least 55 wt %, at least 60 wt %, at least 65 wt %, at least 70 wt %, at least 75 wt %, at least 80 wt %, at least 85 wt %, at least 90 wt %, or at least 95 wt % of the total amount of the one or more pollutants in the fluid sample is adsorbed by the mesoporous polymeric material.

As used herein, the term “adsorbent” refers to solid polymeric materials as described herein which remove contaminants or pollutants, typically but not exclusively organic molecules, from a fluid medium such as a liquid (e.g., water) or a gas (e.g., air or other commercially useful gases such as nitrogen, argon, helium, carbon dioxide, anesthesia gases, etc.). Such terms do not imply any specific physical mechanism (e.g., adsorption vs. absorption).

As used herein, the term “fluid sample” refers to liquid sample such as drinking water, wastewater, ground water, aqueous extract from contaminated soil, or landfill leachate.

In some embodiments, the pollutant is an anionic micropollutant. In some embodiments, the anionic micropollutant is a perfluorinated alkyl compound. In some embodiments, the perfluorinated alkyl compound is selected from PFCA, PFSA, or combinations thereof.

As used herein, the term “micropollutant” refers to chemicals present in water resources at ng L⁻¹ to μg L⁻¹ concentrations as a consequence of human activities. Concerns about their negative effects on human health and the environment motivate the development of technologies that remove MPs more effectively. Micropollutants encompass a range of organic and inorganic pollutants of anthropogenic origin. Micropollutants occur above natural background levels due to human activity and may persistent in the environment for decades or centuries do to slow degradation. Micropollutants may be characterized by their use or chemical characteristics. Micropollutants may include industrial chemicals (such as flame retardants or surfactants, per- and polyfluoroalkyl substances (PFAS)), pharmaceuticals, food and beverage additives, or agricultural chemicals. Micropollutant (MP) span a wide variety of physiochemical properties including surface charge, size, and chemical functionality. Charged MPs can be cationic, anionic, or zwitterionic and are typically difficult to remove in the presence of complex matrix constituents like natural organic matter (NOM) using conventional adsorption materials like activated carbon.

As used herein, the term “PFAS” refers to per- and polyfluoroalkyl substances. PFAS are a group of chemicals used to make fluoropolymer coatings and products that resist heat, oil, stains, grease, and water. Fluoropolymer coatings can be in a variety of products. These include clothing, furniture, adhesives, food packaging, heat-resistant non-stick cooking surfaces, and the insulation of electrical wire. PFAS are also used in many other consumer, commercial, and industrial products, including aqueous film forming foam (AFFF), which is used to extinguish fires. Many PFAS are a concern because they do not break down in the environment, can move through soils and contaminate drinking water sources, build up (bioaccumulate) in fish and wildlife. PFAS have been found in rivers and lakes and in many types of animals on land and in the water.

Anionic PFASs present a particular environmental problem because of their resistance to biodegradation or chemical transformation and correlation to negative health effects. PFASs have been used in the formulations of thousands of consumer goods and are present in aqueous film-forming foam (AFFF) formulations used to suppress aviation fires in training scenarios. As a result, they have contaminated surface and ground waters near thousands of airports and military installations. In 2018, the Environmental Working Group reported that over 110 million people in the United states were exposed to drinking water with PFAS concentrations above 2.5 ng L⁻¹. PFASs have been linked to cancers, liver damage, thyroid disease and other health problems.

As used herein, the term “PFCA” refers to perfluorinated carboxylic acids (PFCAs), or perfluoroalkylcarboxylic acids. PFCAs are compounds of the formula CₙF₍₂ₙ₊₁₎CO₂H. The simplest example is trifluoroacetic acid. These compounds are organofluorine analogues of ordinary carboxylic acids, but they are stronger by several pKa units and they exhibit great hydrophobic character.

As used herein, the term “PFSA” refers to perfluorosulfonic acids and are chemical compounds of the formula CₙF₍₂ₙ₊₁₎SO₃H. The simplest example of a perfluorosulfonic acid is the trifluoromethanesulfonic acid.

Another aspect of the technology is to provide a method of preparing a mesoporous polymeric material comprising a network of cyclodextrin moieties crosslinked by a plurality of cyclodextrin branch units. The method comprises contacting a functionalized cyclodextrin monomer with a comonomer in the presence of a free radical initiator under conditions sufficient to prepare the network of cyclodextrin moieties crosslinked by a plurality of cyclodextrin branch units, wherein the network comprises Formula I.

In some embodiments, the free radical initiator is AIBN. AIBN is the chemical azobisisobutyronitrile and has a CAS No. of 78-67-1. Other examples of suitable free radical initiators for the methods of preparing the mesoporous polymeric material described herein include, but are not limited to, AMBN, ADVN, ACVA, dimethyl 2,2′-azobis(2-methylpropionate), AAPH, 2,2′-azobis[2-(2-imidazolin-2-yl)propane]dihydrochloride, TBIHP, α,α-Dimethylbenzyl hydroperoxide, di-tert-butyl peroxide, dicumyl peroxide, BPO, dicyandiamide, cyclohexyl tosylate, diphenyl(methyl)sulfonium tetrafluoroborate, benzyl(4-hydroxyphenyl)-methylsulfonium hexafluoroantimonate, (4-hydroxyphenyl)methyl-(2-methylbenzyl)sulfonium hexafluoroantimonate, the atom transfer radical polymerization catalysts and initiators described in Chem. Rev. 2001, 101, 9, 2921-2990, the xanthate chain transfer agent/initiator described in Macromolecules 2017, 50, 19, 7433-7447, and nitroxide-based initiators described in pChem Record, 2005, 5, 27-35 and p Polymer Reviews, 2011, 51, 2, 104-137.

In some embodiments, the molar ratio of the functionalized cyclodextrin monomer to the comonomer is from 1:10 to 2:1. In some embodiments, the molar ratio of the functionalized cyclodextrin monomer to the comonomer is from 1:9 to 1:1, from 1:8 to 1:1, from 1:7 to 1:1, from 1:6 to 1:1, from 1:5 to 1:1, from 1:4 to 1:1, from 1:3 to 1:1, or from 1:2 to 1:1.

In some embodiments, the conditions comprise a reaction temperature from 40° C. to 100° C. In some embodiments, the conditions comprise a reaction temperature from 60° C. to 100° C., 70° C. to 90° C., or from 75° C. to 85° C.

In some embodiments, the conditions comprise a reaction time of less than 1.5 hours, or less than 1.3 hours, or less than 1.1 hours.

In some embodiments, the conditions comprise a reaction solvent selected from dimethylformamide. Other examples of suitable solvents for the methods of preparing the mesoporous polymeric material described herein include, but are not limited to, water, toluene, benzene, acetonitrile, acetone, ethyl acetate, methanol, N-methyl-2-pyrrolidinone, and tetrahydrofuran.

In some embodiments, the network of cyclodextrin moieties crosslinked by a plurality of crosslinks is produced in a yield of greater than 90%. In some embodiments, the network of cyclodextrin moieties crosslinked by a plurality of crosslinks is produced in a yield of greater than 92%, greater than 94%, greater than 96%, greater than 98%, or greater than 99%.

In some embodiments, the method further comprises extraction of the network of cyclodextrin moieties crosslinked by a plurality of crosslinks in methanol. In some embodiments, the method further comprises activation of the network of cyclodextrin moieties crosslinked by a plurality of crosslinks by supercritical carbon dioxide. In some embodiments, activation happens after extraction. As used herein, the term “supercritical carbon dioxide” refers to the fluid state of carbon dioxide where it is held at or above its critical temperature and critical pressure.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCES

1. Gagliano, E.; Sgroi, M.; Falciglia, P. P.; Vagliasindi, F. G. A.; Roccaro, P., Removal of Poly- and Perfluoroalkyl Substances (PFAS) from Water by Adsorption: Role of PFAS Chain Length, Effect of Organic Matter and Challenges in Adsorbent Regeneration. Water Res. 2020, 171, 115381.
2. Sun, M.; Arevalo, E.; Strynar, M.; Lindstrom, A.; Richardson, M.; Kearns, B.; Pickett, A.; Smith, C.; Knappe, D. R. U., Legacy and Emerging Perfluoroalkyl Substances Are Important Drinking Water Contaminants in the Cape Fear River Watershed of North Carolina. Environ. Sci. Technol. Lett. 2016, 3 (12), 415-419.
3. Ateia, M.; Maroli, A.; Tharayil, N.; Karanfil, T., The Overlooked Short- and Ultrashort-Chain Poly- and Perfluorinated Substances: A Review. Chemosphere 2019, 220, 866-882.
4. Wang, Z.; DeWitt, J. C.; Higgins, C. P.; Cousins, I. T., A Never-Ending Story of Per- and Polyfluoroalkyl Substances (PFASs)?Environ. Sci. Technol. 2017, 51 (5), 2508-2518.
5. Adamson, D. T.; Nickerson, A.; Kulkarni, P. R.; Higgins, C. P.; Popovic, J.; Field, J.; Rodowa, A.; Newell, C.; DeBlanc, P.; Kornuc, J. J., Mass-Based, Field-Scale Demonstration of PFAS Retention within AFFF-Associated Source Areas. Environ. Sci. Technol. 2020, 54 (24), 15768-15777.
6. Houtz, E. F.; Sutton, R.; Park, J. S.; Sedlak, M., Poly- and Perfluoroalkyl Substances in Wastewater: Significance of Unknown Precursors, Manufacturing Shifts, and likely AFFF Impacts. Water Res. 2016, 95, 142-9.
7. Wang, Y.; Yu, N.; Zhu, X.; Guo, H.; Jiang, J.; Wang, X.; Shi, W.; Wu, J.; Yu, H.; Wei, S., Suspect and Nontarget Screening of Per- and Polyfluoroalkyl Substances in Wastewater from a Fluorochemical Manufacturing Park. Environ. Sci. Technol. 2018, 52 (19), 11007-11016.
8. Scher, D. P.; Kelly, J. E.; Huset, C. A.; Barry, K. M.; Hoffbeck, R. W.; Yingling, V. L.; Messing, R. B., Occurrence of Perfluoroalkyl Substances (PFAS) in Garden Produce at Homes with a History of PFAS-Contaminated Drinking Water. Chemosphere 2018, 196, 548-555.
9. Hoffman, K.; Webster, T. F.; Bartell, S. M.; Weisskopf, M. G.; Fletcher, T.; Vieira, V. M., Private Drinking Water Wells as a Source of Exposure to Perfluorooctanoic Acid (PFOA) in Communities Surrounding a Fluoropolymer Production Facility. Environ. Health Perspect. 2011, 119 (1), 92-7.
10. Houck, K. A.; Patlewicz, G.; Richard, A. M.; Williams, A. J.; Shobair, M. A.; Smeltz, M.; Clifton, M. S.; Wetmore, B.; Medvedev, A.; Makarov, S., Bioactivity Profiling of Per- and Polyfluoroalkyl Substances (PFAS) Identifies Potential Toxicity Pathways Related to Molecular Structure. Toxicology 2021, 457, 152789.
11. McKinlay, R.; Plant, J. A.; Bell, J. N.; Voulvoulis, N., Endocrine Disrupting Pesticides: Implications for Risk Assessment. Environ. Int. 2008, 34 (2), 168-83.
12. Crone, B. C.; Speth, T. F.; Wahman, D. G.; Smith, S. J.; Abulikemu, G.; Kleiner, E. J.; Pressman, J. G., Occurrence of Per- and Polyfluoroalkyl Substances (PFAS) in Source Water and Their Treatment in Drinking Water. Crit. Rev. Environ. Sci. Technol. 2019, 49 (24), 2359-2396.
13. Duchesne, A. L.; Brown, J. K.; Patch, D. J.; Major, D.; Weber, K. P.; Gerhard, J. I., Remediation of PFAS-Contaminated Soil and Granular Activated Carbon by Smoldering Combustion. Environ. Sci. Technol. 2020, 54 (19), 12631-12640.
14. Liu, C. J.; Werner, D.; Bellona, C., Removal of Per- and Polyfluoroalkyl Substances (PFASs) from Contaminated Groundwater using Granular Activated Carbon: a Pilot-Scale Study with Breakthrough Modeling. Environ. Sci. Water Res. Technol. 2019, 5 (11), 1844-1853.
15. McCleaf, P.; Englund, S.; Ostlund, A.; Lindegren, K.; Wiberg, K.; Ahrens, L., Removal Efficiency of Multiple Poly- and Perfluoroalkyl Substances (PFASs) in Drinking Water using Granular Activated Carbon (GAC) and Anion Exchange (AE) Column Tests. Water Res. 2017, 120, 77-87.
16. Zaggia, A.; Conte, L.; Falletti, L.; Fant, M.; Chiorboli, A., Use of Strong Anion Exchange Resins for the Removal of Perfluoroalkylated Substances from Contaminated Drinking Water in Batch and Continuous Pilot Plants. Water Res. 2016, 91, 137-46.
17. Wang, F.; Shih, K., Adsorption of Perfluorooctanesulfonate (PFOS) and Perfluorooctanoate (PFOA) on Alumina: Influence of Solution pH and Cations. Water Res. 2011, 45 (9), 2925-30.
18. Parida, S. K.; Dash, S.; Patel, S.; Mishra, B. K., Adsorption of Organic Molecules on Silica Surface. Adv. Colloid Interface Sci. 2006, 121 (1-3), 77-110.
19. Tang, C. Y.; Shiang Fu, Q.; Gao, D.; Criddle, C. S.; Leckie, J. O., Effect of Solution Chemistry on the Adsorption of Perfluorooctane Sulfonate onto Mineral Surfaces. Water Res. 2010, 44 (8), 2654-62.
20. Ateia, M.; Helbling, D. E.; Dichtel, W. R., Best Practices for Evaluating New Materials as Adsorbents for Water Treatment. ACS Mater. Lett. 2020, 2 (11), 1532-1544.
21. Rizzo, L.; Malato, S.; Antakyali, D.; Beretsou, V. G.; Dolic, M. B.; Gernjak, W.; Heath, E.; Ivancev-Tumbas, I.; Karaolia, P.; Lado Ribeiro, A. R.; Mascolo, G.; McArdell, C. S.; Schaar, H.; Silva, A. M. T.; Fatta-Kassinos, D., Consolidated vs New Advanced Treatment Methods for the Removal of Contaminants of Emerging Concern from Urban Wastewater. Sci. Total Environ. 2019, 655, 986-1008.
22. Ling, Y.; Klemes, M. J.; Xiao, L.; Alsbaiee, A.; Dichtel, W. R.; Helbling, D. E., Benchmarking Micropollutant Removal by Activated Carbon and Porous beta-Cyclodextrin Polymers under Environmentally Relevant Scenarios. Environ. Sci. Technol. 2017, 51 (13), 7590-7598.
23. Ling, Y.; Alzate-Sanchez, D. M.; Klemes, M. J.; Dichtel, W. R.; Helbling, D. E., Evaluating the Effects of Water Matrix Constituents on Micropollutant Removal by Activated Carbon and beta-Cyclodextrin Polymer Adsorbents. Water Res. 2020, 173, 115551.
24. Liu, Q.; Zhou, Y.; Lu, J.; Zhou, Y., Novel Cyclodextrin-based Adsorbents for Removing Pollutants from Wastewater: A Critical Review. Chemosphere 2020, 241, 125043.
25. Alsbaiee, A.; Smith, B. J.; Xiao, L.; Ling, Y.; Helbling, D. E.; Dichtel, W. R., Rapid Removal of Organic Micropollutants from Water by a Porous beta-Cyclodextrin polymer. Nature 2016, 529 (7585), 190-4.
26. Klemes, M. J.; Ling, Y.; Chiapasco, M.; Alsbaiee, A.; Helbling, D. E.; Dichtel, W. R., Phenolation of Cyclodextrin Polymers Controls their Lead and Organic Micropollutant Adsorption. Chem. Sci. 2018, 9 (47), 8883-8889.
27. Zhao, F.; Repo, E.; Yin, D.; Chen, L.; Kalliola, S.; Tang, J.; Iakovleva, E.; Tam, K. C.; Sillanpaa, M., One-pot Synthesis of Trifunctional Chitosan-EDTA-beta-Cyclodextrin Polymer for Simultaneous Removal of Metals and Organic Micropollutants. Sci. Rep. 2017, 7 (1), 15811.
28. Zhang, Q.; Deng, S.; Yu, G.; Huang, J., Removal of Perfluorooctane Sulfonate from Aqueous Solution by Crosslinked Chitosan Beads: Sorption Kinetics and Uptake Mechanism. Bioresour. Technol. 2011, 102 (3), 2265-71.
29. Li, R.; Alomari, S.; Stanton, R.; Wasson, M. C.; Islamoglu, T.; Farha, O. K.; Holsen, T. M.; Thagard, S. M.; Trivedi, D. J.; Wriedt, M., Efficient Removal of Per- and Polyfluoroalkyl Substances from Water with Zirconium-Based Metal-Organic Frameworks. Chem. Mater. 2021, 33 (9), 3276-3285.
30. Wang, W.; Xu, Z.; Zhang, X.; Wimmer, A.; Shi, E.; Qin, Y.; Zhao, X.; Zhou, B.; Li, L., Rapid and Efficient Removal of Organic Micropollutants from Environmental Water using a Magnetic Nanoparticles-Attached Fluorographene-based Sorbent. Chem. Eng. J. 2018, 343, 61-68.
31. Gong, Y.; Wang, L.; Liu, J.; Tang, J.; Zhao, D., Removal of Aqueous Perfluorooctanoic Acid (PFOA) using Starch-stabilized Magnetite Nanoparticles. Sci. Total Environ. 2016, 562, 191-200.
32. Li, C.; Klemes, M. J.; Dichtel, W. R.; Helbling, D. E., Tetrafluoroterephthalonitrile-Crosslinked beta-Cyclodextrin Polymers for Efficient Extraction and Recovery of Organic Micropollutants from Water. J. Chromatogr. A. 2018, 1541, 52-56.
33. Yang, A.; Ching, C.; Easler, M.; Helbling, D. E.; Dichtel, W. R., Cyclodextrin Polymers with Nitrogen-Containing Tripodal Crosslinkers for Efficient PFAS Adsorption. ACS Mater. Lett. 2020, 2 (9), 1240-1245.
34. Crini, G., Review: A History of Cyclodextrins. Chem. Rev. 2014, 114 (21), 10940-75.
35. Ching, C.; Klemes, M. J.; Trang, B.; Dichtel, W. R.; Helbling, D. E., Beta-Cyclodextrin Polymers with Different Cross-Linkers and Ion-Exchange Resins Exhibit Variable Adsorption of Anionic, Zwitterionic, and Nonionic PFASs. Environ. Sci. Technol. 2020, 54 (19), 12693-12702.
36. Xiao, L.; Ling, Y.; Alsbaiee, A.; Li, C.; Helbling, D. E.; Dichtel, W. R., Beta-Cyclodextrin Polymer Network Sequesters Perfluorooctanoic Acid at Environmentally Relevant Concentrations. J. Am. Chem. Soc. 2017, 139 (23), 7689-7692.
37. Xiao, L.; Ching, C.; Ling, Y.; Nasiri, M.; Klemes, M. J.; Reineke, T. M.; Helbling, D.

E.; Dichtel, W. R., Cross-linker Chemistry Determines the Uptake Potential of Perfluorinated Alkyl Substances by β-Cyclodextrin Polymers. Macromolecules 2019, 52 (10), 3747-3752.
38. Chen, Z.; Bradshaw, J. S.; Yi, G.; Pyo, D.; Black, D. R.; Zimmerman, S. S.; Lee, M. L., Self-Inclusion Complexes Derived from Cyclodextrins. J. Org. Chem. 1996, (61), 8949-8955.
39. Rekharsky, M. V.; Inoue, Y., Complexation Thermodynamics of Cyclodextrins. Chem. Rev. 1998, (98), 1875-1917.
40. Klemes, M. J.; Skala, L. P.; Ateia, M.; Trang, B.; Helbling, D. E.; Dichtel, W. R., Polymerized Molecular Receptors as Adsorbents to Remove Micropollutants from Water. Acc. Chem. Res. 2020, 53 (10), 2314-2324.
41. Rojas, M. T.; Koniger, R.; Stoddart, J. F.; Kaifer, A. E., Supported Monolayers Containing Preformed Binding-Sites—Synthesis and Interfacial Binding-Properties of a Thiolated Beta-Cyclodextrin Derivative. J. Am. Chem. Soc. 1995, (117), 336-343.
42. Ashton, P. R.; Koniger, R.; Stoddart, J. F.; Alker, D.; Harding, V. D., Amino Acid Derivatives of β-Cyclodextrin. J. Org. Chem. 1996, (61), 903-908.
43. Liu, Y.; Lin, T.; Cheng, C.; Wang, Q.; Lin, S.; Liu, C.; Han, X., Research Progress on Synthesis and Application of Cyclodextrin Polymers. Molecules 2021, 26 (4).
44. Ateia, M.; Alsbaiee, A.; Karanfil, T.; Dichtel, W., Efficient PFAS Removal by Amine-Functionalized Sorbents: Critical Review of the Current Literature. Environ. Sci. Technol. Lett. 2019, 6 (12), 688-695.
45. Ateia, M.; Arifuzzaman, M.; Pellizzeri, S.; Attia, M. F.; Tharayil, N.; Anker, J. N.; Karanfil, T., Cationic Polymer for Selective Removal of GenX and Short-chain PFAS from Surface Waters and Wastewaters at ng/L Levels. Water Res. 2019, 163, 114874.
46. Munoz, G.; Duy, S. V.; Labadie, P.; Botta, F.; Budzinski, H.; Lestremau, F.; Liu, J.; Sauve, S., Analysis of Zwitterionic, Cationic, and Anionic Poly- and Perfluoroalkyl Surfactants in Sediments by Liquid Chromatography Polarity-Switching Electrospray Ionization Coupled to High Resolution Mass Spectrometry. Talanta 2016, 152, 447-56.
47. Chen, H.; Zhang, C.; Yu, Y.; Han, J., Sorption of Perfluorooctane Sulfonate (PFOS) on Marine Sediments. Mar. Pollut. Bull. 2012, 64 (5), 902-6.

### EXAMPLES

### Example 1

Disclosed herein is a CD polymer platform in which styrene groups are covalently attached to β-CD to form a discrete monomer that is amenable to radical polymerization. A β-CD polymer copolymerized with a methacrylic monomer bearing a cationic functional group achieved nearly 100% removal for eight anionic PFASs at an exceedingly low adsorbent loading of 1 mg L⁻¹, which is at least an order of magnitude lower than what has been explored in previous studies. Furthermore, when the adsorbents were studied in a challenging salt matrix, it was observed that long-chain PFAS adsorption was controlled by a complementary interplay of hydrophobic and electrostatic interactions, whereas short-chain PFASs primarily relied on electrostatic interactions. These materials allow for anionic PFAS removal, and new compositions can be tailored using the versatility of radical polymerization to simultaneously target PFAS and other classes of micropollutants in the future.

The Example demonstrates a structurally well-defined and tunable approach to access porous β-CD polymers that offers superior PFAS removal performance as well as insight into the interactions that drive short- and long-chain PFAS removal. The approach involves copolymerizing a styrene-functionalized β-CD derivative with various styrenic or methacrylic comonomers to give permanently porous, crosslinked molecules with a more uniform β-CD binding environments and easily tunable compositions of hydrophobic or charged comonomers. The first polymers based on these design principles were evaluated for their ability to bind seven PFCAs and four PFSAs of different chain lengths and in different water matrices to elucidate the relative importance of the β-CD interactions, conventionally thought to be hydrophobic, and electrostatic interactions between anionic PFASs and cations embedded in one of the polymer networks. These Examples demonstrate that a β-CD adsorbent containing a cationic functional group exhibits exceptional removal of PFASs with different chain length from nanopure water at an exceedingly low adsorbent loading of 1 mg L⁻¹ which is at least an order of magnitude lower than what has been explored in previous studies. The changes in removal efficiency for both long- and short-chain PFASs as a function of salt concentration provided insight into the combined roles of charge and β-CD binding sites for PFAS binding. These studies establish the styrene-functionalized β-CD monomer as a highly promising building block for β-CD adsorbents.

Seven styrene groups were installed at the 6′ position of each β-CD subunit, effectively replacing primary alcohol groups (C-6) using approaches modified from Rojas and coworkers.⁴¹ First, the primary alcohols were selectively substituted with iodines following established protocols, yielding 1 (FIG. 20(A)). The iodines were converted to thiols using thiourea, yielding 2.⁴¹⁻⁴² The enhanced nucleophilicity and acidity of the thiols relative to the remaining hydroxyl groups of β-CD enabled their selective benzylation in the presence of stoichiometric K₂CO₃ and 4-vinylbenzylchloride, yielding 3. This sequence was carried out with an isolated yield of 75% over three steps (23 g) with no chromatography required to purify the intermediate or final products.

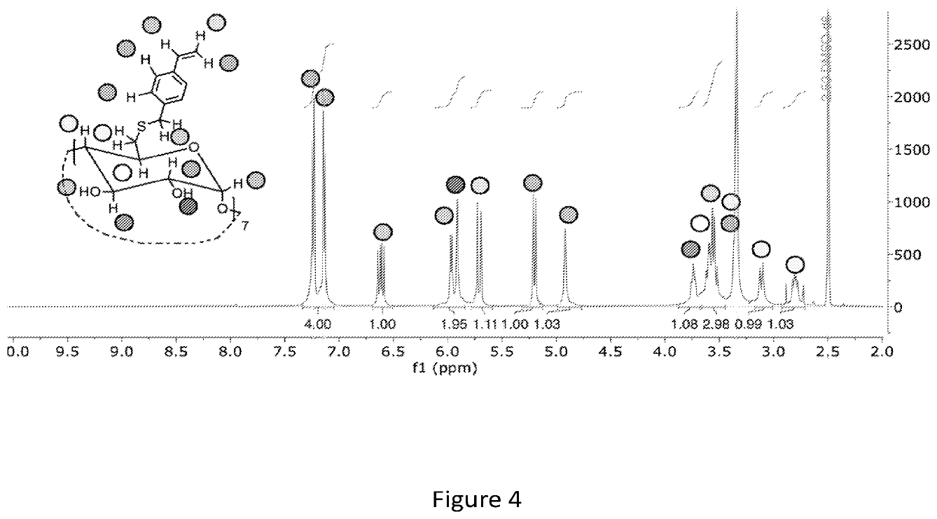

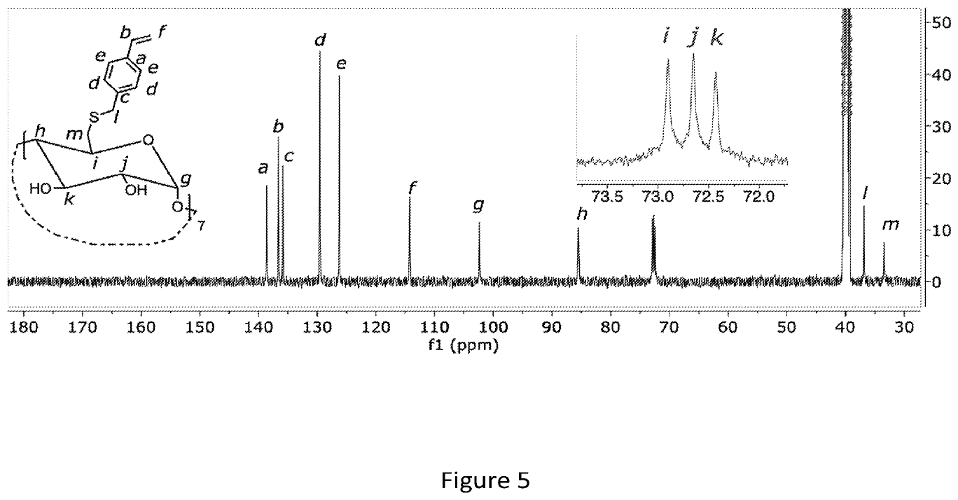

The ¹H NMR spectrum of 3 indicated the successful installation of styrene groups, based on the appearance of resonances in the 5.0-7.5 ppm region as well as the disappearance of thiol S—H resonance at 2.16 ppm.⁴¹ The integrations of the aromatic resonances (7.0-7.5 ppm) relative to the β-CD resonance at 5.0 ppm was consistent with seven styrene groups per β-CD (FIG. 4). ¹³C NMR spectroscopy of 3 indicated the correct number of carbon resonances, as well as the successful addition of styrene groups with peaks between 115 and 140 ppm (FIG. 5). High-resolution mass spectroscopy of 3 confirmed the addition of seven styrene groups on the primary site based on a single peak in the full-scan chromatogram with an accurate mass corresponding to the theoretical mass of 3. IR spectroscopy and combustion elemental analysis were also consistent with the expected structure.

The styrene groups of 3 are potentially compatible with hundreds of commercially available vinyl comonomers as well as many radical polymerization methods. This versatility will be advantageous in targeting a broad scope of micropollutants in the future.^{24, 43} For this study, we polymerized 3 using azobisisobutyronitrile (AIBN) as a free radical initiator. We used these conditions to prepare three polymers based on 3: a styrene copolymer 4, a methyl methacrylate copolymer 5, and a cationic methacrylate copolymer 6. Polymers 4, 5, and 6 were synthesized using similar procedures by heating 3, the comonomer, and AIBN in DMF for 1 h, with increased viscosity of the solution developing within 15 min. The crosslinked polymer was subjected to continuous liquid/solid extraction in methanol for approximately 14 h. Following extraction, the polymers were activated by supercritical CO₂ washing and isolated in high yields at multigram scales (FIG. 20(B)). Notably, the isolated yields of these polymerizations (94-96%) were significantly higher than those of TFN-based β-CD adsorbents, which we attribute to the high efficiency of radical polymerizations of styrene and methacrylic monomers relative to those based on aromatic substitution chemistries.²⁶

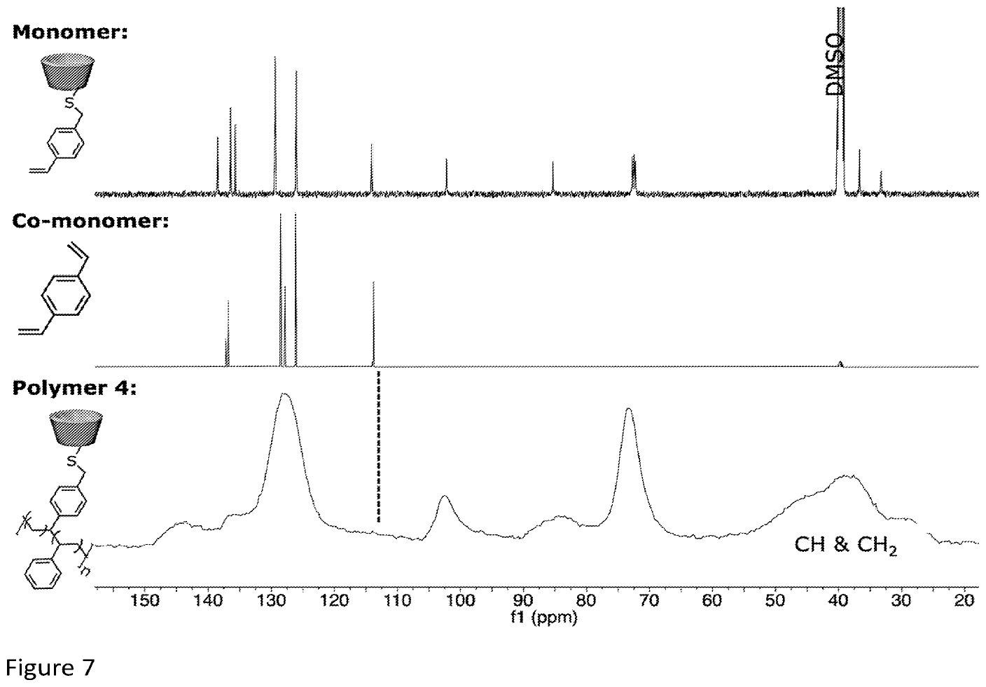

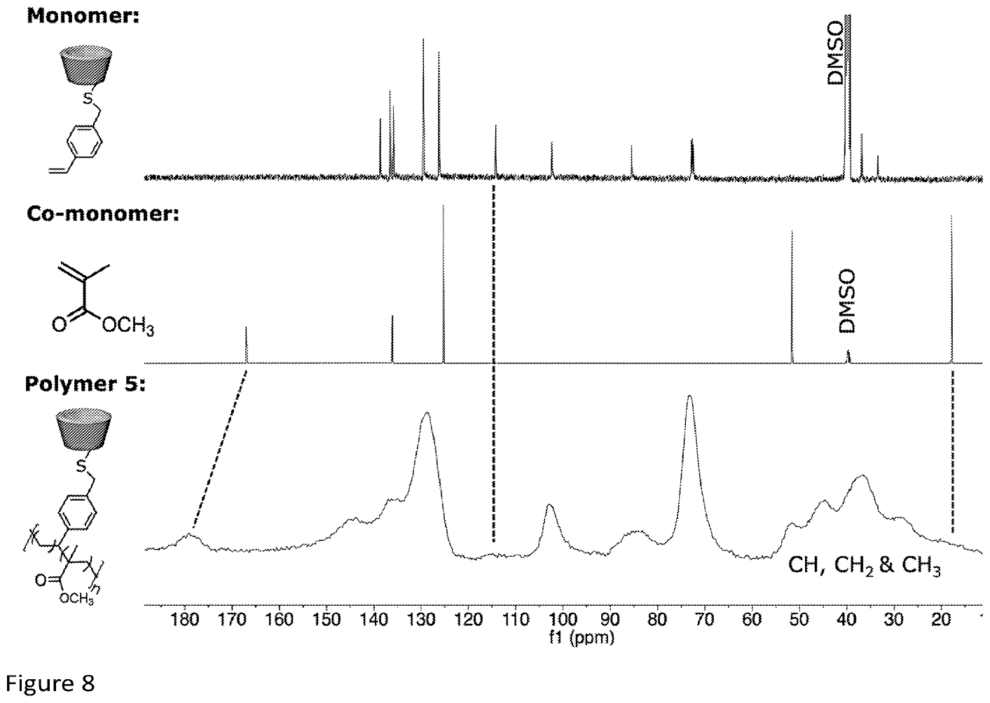

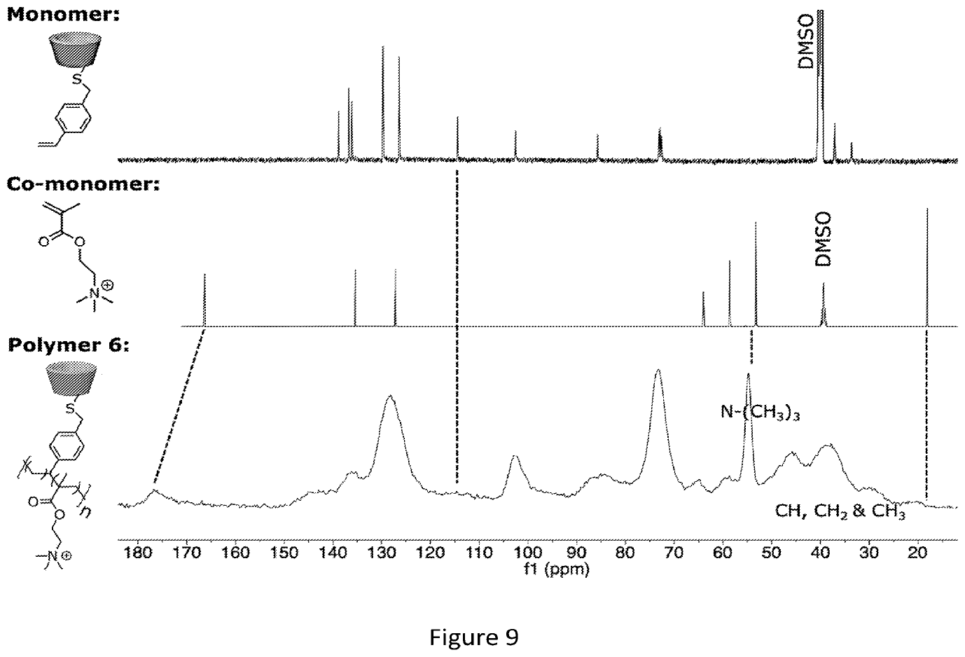

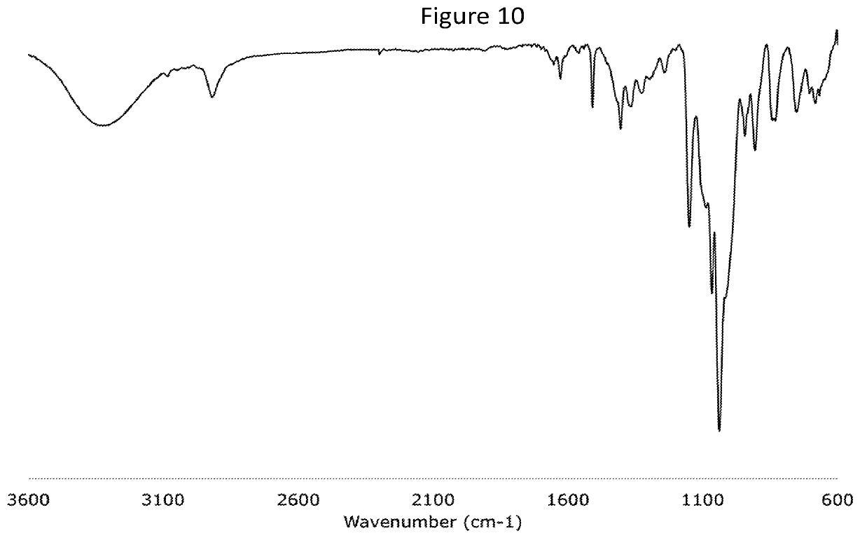

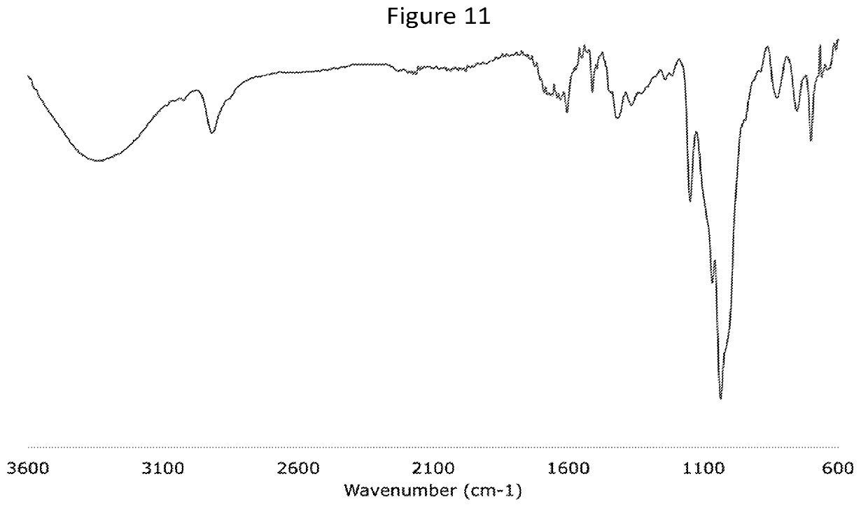

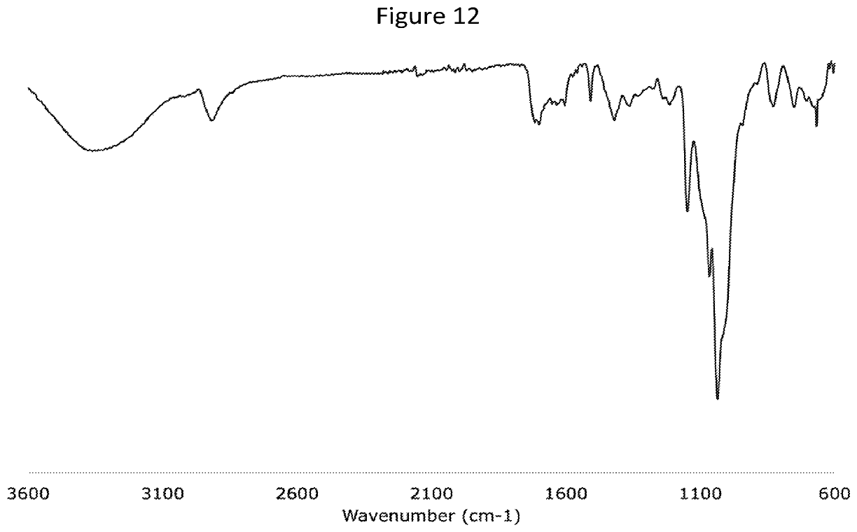

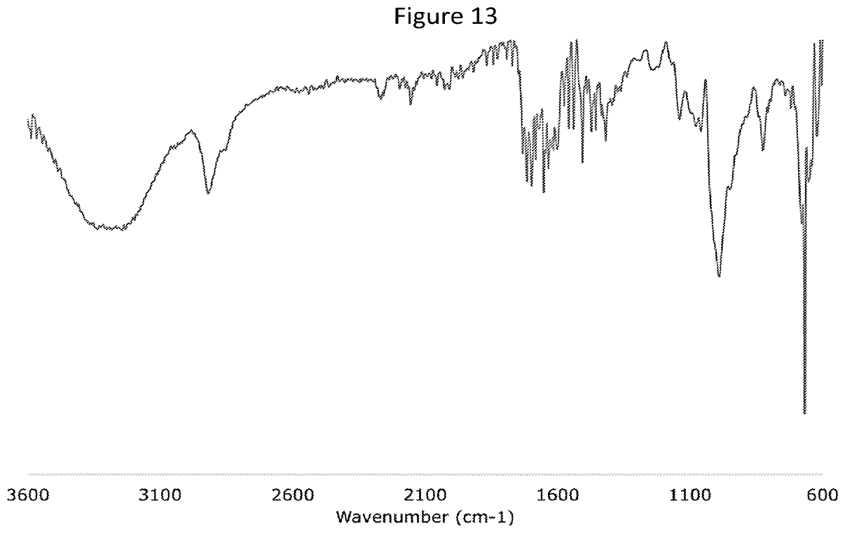

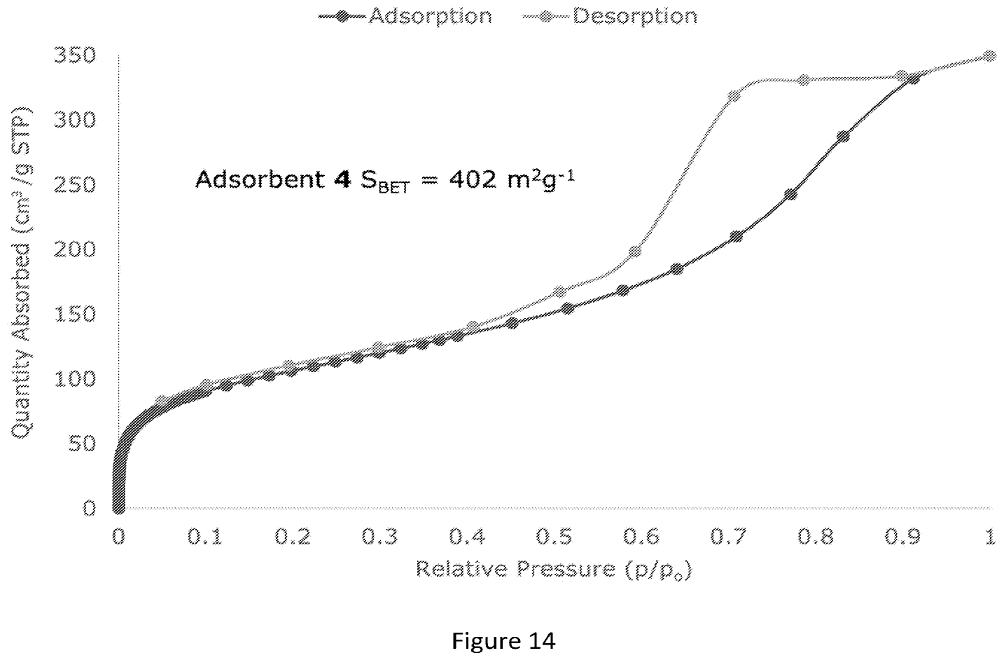

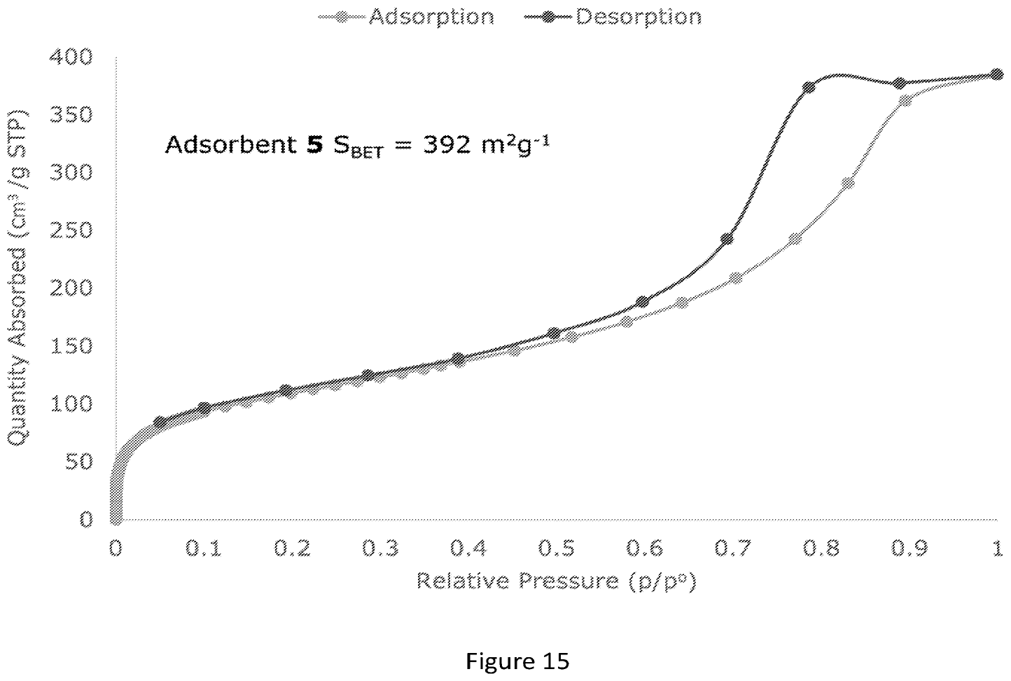

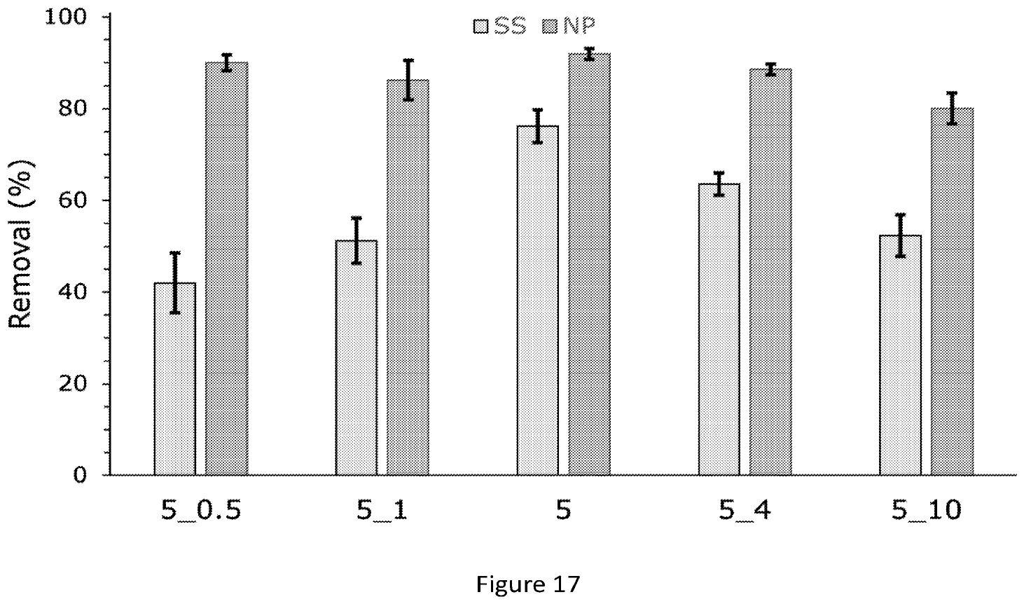

Polymers 4, 5, and 6 formed porous and crosslinked networks with permanent surface charge. Solid-state cross-polarization magic angle spinning ¹³C NMR spectroscopy confirmed the incorporation of comonomers in 4, 5, and 6 (FIGS. 7-9). In all three spectra, the resonance corresponding to the vinyl carbons of 3 (113 ppm) was not detected, suggesting a high degree of polymerization of the styrene groups. The polymer backbone was formed from the vinyl carbons, as evident from the broadened alkane regions (20-55 ppm). In the spectra of 5 and 6, carbonyl carbons of the comonomers were detected around 180 ppm. Furthermore, the characteristic N-methyl carbons (55 ppm) were detected in the spectrum of 6. The elemental analyses of the three polymers suggested that each polymer incorporated between 1.2-2.0 comonomers per β-CD. A feed ratio of two equivalences of comonomers with respect to 3 was determined to be most promising based on preliminary PFAS binding studies (FIG. 17), and were used in subsequent polymerizations. The comonomer incorporation ratio of 4 and 6 were calculated to be 1.8 and 2.0, respectively, which were consistent with the feed ratio. The ratio of 5, however, was 1.2, indicating that methyl methacrylate was not incorporated as readily. The porosity and Brunauer-Emmett-Teller surface area (S_{BET}) of polymers 4, 5, and 6 were characterized by N₂ porosimetry. Each polymer exhibited permanent porosity and high S_{BET}, ranging from 237-402 m² g⁻¹, which is higher than previous β-CD adsorbents (FIGS. 14-15).^{25-26, 33} Lastly, the zeta potentials of suspensions of 4 and 5 were found to be weakly negative whereas that of 6 was strongly positive (Table 1). IR spectroscopy of the polymers was consistent with their expected structures (FIGS. 10-13). These data confirmed the porous and crosslinked nature of the polymers, which were subsequently used to remove PFAS from water.

TABLE 1
Characterization of the Adsorbents.

| | | | | | | Co- |
|---|---|---|---|---|---|---|
| | | | | | | monomer |
| | | | | | | Incor- |
| | | | | | | poration |
| | Co- | | Average | BET | Iso- | Ratio |
| | mono- | Zeta | Particle | Surface | lated | (Co- |
| Ad- | mer | Potential | Diameter | Area | Yield | mono- |
| sorbent | Charge | (mV) | (μm) | (m²g⁻¹) | (%) | mer: 3) |
| 4 | Neutral | −8.2 ± 0.6 | 149 | 402 | 94 | 1.8 |
| 5 | Neutral | −9.9 ± 0.9 | 118 | 392 | 93 | 1.2 |
| | Cationic | +23.8 ± 1.6 | 162 | 237 | 96 | 2.0 |

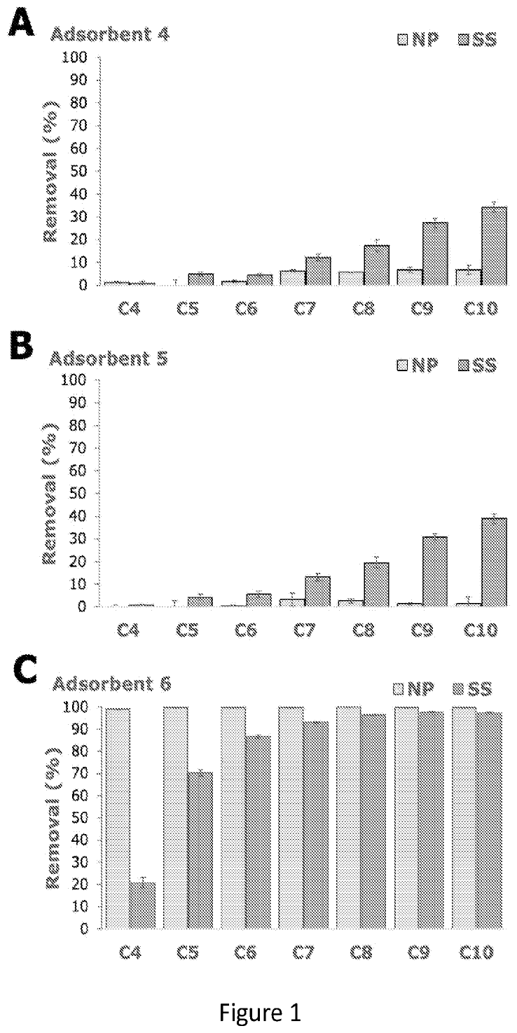

We first evaluated the removal performances of polymers 4, 5, and 6 at an adsorbent loading of 10 mg L⁻¹ for 4-10 carbon PFCAs (initial concentration of 1 μg L⁻¹ for each compound) in a nanopure (NP) water matrix and in a 1 mM Na₂SO₄ (SS) matrix (FIG. 1). The high salt concentration of the SS matrix was chosen to probe the relative importance of hydrophobic and electrostatic interactions in both short- and long-chain PFAS removal. Adsorbents 4 and 5 were inefficient at adsorption in NP matrix with 0-5% removal for all tested PFASs. However, adsorbent 6 performed effectively, with nearly 100% removal across the 4-10 carbon PFCAs. The ability of 6 to remove the four carbon PFBA and five carbon PFPeA (>99% removal) was notable because these short-chain PFASs are not removed as effectively by ACs and other emerging adsorbents. We attribute this promising performance of 6 to its permanent positively charged ammonium groups that interact favorably with anionic PFASs, as has been shown for other designed adsorbents based on β-CD and other materials.⁴⁴⁻⁴⁶ PFCA removal experiments conducted using adsorbents 4, 5, and 6 in a 1 mM SS matrix indicated that PFASs of different chain lengths interacted with the adsorbents and matrix through different non-covalent interactions. Generally speaking, hydrophobic adsorbents 4 and 5 showed enhanced, yet still modest PFCA removal in SS matrix as compared to NP matrix (FIGS. 1A and 1B). In contrast, adsorbent 6 showed inhibited, yet still relatively high PFCA removal in the SS matrix as compared to the NP matrix (FIG. 1C). Inhibition was most pronounced for PFBA and PFPeA, the shortest-chain PFCAs studied, and was relatively minor for seven carbon and longer PFCAs.

The removal of four carbon PFBA by 6 was inhibited substantially from 99% to 21% in SS matrix, suggesting that electrostatic interactions play a significant role in short-chain PFCA removal. We attribute the interference to either direct-site competition in which inorganic anions compete with anionic PFCAs for adsorption sites, or the increased screening that attenuates electrostatic interactions at increased electrolyte concentrations.^{17, 19, 31} Notably, the removal of 6-10 carbon PFCAs was less inhibited in the SS matrix than that of shorter chain derivatives. The removal of six carbon PFHxA decreased from 99% to 87%, and the removal of 8-10 carbon PFCAs were nearly unaffected. The decreased sensitivity of longer chain PFCAs to ionic strength suggests that hydrophobic interactions between the perfluoroalkyl tails, the hydrophobic portions of the polymer, and the β-CD inner cavity, play a relatively large role in longer chain PFCA removal. Alternatively, it is possible that these hydrophobic interactions increase in energy at higher ionic strength as PFCA and electrostatic interactions are attenuated. On the other hand, the performance of adsorbents 4 and 5 was significantly enhanced for most PFCAs, except four carbon PFBA, with longer chain PFCAs experiencing more profound enhancement. For instance, the removal of ten carbon PFDA increased from 7% to 34% by 4 and from 1% to 39% by 5. We attribute this enhancement to a screening effect that reduces the repulsion between negatively charged surfaces of 4 or 5, and the anionic PFCAs.^{17, 19, 31} Additionally, this enhancement may also result from a salting out effect, in which the presence of inorganic ions decreased the solubility of organic molecules and increased hydrophobic interactions for adsorbents 4 and 5 and long-chain PFCAs.^{1, 47}

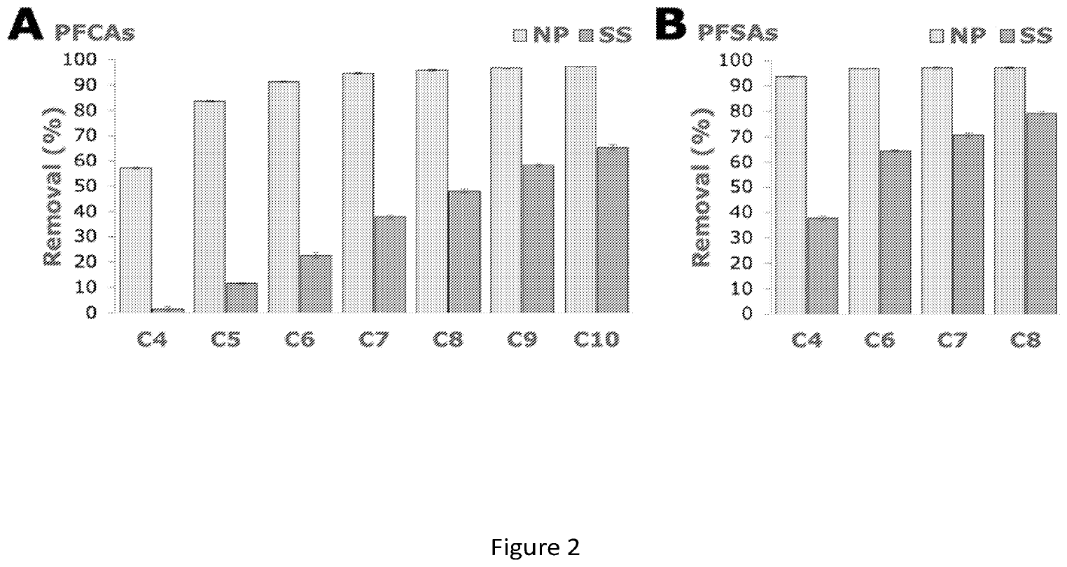

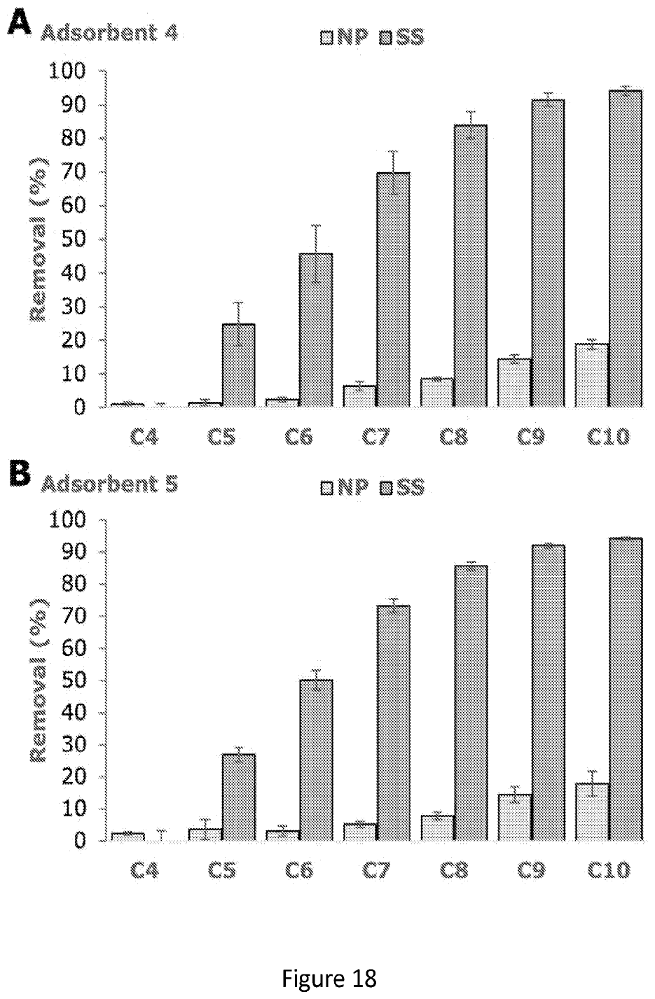

To better investigate the magnitude of inhibitory or enhancement effects for the same concentration of PFCA in NP and SS matrices, adsorbent 6 loading was adjusted from 10 mg L⁻¹ to 1 mg L⁻¹ (FIG. 2A), and adsorbents 4 and 5 loadings were adjusted from 10 mg L⁻¹ to 100 mg L⁻¹ (FIG. 18). In a separate study, a mixture of 4, 6, 7, and 8-carbon PFSA was also added in both matrices with an initial concentration of 1 μg L⁻¹ (FIG. 2B). Under these conditions, adsorbents 4 and 5 showed modest removal and similar trends of enhancement in the higher ionic strength matrix. However, 6 exhibited promising high PFCA and PFSA removal even at these low adsorbent loadings, such as over 90% removal of 6-10 carbon PFCAs. The removal of four carbon PFBA and five carbon PFPeA were 57% and 84%, respectively, which is unsurprisingly lower than their removal percentages at 10 mg L⁻¹ adsorbent loading. Yet, this performance is still promising because of the difficulty of short-chain PFCA removal.³ Exceptional removal was also observed for PFSAs (FIG. 2B), which were each removed to a greater extent than their PFCA counterparts with the same number of carbons. For example, 94% of four carbon PFBS was removed in NP matrix compared to the 57% removal of four carbon PFBA. Similar studies have corroborated the greater adsorptions of PFSAs than PFCAs on β-CD polymers and other adsorbents.^{15-16, 33, 36} We attribute this difference to PFSAs being more hydrophobic than PFCAs, due to PFSAs having one more fluorinated carbon atom than PFCAs with the same carbon number. The more effective removal of PFSAs by 6 once again highlights the importance of the cationic feature for anionic PFAS removal. To our knowledge, 1 mg L⁻¹ is the lowest β-CD adsorbent loading to achieve exceptional removal for anionic PFCA and PFSA in NP matrix at 1 μg L⁻¹ pollutant loading.

The inhibitory effect of inorganic ions on short-chain PFCAs and PFSA is apparent at a lower adsorbent 6 loading in SS matrix, with decreased removal performance as a function of decreasing fluoroalkyl chain length for both PFCAs and PFSAs. The removal of shorter chain PFCAs and PFSAs experienced significantly greater removal interference from inorganic ions than longer-chain analogues. The removal of four carbon PFBA decreased from 57% to 1% and five carbon PFPeA decreased from 84% to 12%. The virtually complete inhibition of adsorbent 6 implies that the removal of shorter-chain PFCAs relies heavily on electrostatic interactions. Four carbon and five carbon PFSA removals were less inhibited, with removals decreasing from 94% to 38% and 97% to 64%, respectively. The removal of longer-chain PFCAs and PFSAs were weakly inhibited. The removal of eight carbon PFOS decreased from 97% to 79% and the removal of ten carbon PFDA decreased from 97% to 65%. As noted previously, the uptake of longer-chain PFAS was less attenuated because of the more pronounced hydrophobic interaction with the β-CD cavities. Assuming that electrostatic attraction is rendered ineffective in the SS matrix, such as the case of four carbon PFBA, hydrophobic interactions become the primary interactions for removal. In NP matrix, 96% of PFOA was removed by adsorbent 6, whereas the removal decreased to 48% in SS matrix. This difference of approximately 50% in removal performance hints at a complementary nature of electrostatic and hydrophobic interactions.

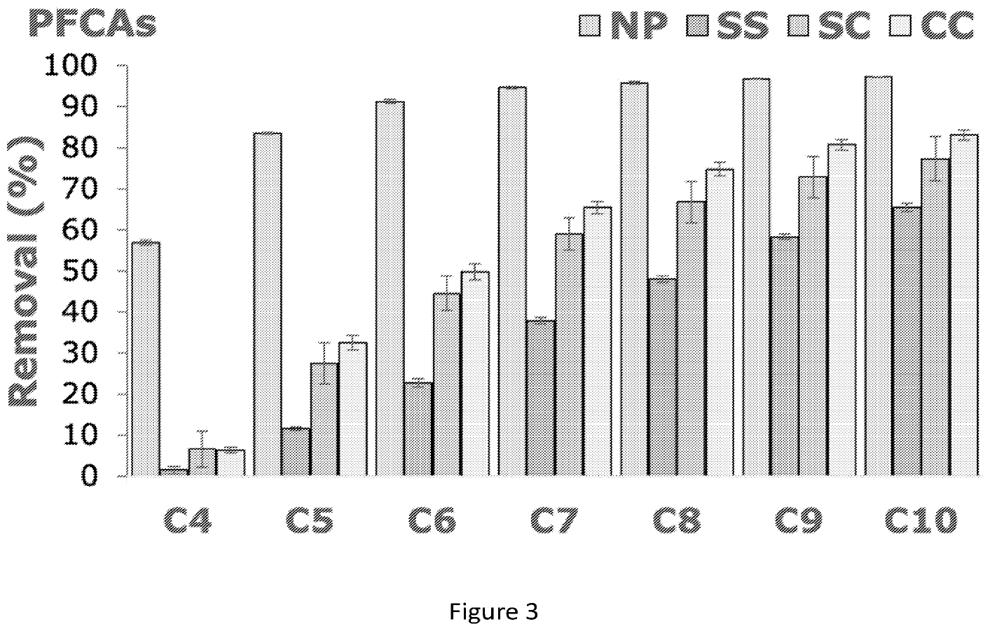

Monovalent and divalent inorganic ions were evaluated to further explore the importance of observed adsorption inhibition. We selected the following salts and concentrations: 1 mM Na₂SO₄ (SS), 2 mM NaCl (SC), and 1 mM CaCl₂) (CC) in order to generate comparable data with 2 mM of monovalent sodium or chloride ions and 1 mM of divalent sulfate or calcium ions (FIG. 3). The adsorbent 6 loading remained as 1 mg L⁻¹ with 1 μg L⁻¹ of the PFCA mixture. No significant differences (p≥0.05) were found when comparing the removal of PFCAs by adsorbent 6 in SC and CC matrix, suggesting that the cation valency does not impact inhibition. However, the anion valency was observed to impact inhibition as the removal of 5-10 carbon PFCAs were significantly (p<0.05) more inhibited in the divalent SS matrix than the monovalent SC matrix. Additionally, the type of anion may potentially affect inhibition to a varying extent. We attribute anion valency to either direct-site competition or a screening effect. For instance, one unit of divalent anion sulfate has a greater screening effect due to compression of the electrical double layer than two units of monovalent anion, where the compression is directly related to ionic strength which is proportional to the square of ion valency.

In summary, a modular, permanently porous, and crosslinked styrene-functionalized β-CD polymers with a controllable binding environment and tunable compositions of comonomers is used to remove PFASs of different chain lengths from water. The modularity of this platform and reliability of radical polymerization enabled a broad range of comonomers to be incorporated. This structural versatility in turn enables performance trends to be studied as a function of the adsorbent structure and water matrix. Adsorbent 6, with its cationic comonomer, achieved exceptional removal efficiencies of PFCAs and PFSAs at an adsorbent loading as low as 1 mg L⁻¹. The inhibition effect observed in SS matrix revealed a complementary interplay of hydrophobic and electrostatic interactions between the adsorbent and PFASs as a function of fluorocarbon chain lengths. We demonstrated that removal of shorter chain PFASs that are conventionally difficult to remove relies most strongly on electrostatic interactions, which are disrupted when salts are present in the matrix. The removal of longer chain PFASs is achieved through both hydrophobic and electrostatic interactions. These results demonstrate that styrene-functionalized β-CD polymers are promising adsorbents for the remediation of anionic PFAS. Furthermore, the materials might be tailored to target other organic micropollutants, including cationic and neutral PFAS by varying the comonomer structures.

### A. Materials and Instrumentation

### I. Materials

β-Cyclodextrin (97%) was provided by Wacker Chemical and dried at 80° C. under high vacuum prior to monomer synthesis. Iodine (>99.8%), triphenylphosphine (99%), styrene (>99%), [2-(Methacryloyloxy)ethyl]trimethylammonium chloride solution (MATMA, 80% in H₂O), 2,2′-Azobis(2-methylpropionitrile) (AIBN, 98%), sodium sulfate, and calcium chloride were purchased from Sigma Aldrich. Sodium chloride was purchased from Fisher Scientific. The chemicals were stored at room temperature and used as received. Two PFAS mixtures of anionic PFASs (PFC-MXA and PFS-MXA) and one mixture of PFAS isotope-labelled internal standards (ILISs) (MPFAC-MXA) were purchased from Wellington Laboratories, Inc. See PFAS and Internal Standards (Section F, Table 5) for a detailed list of the two PFAS mixtures and internal standards. For PFAS mixture preparation, see descriptions in that section.

### II. Instrumentations

Critical Point Dryer: Activation of polymers by supercritical CO₂ washing was performed on a Leica EM CPD 300. The polymer samples were stored in teabags for both Soxhlet extraction and supercritical CO₂ washing. After 14 h of Soxhlet extraction in methanol, the polymer samples were immediately transferred to the drying chamber of the critical point dryer (samples contain residual methanol). The drying chamber was cooled to 15° C. and filled with CO₂ at the “slow” setting with 120 s delay. After the delay, CO₂ exchange occurred at the speed setting of “5” for 20 cycles. The samples were then cooled to 40° C. on the “slow” setting and the pressure in the chamber was also relieved on the “slow 50%” setting.

Nuclear Magnetic Resonance (NMR) Spectroscopy: Solution ¹H and ¹³C NMR spectra were acquired on a Bruker AvanceIII-500 MHz spectrometer with a TXO 5 mm Prodigy probe w/Z-Gradient, or a Bruker AdvanceIII-500 MHz spectrometer with a CryoProbe 5 mm DCH w/Z-Gradient. All solution spectra were recorded at 25° C., and calibrated using DMSO-d₆ as an internal reference, 2.50 ppm for ¹H NMR and 39.52 ppm for ¹³C NMR. ¹H NMR data are reported as follows: chemical shift, multiplicity (d=doublet, dd=doublet of doublets, m=multiplet), and integration.

Solid-State Cross-Polarization Mass Angle Spinning ¹³C NMR spectra were acquired on a Bruker AvanceIII HD 400 MHz spectrometer with a 4 mm HX probe w/Z-Gradient. All solid-state NMR spectra were recorded at 25° C., and calibrated using adamantane as an external reference at 38.3 ppm for ¹³C NMR. The reference was converted to tetramethylsilane at 0.00 ppm. The sample spinning rate was controlled by a Bruker pneumatic MAS unit at 10 kHz, and 2048 scans were collected for each sample.

Fourier-Transform Infrared (FTIR) Spectroscopy: FTIR data were collected at room temperature on a Bruker Tensor 37 FTIR Spectrometer equipped with a Mid IR detector and KBr beam splitter. The spectrum was collected in attenuated total reflectance mode in the range of 3600 to 600 cm¹. The data were averaged over 32 scans. The OPUS software was used for the data acquisition.

High-Resolution Mass Spectroscopy (HRMS): High-resolution mass spectrum was acquired on an Agilent 6545 Q-TOF Mass Spectrometer, with Electrospray Ionization (ESI) as an ion source. The instrument is equipped with an Agilent 1200 Series HPLC binary pump and autosampler. Analysis was performed with direct injection with methanol as solvent. Data acquisition and analysis were done using Agilent MassHunter Data Workstation and Qualitative Analysis software.

Batch adsorption experiments were quantified using a ThermoFisher Scientific QExactive high-resolution quadrupole-orbitrap mass spectrometer coupled to a high performance liquid chromatography system. The trap column, a Hypersil Gold dC18 12 μm 2.1×20 mm, was purchased from Fischer Scientific. The analytical column, an Atlantis® dC18 5 μm 2.1×150 mm, was purchased from Waters. See Analytical Methods (Section E) for a detailed description of sample preparation and data collection and analysis.

Surface Area Analysis: The polymer porosity and Brunauer-Emmett-Teller surface areas (S_{BET}) were collected on a Micromeritics ASAP 2420 Accelerated Surface Area and Porosity Analyzer. Approximately 40 mg of polymer was used for each analysis. The polymers were degassed at 100° C. for 24 h until the off-gas rate was constantly reading less than 0.2 μmHg/min. N₂ isotherms were generated by incremental exposure to ultrahigh purity nitrogen up to 1 atm in a liquid nitrogen bath at 77K. The S_{BET} were calculated using the linear region (P/P₀ of 0.05-0.1) of the isotherm using adsorption models included in the instrument software (Micromeritics ASAP-2420 V4.00).

Elemental Analysis of C, H, N, and S: Elemental analysis was performed by Robertson Microlit Laboratories. Combustion analysis was used for carbon, hydrogen, and nitrogen on a Perkin-Elmer Model 2400 CHN Analyzer, and titration was used for sulfur. For monomer, the elemental analysis result was compared to calculated values. For polymers, see the Polymer Characterization (Section D, V. Elemental Analysis) for a detailed analysis for determining the ratio of comonomers with respect to monomers.

### B. Synthesis Procedures

### Synthesis of 1, 2, and 3 is Shown in FIG. 20

Synthesis of 1 (Heptakis-(6-deoxy-6-iodo)-β-Cyclodextrin): Literature procedures^{1,2} were followed to replace the primary alcohol at 6′ position with iodine with the following modifications: Soxhlet in methanol was not carried out, because the large scale of products rendered Soxhlet ineffective. Instead the product was suspended in methanol for several days and filtered until filtrate ran clean. Note: Solvents do not need to be dried or degassed. (Yield 91%)

Synthesis of 2 (Heptakis-(6-deoxy-6-mercapto)-β-Cyclodextrin): Literature porcedures^{1, 2} were followed to convert the iodines to thiols with the following modifications: After NaHSO₄ precipitation and filtration, the product was suspended in methanol and filtered twice. The solid was then subjected to a rotary evaporation at 30° C. for 3 h before being placed on a high vacuum line for 48 h at room temperature. Note: Solvents during synthesis must be degassed and the product must be stored away from light in a freezer. (Yield 92%)

Synthesis of 3 (Heptakis-(6-deoxy-6-vinylbenzyl)-β-Cyclodextrin): 2 (17.591 g, 14.102 mmol) was dissolved in DMSO (170 mL) and degassed with nitrogen sparging for 30 min. Potassium carbonate (6.8213 g, 49.357 mmol) was added and the solution was stirred for an additional 30 min. 4-vinylbenzyl chloride (14.11 mL, 100.123 mmol) was then added dropwise to the solution under N₂ pressure. The solution was stirred at room temperature. After 24-32 h the solution was precipitated into water (1500 mL) and stirred for an additional 10 min before filtering. The filtrate was wash with copious amounts of methanol, superficially dried, then resuspended in methanol (600 mL). After 30 min, the solution was filtered again, and the filter cake was resuspended in methanol (600 mL). After 30 min, the solution was filtered again, superficially dried and transferred to a drying flask and subjected to rotary evaporation for an additional 3 h at 35° C. The powder was then transferred onto a high vacuum line and dried at room temperature for 24-48 h. Note: Powder is not bench stable for long periods of time (>30 days); store in freezer away from light. (Yield 89%)

¹H NMR (500 MHz, DMSO-d₆) δ 7.24 (d, 14H), 7.14 (d, 14H), 6.62 (dd, 7H), 5.95 (d, 7H), 5.90 (d, 7H), 5.71 (dd, 7H), 5.20 (dd, 7H), 4.92 (d, 7H), 3.75 (m, 7H), 3.58 (m, 14H), 3.35 (m, 14H), 3.11 (d, 7H), 3.81 (dd, 7H) ppm.

¹³C NMR (126 MHz, DMSO-d₆): δ 138.64, 136.60, 135.89, 129.62, 126.26, 114.26, 102.36, 85.54, 72.90, 72.65, 72.44, 36.92, 33.48 ppm.

ESI HRMS m z calculated for C₁₀₅H₁₂₆O₂₈S₇([M-H]⁻) 2059.65; found 2058.6437.

Elemental Analysis (%) calculated for C₁₀₅H₁₂₆O₂₈S₇: C, 61.20; H, 6.18; 0, 21.74; S, 10.89. Found C, 58.84; H, 5.99; 0, 10.73; S, 24.28.

General Polymerization for 4, 5, and 6: Synthesis of 4, 5, and 6 is shown in FIG. 20.

Monomer 3 (0.600 g, 0.291 mmol) and AIBN (0.019 g, 0.116 mmol) were dissolved in DMF (2 mL). Two equivalence of comonomer (0.582 mmol) were added as a liquid; comonomers consisted of styrene, methyl methacrylate, or MATMA (aqueous 80%). Note: Two equivalents was determined to be optimal equivalency, see Optimal Comonomer Equivalency Test (Section H). The monomer solution was transferred into a dry Schlenk flask, subjected to 3 freeze-pump-thaw cycles and heated to 80° C. for 1 h. Polymer gelled after 15 min and was heated for an additional 45 mins. After 1 h total reaction time, the solid gel was broken apart with a metal spatula, suspended in methanol, transferred to a teabag, and sealed with staples. This teabag was subjected to a Soxhlet extractor with methanol for 14 h before activating the polymer with supercritical CO₂ (80 cycles, 4 h). The polymer was then crushed into a fine powder and isolated. (yields: 89-97%)

See ¹³C ssNMR spectra of (4), (5), and (6) below.

S_{BET}: (4) 402 m² g⁻¹, (5) 392 m² g⁻¹ and (6) 237 m² g⁻¹.

Elemental Analysis was used to calculate comonomer:β-CD ratio: (4) 1.76, (5) 1.21, and (6) 1.99. See Section D, V for a sample calculation.

### C. Monomer Characterization

Functionalized CD monomer was characterized by ¹H and ¹³C NMR as shown in FIGS. 4 and 5.

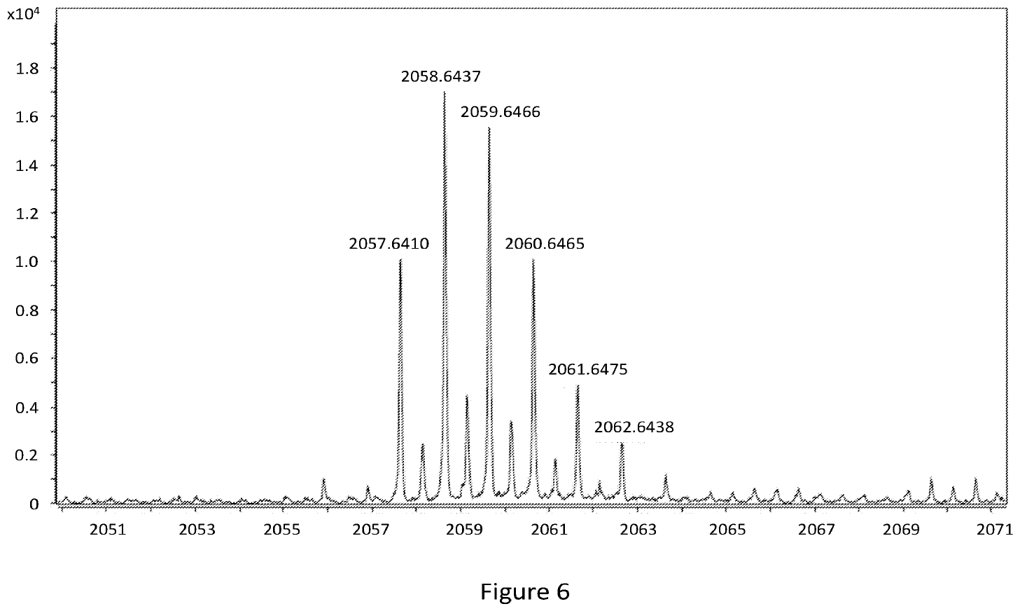

HRMS of 3 in chloroform as also performed. The most abundant adduct is 2058.6437, corresponding to [M-H]⁻ (calculated 2059.65). Other peaks correspond to the isotopic masses of 3 (FIG. 6). The spectrum was obtained in negative mode.

### D. Polymers Characterization

### I. Solid State ¹³C NMR

Solid state ¹³C NMR spectra for 4, 5, and 6 are shown in FIGS. 7-9.

### II. FT-IR

FT-IR spectra for 3, 4, 5, and 6 are shown in FIGS. 10-13.

### III. N₂ Isotherms

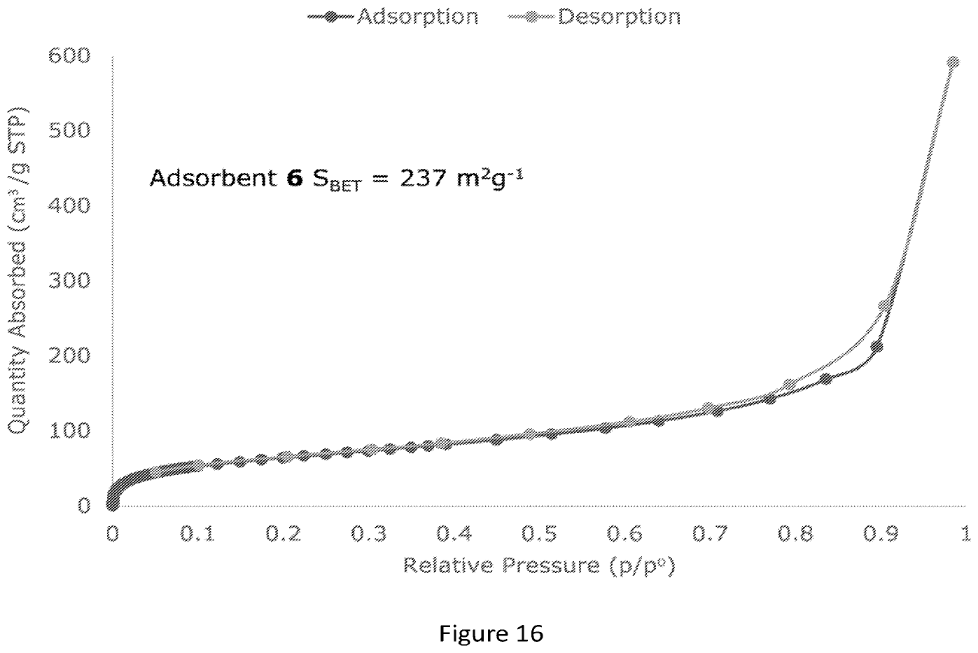

N₂ isotherms for 4, 5, and 6 are shown in FIGS. 14-17.

### IV. Zeta Potentials

TABLE 2
Zeta potentials of polymers (100 mg
L⁻¹) measured in 0.9 mM CaCl₂ solution.

| Adsorbent | Zeta Potential (mV) |
|---|---|
| 4 | −8.2 ± 0.6 |
| 5 | −9.9 ± 0.9 |
| 6 | +23.8 ± 1.6 |

### V. Elemental Analysis

TABLE 3
Comonomer:β-CD Ratio for 4, 5, and 6.

| | C | H | N^{a} | S | |
|---|---|---|---|---|---|
| Adsorbents | (%) | (%) | (%) | (%) | Comonomer:β-CD^{b} |
| 4 | 56.84 | 6.20 | 8.92 | 0.14 | 1.76 |
| 5 | 54.50 | 6.31 | 9.17 | 0.21 | 1.21 |
| 6 | 52.56 | 6.50 | 8.11 | 1.18 | 1.99 |

^{a}N content for 4 and 5 is below the instrument threshold.
^{b}The Comonomer:β-CD ratio was calculated from a system of equations. The following sample calculation was for 4, but 5 and 6 were calculated with the same analysis.

### Sample Calculation for 4.

The system of equations was set up such that,
a=mol modified of β-CD
b=mol of comonomer

Polymer 4 consists of two components: modified β-CD and the comonomer styrene. The molecular formula of modified β-CD is C₁₀₅H₁₂₆O₂₈S₇, and the molecular of the comonomer styrene is C₈H₈. The total mol of C, H, or S follows,

$$Total mol C = 105 a + 8 b$$

$$Total mol H = 12 \; 6 a + 8 b$$

$$Total mole O = 28 a \& Total mol S = 7 a$$

where the total mol of C is a sum from modified β-CD and comonomer. Because styrene does not contain O or S, it is primarily from modified β-CD portion of 4. S was used to calculate the mol of modified β-CD.

$$a = \frac{S}{7}$$

We converted the raw % elemental analysis data (Table 3) to mol for each element by arbitrarily assuming a 1 g of the sample and dividing it by the element's molar mass. The converted mol amount of each element was used in the system of equations equation:

$$b = \frac{Total mol C - 105 a}{8}$$

where resulting b is the mol of the comonomer in 4. The comonomer:β-CD ratio was determined by diving a into b.

### E. Analytical Methods

Quantification of target PFCAs or PFSAs after Batch Equilibrium Adsorption Experiments (Section G) was conducted using a HPLC coupled with HRMS (QExactive, quadrupole-orbitrap, ThermoFischer Scientific) using an established parallel reaction monitoring (PRM) method optimized for PFAS quantification.³ Previously established methods were also used for HPLC parameters.⁴⁻⁶ HPLC-MS was operated with electrospray ionization in negative polarity mode for all PFAS measurements. A detailed list of analytical information is provided in Table 4, and a summary of PFAS mixtures and their isotope-labeled internal standards (ILISs) is provided in Table 5. Matrix-matched calibration standards (n=9) were prepared with concentrations ranging between 0 ng L⁻¹ to 1000 ng L⁻¹. Analytes were quantified from the calibration standards (spiked with same concentration of ILISs) based on the PFAS target-to-ILIS peak area ratio responses of the designated quantitation product ion by linear least-squares regression. Calibration curves were run at the beginning of the analytical sequence. Instrument blanks and quality control (QC) samples were run before and after the calibration curve to ensure minimal carryover and adequate MS performance (QC tolerance set at +30%). PFAS spike controls were used to determine the PFAS recovery rate during analysis; recovery rate threshold was set at +50% for reach PFAS to be considered as reliable data.

The mobile phase consisted of (A) LC-MS grade water amended with 20 mM ammonium acetate and (B) LC-MS grade methanol. Samples were injected at 5 mL volumes onto a Hypersil Gold dC18 12 μm 2.1×20 mm trap column (Fisher Scientific) at room temperature using an isocratic mobile phase of 99% (A), pumped at 1 mL·min⁻¹ via a low-pressure loading pump. Elution from the trap column and subsequent separation of analytes on an Atlantis® dC18 5 μm 2.1×150 mm analytical column (Waters) at 25° C. was achieved using an initial mobile phase of 60% (A), pumped at 0.3 mL·min⁻¹ via a high-pressure elution pump. The isocratic mobile phase delivered from the loading pump changed to 2% (A) at 37.3 minutes to rinse the trap column and returned to 99% (A) at 41.3 minutes to prepare for the next sample injection. The mobile phase gradient delivered from the loading pump remained at 60% (A) until 6.1 minutes and then increased linearly to 10% (A) at 30.1 minutes. The mobile phase was held at 10% (A) until 37.1 minutes before it returned to 60% (A) to prepare for the next sample. The chromatography program had a total duration of 42.1 minutes.

TABLE 4
Analytical information of PFAS target compounds and their ILISs for PRM.

| | | | Precursor | Product | Retention | Normalized | |
|---|---|---|---|---|---|---|---|
| | Molecular | | Ion Mass | Ion Mass | Time | Collision | |
| Acronym | Formula | Adduct | (Da) | (Da) | (min) | Energy | ILISs |
| PFBS | C₄HF₉O₃S | [M − H]⁻ | 298.9430 | 79.9557 | 13.71 | 60 | 18O2-PFHxS |
| PFHxS | C₆HF₁₃O₃S | [M − H]⁻ | 398.9366 | 79.9557 | 19.80 | 60 | 18O2-PFHxS |
| PFHpS | C₇HF₁₅O₃S | [M − H]⁻ | 448.9334 | 79.9557 | 22.11 | 60 | 13C4-PFOS |
| PFOS | C₈HF₁₇O₃S | [M − H]⁻ | 498.9302 | 79.9558 | 24.04 | 60 | 13C4-PFOS |
| PFBA | C₄HF₇O₂ | [M − H]⁻ | 212.9792 | 168.9897 | 9.70 | 20 | 13C4-PFBA |
| PFPeA | C₅HF₉O₂ | [M − H]⁻ | 262.9760 | 218.9863 | 13.19 | 20 | 13C2-PFHxA |
| PFHxA | C₆HF₁₁O₂ | [M − H]⁻ | 312.9728 | 268.9829 | 16.79 | 20 | 13C2-PFHxA |
| PFHpA | C₇HF₁₃O₂ | [M − H]⁻ | 362.9696 | 318.9794 | 19.75 | 20 | 13C4-PFOA |
| PFOA | C₈HF₁₅O₂ | [M − H]⁻ | 412.9664 | 368.9767 | 22.16 | 20 | 13C4-PFOA |
| PFNA | C₉HF₁₇O₂ | [M − H]⁻ | 462.9632 | 418.9737 | 24.17 | 20 | 13C5-PFNA |
| PFDA | C₁₀HF₁₉O₂ | [M − H]⁻ | 512.9600 | 468.9703 | 25.87 | 20 | 13C2-PFDA |

### F. PFAS and Internal Standard List

The PFC-MXA mixture contains eleven PFCAs (C4 through C14) dissolved in methanol each at a concentration of 2 mg L⁻¹. The PFS-MXA mixture contains five PFSAs (C4, C6-C8, and C10) dissolved in methanol each at a concentration of 2 mg L⁻¹. The MPFAC-MXA mixture contains seven isotope-labelled PFCAs (C4, C6, C8-C12) and two isotope-labelled PFSAs (C6 and C8) dissolved in methanol each at a concentration of 2 mg L⁻¹. The PFAS standard spike mixtures were diluted from the stock mixtures (PFC-MXA and PFS-MXA) using nanopure water to yield a concentration of 1 mg L¹. The ILIS spike mixture was diluted from MPFAC-MXA using nanopure water to yield a concentration of 250 μg L⁻¹. The stock mixtures and the spike mixtures were stored at −20° C. and 4° C., respectively.

TABLE 5
PFAS target compounds and their isotopically labeled internal standards (ILISs)

| Mixture | | | Molecular | | |
|---|---|---|---|---|---|
| Name | Name | Acronym | Formula | Concentration | Solvent |
| PFC-MXA | Perfluorobutanoic acid | PFBA | C₄HF₇O₂ | 2 mg/L | MeOH:H₂O |
| | | | | | (H₂O < 1%) |
| PFC-MXA | Perfluoropentanoic acid | PFPeA | C₅HF₃O₂ | 2 mg/L | MeOH:H₂O |
| | | | | | (H₂O < 1%) |
| PFC-MXA | Perfluorohexancic acid | PFHxA | C₆HF₁₂O₂ | 2 mg/L | MeOH:H₂O |
| | | | | | (H₂O < 1%) |
| PFC-MXA | Perfluoroheptanoic acid | PFHpA | C₇HF₁₃O₂ | 2 mg/L | MeOH:H₂O |
| | | | | | (H₂O < 1%) |
| PFC-MXA | Perfluorooctanoic acid | PFOA | C₈HF₁₅O₂ | 2 mg/L | MeOH:H₂O |
| | | | | | (H₂O < 1%) |
| PFC-MXA | Perfluorononanoic acid | PFNA | C₉HF₁₇O₂ | 2 mg/L | MeOH:H₂O |
| | | | | | (H₂O < 1%) |
| PFC-MXA | Perfluorodecanoic acid | PFDA | C₁₀HF₁₉O₂ | 2 mg/L | MeOH:H₂O |
| | | | | | (H₂O < 1%) |
| PFC-MXA | Perfluoroundecanoic acid | PFUnA | C₁₁HF₂₁O₂ | 2 mg/L | MeOH:H₂O |
| | | | | | (H₂O < 1%) |
| PFC-MXA | Perfluorododecanoic acid | PFDoA | C₁₂HF₂₃O₂ | 2 mg/L | MeOH:H₂O |
| | | | | | (H₂O < 1%) |
| PFC-MXA | Perfluorotridecanoic acid | PFTrDA | C₁₃HF₂₅O₂ | 2 mg/L | MeOH:H₂O |
| | | | | | (H₂O < 1%) |
| PFC-MXA | Perfluorotetradecanoic acid | PFTeDA | C₁₄HF₂₇O₂ | 2 mg/L | MeOH:H₂O |
| | | | | | (H₂O < 1%) |
| PFS-MXA | Perfluorobutanesulfonic acid | PFBS | C₄HF₅O₃S | 2 mg/L | 100% |
| | | | | | Methanol |
| PFS-MXA | Perfluorohexanesulfonic acid | PFHxS | C₆HF₁₃O₃S | 2 mg/L | 100% |
| | | | | | Methanol |
| PFS-MXA | Perfluoroheptanesulfonic acid | PFHpS | C₇HF₁₅O₃S | 2 mg/L | 100% |
| | | | | | Methanol |
| PFS-MXA | Perfluorooctanesulfonic acid | PFOS | C₈HF₁₇O₃S | 2 mg/L | 100% |
| | | | | | Methanol |
| PFS-MXA | Perfluorodecanesulfonic acid | PFDS | C₁₀HF₂₁O₃S | 2 mg/L | 100% |
| | | | | | Methanol |
| MPFAC- | Perfluoro-n-[1,2,3,4- | 13C4 - | [13]C₄HF_{γ}O₂ | 2 mg/L | MeOH:H₂O |
| MXA | 13C4]butanoic acid | PFBA | | | (H₂O < 1%) |
| MPFAC- | Perfluoro-n-[1,2- | 13C2 - | [13]C₂C₄HF₃₁O₂ | 2 mg/L | MeOH:H₂O |
| MXA | 13C2]hexanoic acid | PFHxA | | | (H₂O < 1%) |
| MPFAC- | Perfluoro-n-[1,2,3,4- | 13C4 - | [13]C₄C₄HF₁₅O₂ | 2 mg/L | MeOH:H₂O |
| MXA | 13C4]octanoic acid | PFOA | | | (H₂O < 1%) |
| MPFAC- | Perfluoro-n-[1,2,3,4,5- | 13C5 - | [13]C₅C₄HF₁₇O₂ | 2 mg/L | MeOH:H₂O |
| MXA | 13C5]nonanoic acid | PFNA | | | (H₂O < 1%) |
| MPFAC- | Perfluoro-n-[1,2- | 13C2 - | [13]C₂C₈HF₁₉O₂ | 2 mg/L | MeOH:H₂O |
| MXA | 13C2]decanoic acid | PFDA | | | (H₂O < 1%) |
| MPFAC- | Perfluoro-n-[1,2- | 13C2 - | [13]C₂C₉HF₂₁O₂ | 2 mg/L | MeOH:H₂O |
| MXA | 13C2]undecanoic acid | PFUnA | | | (H₂O < 1%) |
| MPFAC- | Perfluoro-n-[1,2- | 13C2 - | [13]C₂C₁₀HF₂₃O₂ | 2 mg/L | MeOH:H₂O |
| MXA | 13C2]dodecanoic acid | PFDoA | | | (H₂O < 1%) |
| MPFAC- | Sodium perfluoro-1- | 18O2 - | C₆HF₁₃[18]O₂OS | 2 mg/L | MeOH:H₂O |
| MXA | hexane[18O2]sulfonate | PFHxS | | | (H₂O < 1%) |
| MPFAC- | Sodium perfluoro-1-[1,2,3,4- | 13C4 - | [13]C₄C₄HF₁₇O₂S | 2 mg/L | MeOH:H₂O |
| MXA | 13C4]octanesulfonate | PFOS | | | (H₂O < 1%) |

Note:
All of the above chemicals were purchased from Wellington Laboratories. Certain PFCAs and PFSAs did not make the spike-recovery threshold and were subsequently removed from the rest of the studies.

### G. Batch Equilibrium Adsorption Experiments

Adsorption experiments (also referred to as removal experiments) were conducted in 15 mL polypropylene centrifuge tubes (Corning) with either 10 mL of nanopure water or salt-amended nanopure water, with the following concentrations: 1 mM Na₂SO₄, 2 mM NaCl, or 1 mM CaCl₂ as previously described.⁴⁻⁶ All adsorption experiments were conducted with either the PFCA or the PFSA mixture (Table 4) at an initial concentration of 1 μg L⁻¹ at pH of 5.5 to 6, and adsorbent loadings at 1 mg L⁻¹, 10 mg L⁻¹, or 100 mg L⁻¹ in triplicate. Prepared centrifuge tubes were placed on a tube revolver and rotated at 40 rpm at 23° C. for 48 h to reach equilibrium in adsorption. After rotating, samples were filtered through 0.45 m cellulose acetate filters (Restek) and transferred into 10 mL glass LC-MS vials (Fischer Scientific). All triplicate samples were spiked with ILISs and stored at 4° C. until analysis. Control experiments were conducted in triplicate using the same procedure, but without adsorbents. The average and the standard deviation of PFAS removal efficiency were calculated based on the triplicate concentrations of each PFAS in the experimental group and the control group. The PFAS removal efficiency (%) by adsorbents were determined using Eq. S2:

$$Removal ( \% ) = \frac{{C}_{0} - {C}_{f}}{{C}_{0}} \times 100 ; \qquad Equation S 2$$

where C₀ (g L⁻¹) and C_{f} (μg L⁻¹) are the initial and residual concentration at 48 h of PFAS, respectively. The initial concentration C₀ was obtained from the average concentration of control samples to account for the loss of PFAS from experimental conditions.

### H. Optimal Comonomer Equivalency Test

The optimal equivalency of the comonomer for polymerization was determined. Polymer formulations of 0.5, 1, 4, or 10 equivalencies of comonomer MMA, with respect to 3, were synthesized in the same condition as 5, which all resulted in high yields (90-93%) and high S_{BET}(150-300 m² g⁻¹) [denoted as 5_0.5, 5_1, 5_4, and 5_10]. Note, 5 contains two equivalents of comonomer MMA. Each polymer was subjected to the same equilibrium adsorption experiment as previously described (see Section G). Specifically, the polymers were loaded at 40 mg L⁻¹ to remove PFOA with an initial concentration of 40 mg L⁻¹ in nanopure water (NP) or 1 mM NaSO₄ (SS) matrix (FIG. 17). No statistical significances were found in removal efficiencies among the adsorbents in SS matrix. In NP matrix, two equivalents of MMA (5) yielded best removal performance. Based on this data, two commoner equivalencies were selected for the remaining polymerizations and PFAS removal studies. We acknowledge this study is not meant to be accurate or representative for the other comonomers in 4 and 6. However, selecting a particular equivalence allowed us to minimize the number of conditions to test and obtain comparable data.

### I. Additional Removal Experiments Using 4 and 5

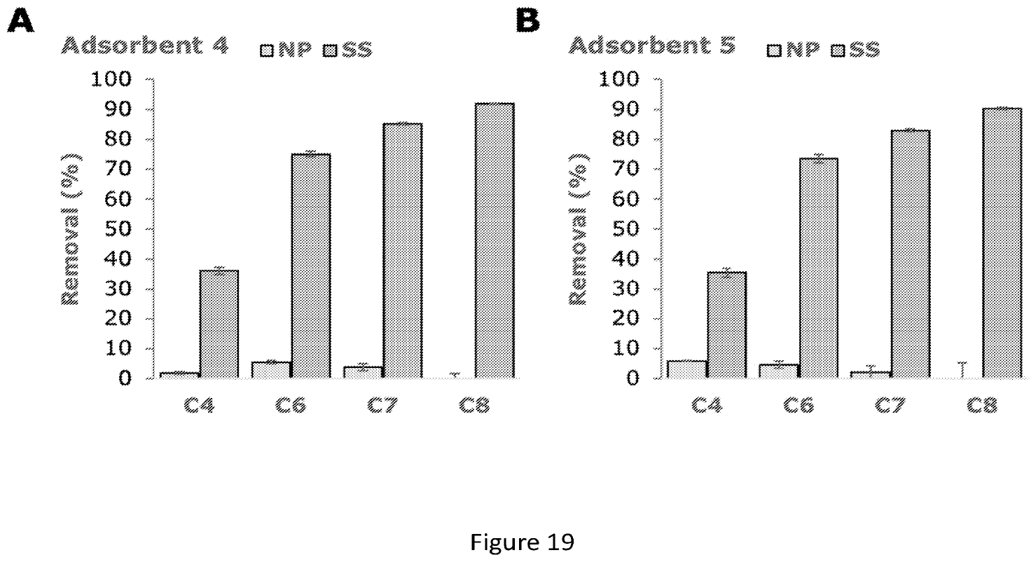

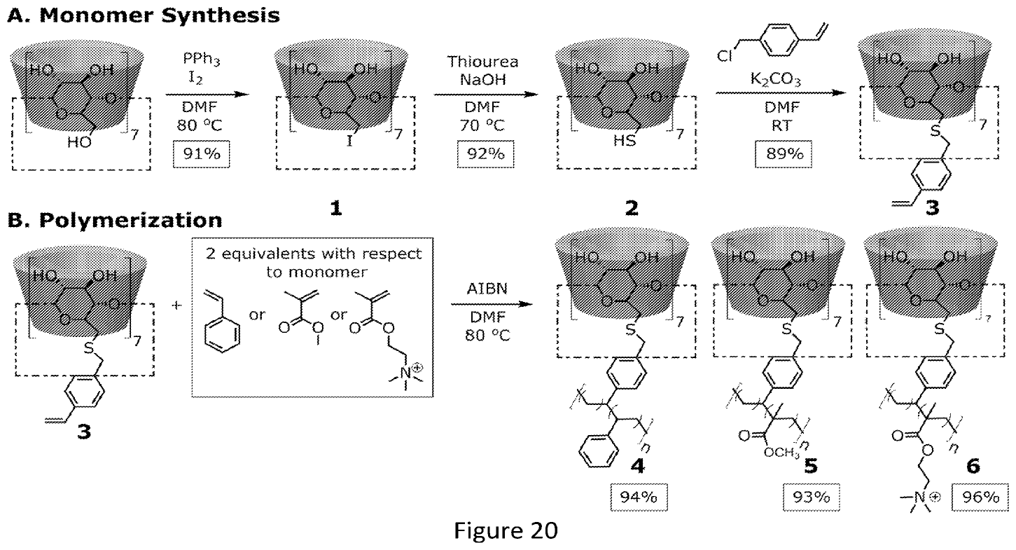

Adsorbent loadings of 4 and 5 were adjusted from 10 mg L⁻¹ to 100 mg L⁻¹ to better probe the magnitude of the enhanced adsorptions of PFCAs and PFSAs observed in SS matrix (FIGS. 18-19). In NP matrix, 4 and 5 exhibited very low adsorption of PFCAs and PFSAs. In SS matrix, the adsorption was significantly enhanced, such as the removal of eight carbon PFOA from 8.5% to 83.9% by 4 and the removal of eight carbon PFOS from 0% to 90.3% by 5. The enhancement effect was more profound for longer-chain PFCAs and PFSAs, highlighting the importance of hydrophobic interactions.

### J. Ruling Out Competitive Adsorption

The experiments with the mixture of PFSAs (FIG. 2B) ruled out competitive adsorption among the PFASs in the same mixture as a confounding variable. Competitive adsorption of PFASs is usually explained by longer-chain PFASs replacing shorter-chain PFASs on the adsorbent surface over time due to the greater hydrophobic interactions. If competitive adsorption were a factor for the PFCAs where eleven species were examined at 1 μg L⁻¹, then the four PFSAs which were also at 1 μg L⁻¹ should exhibit less of a chain-length effect because there would be fewer long-chain PFSAs to compete with the short-chain PFSAs. Because we observed no weaker extent of adsorption inhibition or enhancement as a function of chain-length for the PFSAs as we observed with the PFCAs (i.e., the absolute values of slopes between removal difference and CF₂ chain length of PFSAs are all 10%-20% larger than those of PFCAs for all three adsorbents), competitive adsorption was ruled out as a possible confounding factor in the study. Finally, considering 6 in both matrices, and 4 and 5 in 1 mM SS matrix, the PFSAs are better removed than the PFCAs with the same CF₂ chain length, which corroborates other studies that have noted the greater adsorption of PFSAs on CDPs and other adsorbents.

### K. References for Example 1

1. Rojas, M. T.; Koniger, R; Stoddart, J. F.; Kaifer, A. E., Supported Monolayers Containing Preformed Binding Sites. Synthesis and Interfacial Binding Properties of a Thiolated 3-Cyclodextrin Derivative. J. Am. Chem. Soc. 1995, 117, 336-343.
2. Ashton, P. R.; Koniger, R.; Stoddart, J. F.; Alker, D.; Harding, V. D., Amino Acid Derivatives of β-Cyclodextrin. J. Org. Chem. 1996, 61, 903-908.
3. Haghani, A.; Eaton, A.; Eaton, E.; Jack, R.; Bromirski, M.; Thermo Fisher Scientific. Secondary Validation Study for EPA Method 537.1 Using Automated SPE Followed by LC-Q Exactive Orbitrap MS; 2019.
4. Ching, C.; Klemes, M. J.; Trang, B.; Dichtel, W. R.; Helbling, D. E. β-Cyclodextrin Polymers with Different Crosslinkers and Ion Exchange Resins Exhibit Variable Adsorption of Anionic, Zwitterionic, and Non-Ionic PFASs. Environ. Sci. Technol. 2020, 54, 12693-12702.
5. Wang, R.; Ching, C.; Dichtel, W. R.; Helbling, D. E. Evaluating the Removal of Per- and Polyfluoroalkyl Substances from Contaminated Groundwater with Different Adsorbents Using a Suspect Screening Approach. Environ. Sci. Technol. Lett. 2020, 7, 954-960.
6. Wu, C.; Klemes, M. J.; Trang, B.; Dichtel, W. R.; Helbling, D. E. Exploring the Factors That Influence the Adsorption of Anionic PFAS on Conventional and Emerging Adsorbents in Aquatic Matrices. Water Res. 2020, 182, 115950.

### Example 2

A β-CD polymer bearing quaternary ammonium groups was synthesized through free radical polymerization. The polymer was evaluated for the removal efficiencies of 13 trace organic contaminants (TrOCs) that were spiked into nanopure water and municipal wastewater, and benchmarked to two commercial adsorbents: a regenerable granular activated carbon Filtrasorb 600 and a single-use anion exchange resin Amberlite PSR2+. Batch adsorption experiments and rapid small-scale column tests offered important insights into the performance of the β-CD polymer for removal of 13 TrOCs under environmentally relevant conditions in this complex water matrix. The β-CD polymer exhibited superior TrOCs removal performance and resisted fouling by wastewater constituents most effectively compared to the benchmarks. The β-CD polymer can readily be regenerated and, when packed in a fix-bed column, demonstrated late breakthroughs, indicating high adsorbent capacities, rapid adsorption kinetics and narrow mass transfer zones. Together, these studies further demonstrate β-CD polymer as promising adsorbents for practical wastewater remediation.

### A. Synthesis and Characterization of StyDex Monomer and Polymer

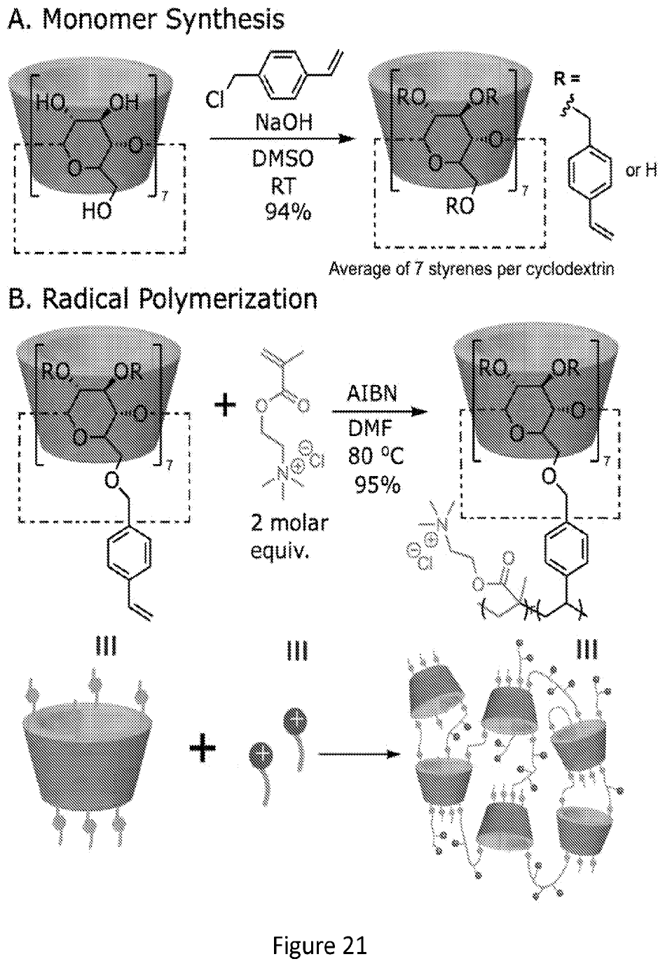

To prepare StyDex monomers, styrene groups were installed at the hydroxyl groups at the 2′, 3′ and 6′ positions of β-CD via direct etherification reactions with 4-vinylbenzyl chloride as the electrophile (FIG. 21). This reaction was performed at room temperature with an isolated yield of 94%, after precipitation and washing of the solid product. The StyDex monomer was characterized by 1H nuclear magnetic resonance (NMR) spectroscopy, matrix-assisted laser desorption/ionization time-of-flight mass spectroscopy (MALDI-TOF MS), Fourier Transformed Infrared (FTIR) spectroscopy, and combustion elemental analysis. The 1H NMR spectrum of StyDex monomer indicated successful installation of styrene groups, based on appearance of aromatic and vinyl proton resonances in the 5.0-7.5 ppm region. On average, 7.6 styrene groups per β-CD molecule was determined from the integration of aromatic proton resonances relative to β-CD proton resonances in the 3.5-5.0 ppm region. Despite the primary hydroxyl groups (6′) being less sterically hindered and more nucleophilic than the secondary hydroxyl groups (2′ and 3′), the etherification in the presence of NaOH and 4-vinylbenzyl chloride was not selective, yielding StyDex monomers with a distribution of styrene groups per β-CD molecule. Based on the broadening of the β-CD proton resonances, we assign the styrene-functionalized monomer to have polymerizable styrene groups on both faces of the β-CD ring. Selective functionalization of the primary OH groups provide monomers with much more well-defined proton resonances. MALDI-TOF MS of StyDex monomers was also consistent with the incorporation of 7.6 average styrene groups per β-CD molecule, based on a distribution of [M+Na]+ adducts ranging from 1388.46 m/z to 2549.59 m/z in the full-scan chromatogram. The most abundant peaks, 1969.53 m/z and 2085.54 m/z, correspond to the theoretical masses of seven and eight styrene groups per β-CD molecule, respectively. FTIR spectroscopy and combustion elemental analysis were also consistent with the expected structure.

The styrene groups of StyDex monomers are potentially compatible with hundreds of commercially available vinyl comonomers and different radical polymerization methods. This versatility is advantageous in targeting a broad scope of TrOCs. For this study, we prepared a polymer based on the StyDex monomer and a cationic methacrylate monomer bearing quaternary ammonium groups, which were copolymerized using azobisisobutyronitrile (AIBN) in DMF at 80° C., with an isolated yield of 95% after 15 h Soxhlet extraction in methanol and activation by supercritical CO₂ washing. Cationic StyDex formed porous and cross-linked polymer network with permanent surface charge. The polymer was characterized using solid-state cross-polarization magic angle spinning ¹³C NMR spectroscopy, N₂ porosimetry, FTIR spectroscopy, combustion elemental analysis and (potentials. Solid state ¹³C NMR spectroscopy confirmed the successful incorporation of the comonomers. The resonance corresponding to the vinyl carbons (113 ppm) of StyDex monomer was not detected, indicating a high degree of cross-linking of the styrene groups. The resonances corresponding to the polymer backbone were detected in the broadened alkane regions (20-55 ppm). Carbonyl carbons of the comonomers were detected around 180 ppm. Furthermore, the characteristic N-methyl carbons (55 ppm) were detected in spectrum of Cationic StyDex. The porosity and Brunauer-Emmett-Teller surface area (SBET) of Cationic StyDex, F600 and PSR2+ were characterized by N₂ porosimetry. Cationic StyDex exhibited permanent porosity and high SBET of 260 m² g⁻¹, with the most abundant pore width around 22 Å. F600 exhibited a SBET of 840 m² g⁻¹, with the most abundant pore width around xx A. PSR2+ was not porous under these conditions. Cationic StyDex was found to have strongly positive surface charge, corresponding to a (potential of 10 mV, and consistent with the incorporation of free cations into the polymer. Combustion elemental analysis and FTIR of Cationic StyDex was consistent with its expected structures. This characterization confirmed the porous and cross-linked nature of Cationic StyDex, which was used to remove TrOCs from nanopure water and municipal wastewater.

### B. Batch Adsorption Experiments Validation

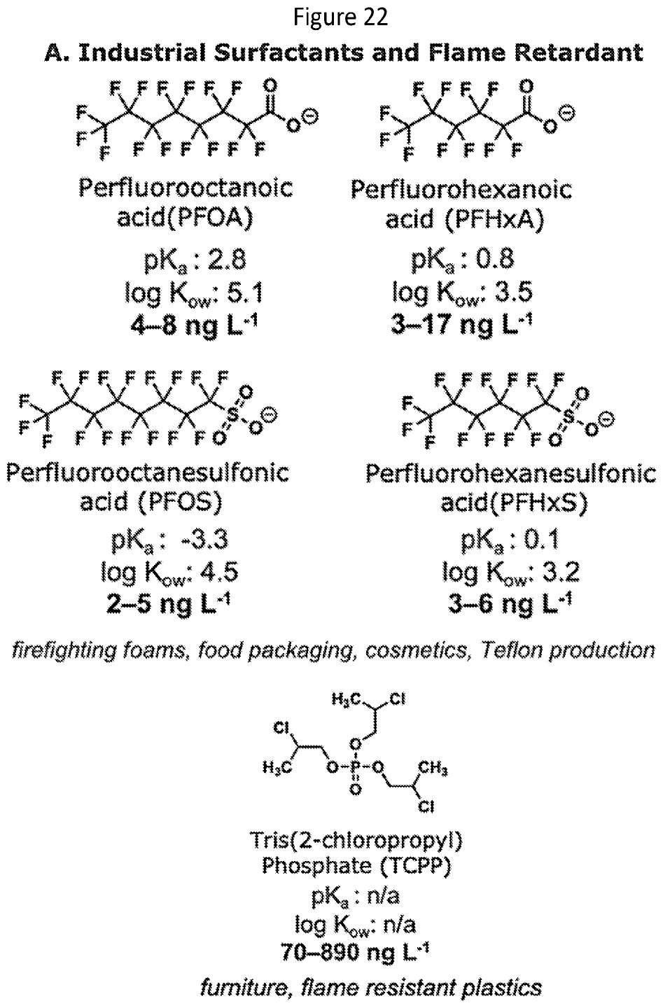

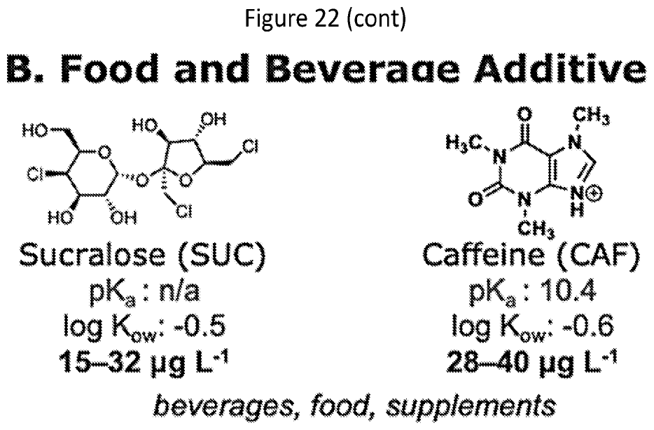

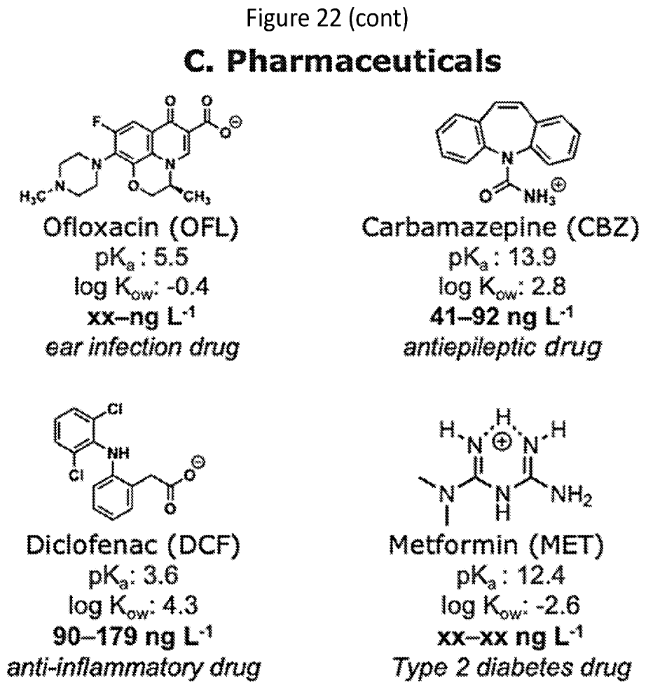

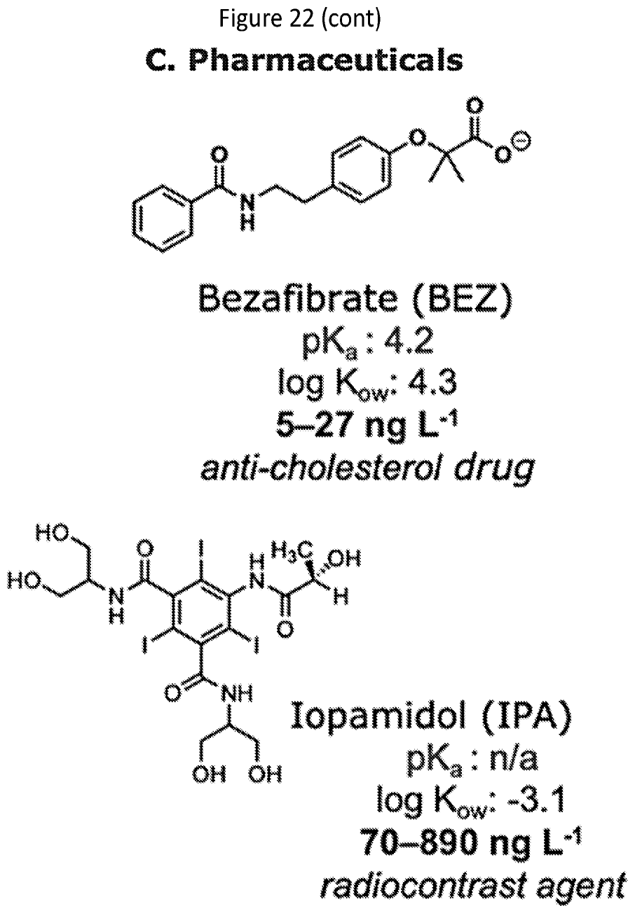

Given the trace analysis nature of this study and a diverse list of TrOCs (FIG. 22), consumables used in batch adsorption experiments were investigated for nonspecific interactions with TrOCs through spike-recovery tests. For example, equal volumes of a stock nanopure water spiked with 13 TrOCs (500 ng L⁻¹ each) were passed through commercially available syringe filters (e.g., PTFE, PES, PVDF, cellulose acetate) based on different active materials. Recovery was calculated by dividing the measured TrOC concentration of the filtered water by the initial concentration in the stock water. Acceptable recovery was defined to be within ±20% of the spike concentration. Based on these spike-recovery tests, we selected 15-mL polypropylene centrifuge tubes (Falcon), 5-mL Luer-Lock syringe (Fisherbrand), 0.2-μm cellulose acetate syringe filters (Chromafil Xtra), and 2-mL clear glass vials (Agilent) for batch adsorption experiments as they yielded acceptable spike-recoveries for most TrOCs, with the exceptions of PFOS, CAF, OFL, and TCPP, which resulted in variable recoveries (data not shown). The spike-recovery results greatly minimized the number of confounding variables. All batch adsorption experiments were also carried out with appropriate negative and zero-point controls.

### C. Characterization of Water Waste Effluents

Municipal wastewater effluents were acquired from the Terrance O'Brien Water Reclamation Plant in Skokie, Illinois, which treats an average of 230 Mgal per day of influents from the northeastern areas of Chicago. All effluents collected received primary and secondary treatments at the plant, but not tertiary ultraviolet (UV) disinfection treatment. Therefore, the effluents contained various concentrations of microbes, as well as background concentrations of TrOCs, which are reported in FIG. 22. Based on multiple analysis of different wastewater effluents, PFOA (4-8 ng L⁻¹), PFOS (2-5 ng L⁻¹), PFHxA (3-17 ng L⁻¹) and PFHxS (3-6 ng L−1) levels detected are similar to with the typical concentrations found in many drinking water sources, which are 1-2 orders of magnitude higher than their respective U.S. EPA health advisory limits. To our knowledge, DCF (90-179 ng L⁻¹), SUC (15-32 μg L⁻¹), CAF (20-40 μg L⁻¹), BEZ (5-27 ng L⁻¹) and the rest of TrOCs are within the expected range reported by other WWTPs in the United States.

The wastewater was also characterized for general water quality parameters including pH, DOC concentration, TDS concentration, and the concentrations of target inorganic ions. The pH of wastewater effluents ranged between 7.1 and 7.6, which is consistent with pH measurements reported by Terrance O'Brien Water Reclamation Plant.

### D. Equilibrium Removal of TrOCs

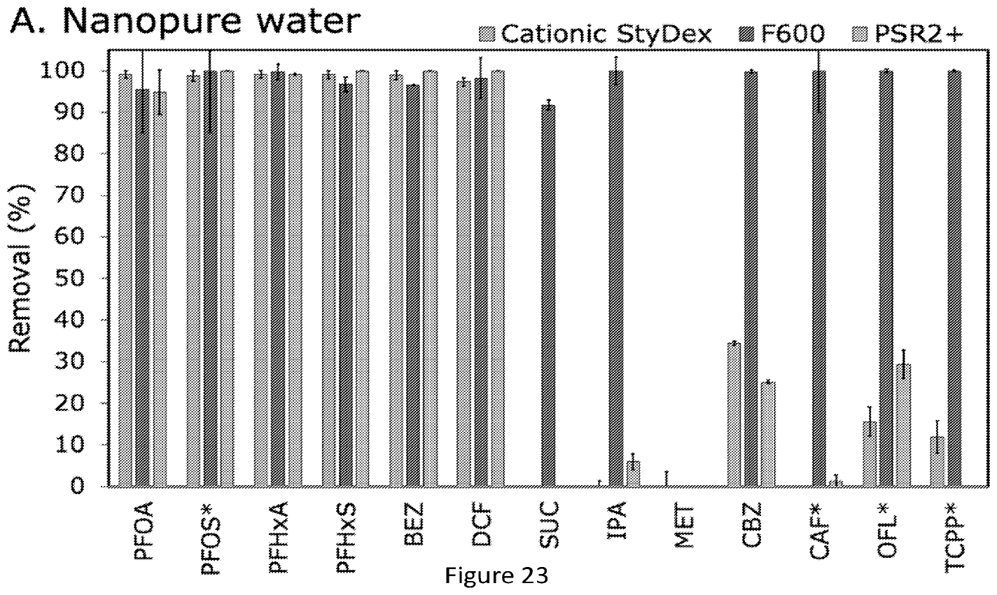

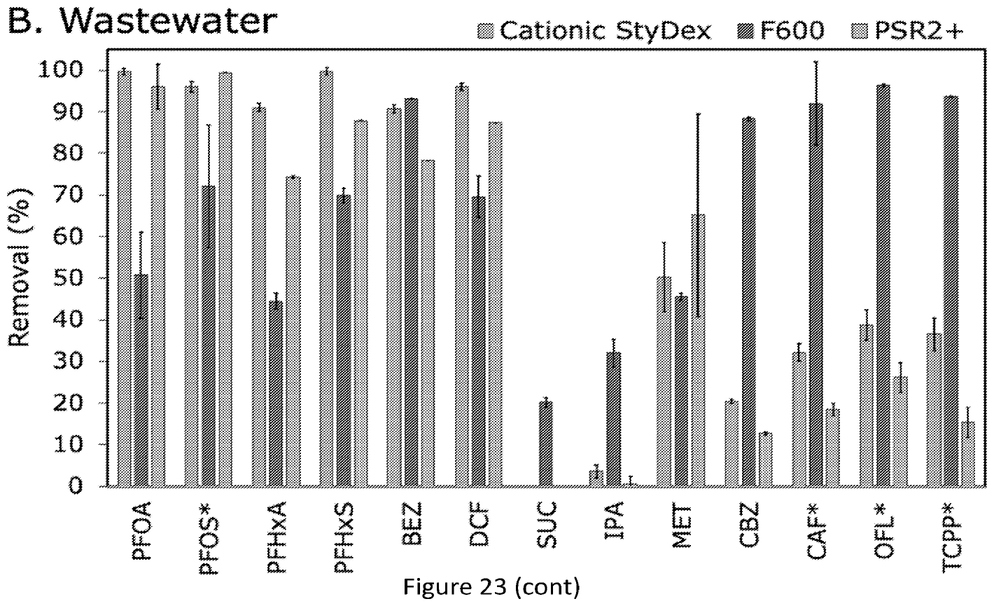

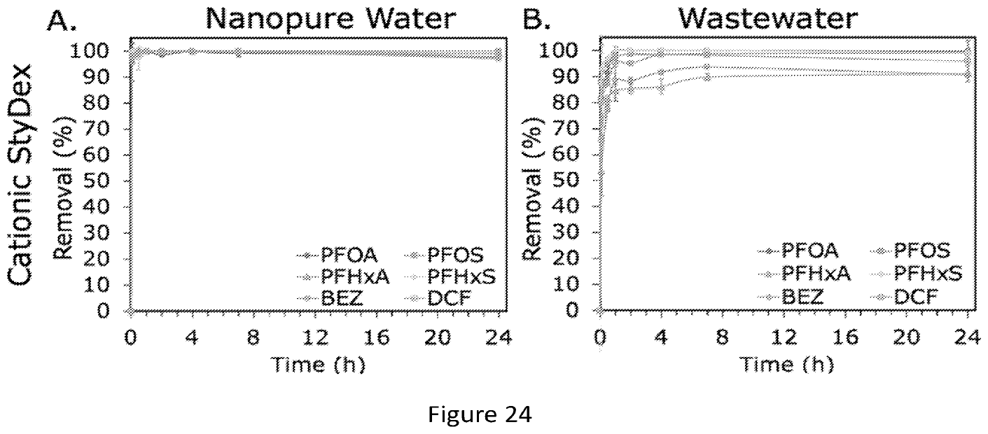

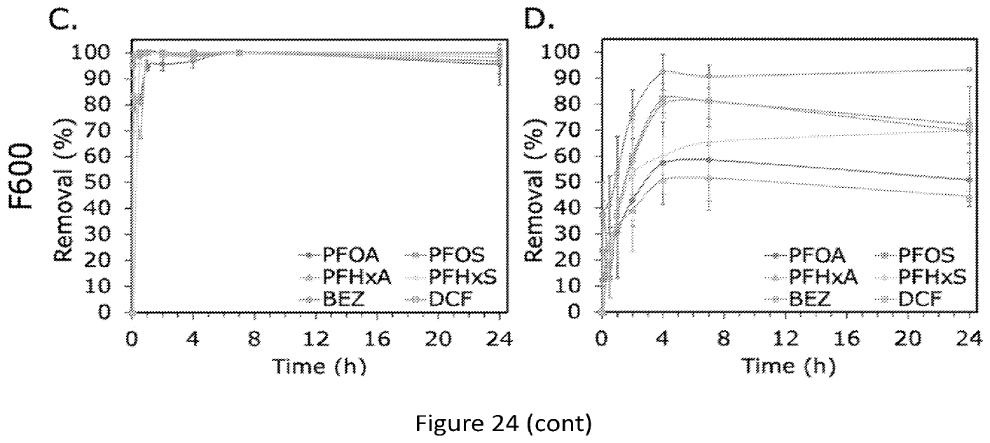

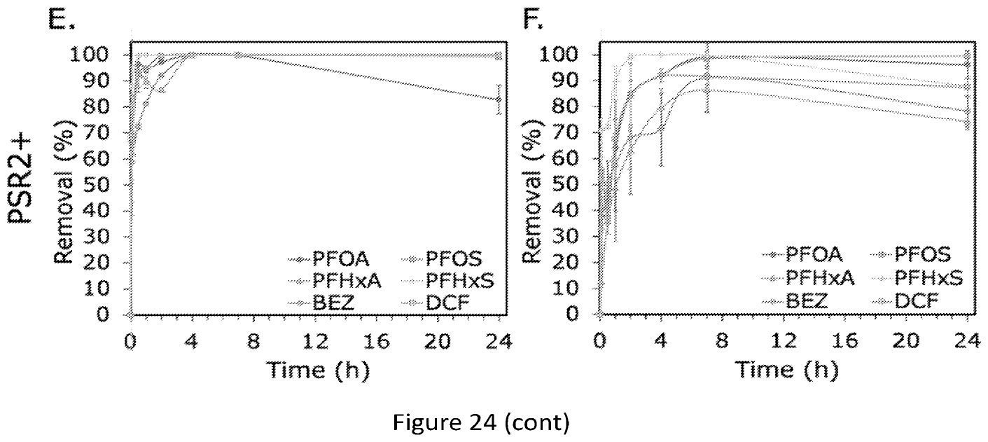

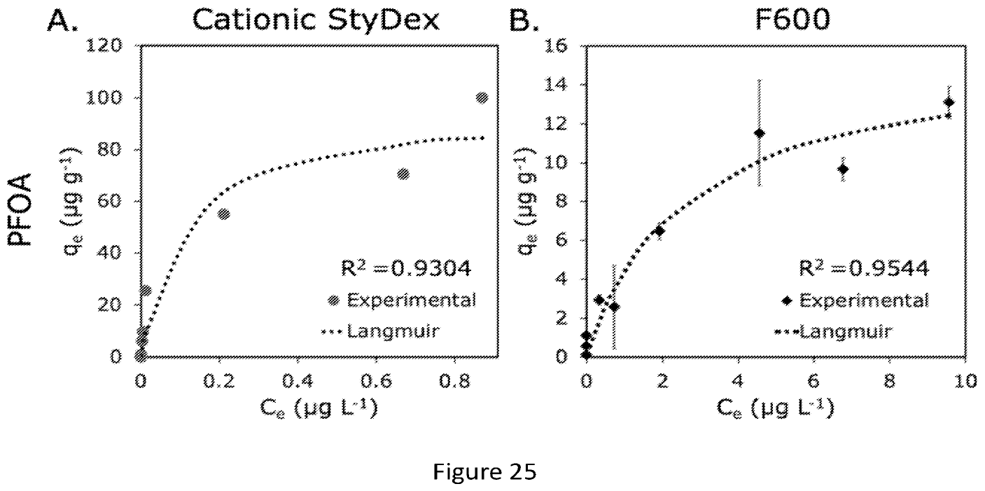

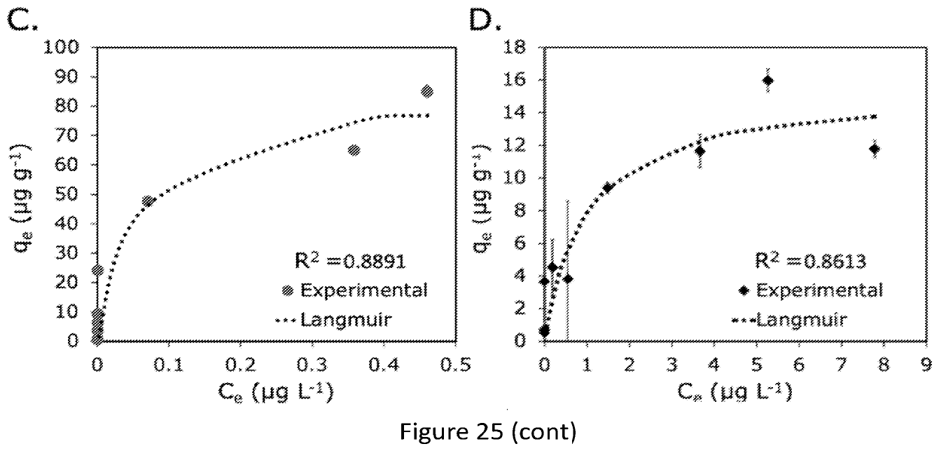

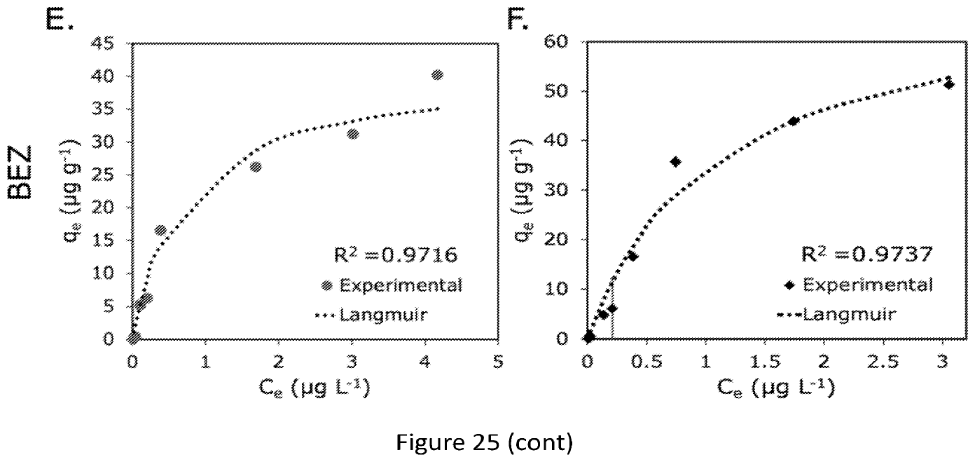

We first evaluated the equilibrium removal efficiencies of 100 mg L⁻¹ Cationic StyDex, F600, and PSR2+ for 13 TrOCs (spiked 500 ng L⁻¹ each) in nanopure water and Pre-UV disinfected municipal wastewater following a 24 h contact time at room temperature. This contact time was sufficient to reach equilibrium removal, based on similar removal efficiencies observed in samples with 48 h contact times. In nanopure water, Cationic StyDex performed effectively, with near 100% removal of PFOA, PFOS, PFHxA, PFHxS, BEZ, and DCF (FIG. 23A). We attribute the effective removal of Cationic StyDex to its permanent positively charged ammonium groups that electrostatically attract anionic TrOCs, as well as polymer surfaces and β-CD cavities that form hydrophobic interactions with TrOCs. However, Cationic StyDex exhibited little to no removal of SUC (log K_{ow}: −0.5), IPA (log K_{ow}: −3.1), MET (log K_{ow}: −2.6), CAF (log K_{ow}: −0.6), OFL (log K_{ow}: −0.4) and TCPP (n/a), which are relatively more hydrophilic compounds with negative log Kow values than PFAS (log K_{ow}: 3.2-5.1), BEZ (log K_{ow}: 4.3), and DCF (log K_{ow}: 4.3) (FIG. 22). Interestingly, CBZ has a log K_{ow} of 2.8, suggesting that it can also be effectively removed through hydrophobic interactions. However, CBZ removal efficiency was 35% in nanopure water, which we attribute to a positive-positive charge repulsion between Cationic StyDex and CBZ (pKa: 13.9) that exists as mostly protonated species under neutral pH (FIG. 23A). Additionally, the lack of removal by Cationic StyDex may also be attributed by the physical size of TrOCs. For example, SUC is a bulky molecule that may exceed Cationic StyDex's typical pore width of 22 Å. PSR2+, a single-use anion exchange resin, exhibited a similar removal profile as Cationic StyDex in nanopure water, with near complete removal of PFAS, BEZ and DCF. In contrast, F600, a granular activated carbon, demonstrated effective equilibrium removal for all TrOCs except MET in nanopure water. We observed near complete removal of PFHxA and PFHxS by F600, which generally have poor affinities for shorter-chain PFAS. This result may be explained by a high adsorbent loading of 100 mg L⁻¹ and low initial PFAS concentration around 500 ng L⁻¹ in nanopure water. Although F600, PSR2+, and Cationic StyDex achieved TrOCs removal from nanopure water to similar extents, the materials behaved differently in wastewater.

The fouling of conventional adsorbents by DOM and inorganic constituents in complex water matrices remains a serious material drawback and limit wider implementations of these adsorbents. Different degrees of reduced uptake, which we associate with fouling, were observed for Cationic StyDex, F600 and PSR2+ in wastewater (FIG. 23B). Among the three adsorbents, F600 experienced the most severe removal inhibition in wastewater, such as 45% PFHxA removal from 98% in nanopure water or 70% DCF removal from 96%. The removal of SUC decreased from 92% in nanopure water to 20% wastewater due to significantly higher SUC concentration in wastewater from background sources (e.g., approximately 500 ng L⁻¹ in nanopure water vs. 15-32 g L⁻¹ wastewater). Compared to F600, PSR2+ also experienced removal inhibition in wastewater, such as 74% PFHxA removal from 99% removal in nanopure water. However, PSR2+ was not affected as much as F600. Cationic StyDex experienced the least amount of removal inhibition in wastewater, because it is believed that β-CD polymers have minimal to no interactions with DOM and inorganic constituents. We attribute this to β-CD polymers having relatively uniform and smaller pores than F600, which greatly suppress fouling mechanisms such as pore blockage. In addition, adsorption competition from non-target TrOCs and inorganic constituents that are present in wastewater may also contribute to the decreased removal performances observed for F600 and PSR2+, while Cationic StyDex remained selective towards the anionic TrOC targets. Interestingly, we also observed enhanced removal of MET from 0% for all three adsorbents in nanopure water to 50%, 48%, and 65% for Cationic StyDex, F600, and PSR2+ in wastewater. We attribute this enhanced to nonspecific interactions between MET and wastewater constituents, or chemical modification of MET by active microbes. Overall, the equilibrium removal indicated that Cationic StyDex can be a promising alternative to the benchmark adsorbents.

### E. Regenerative Studies

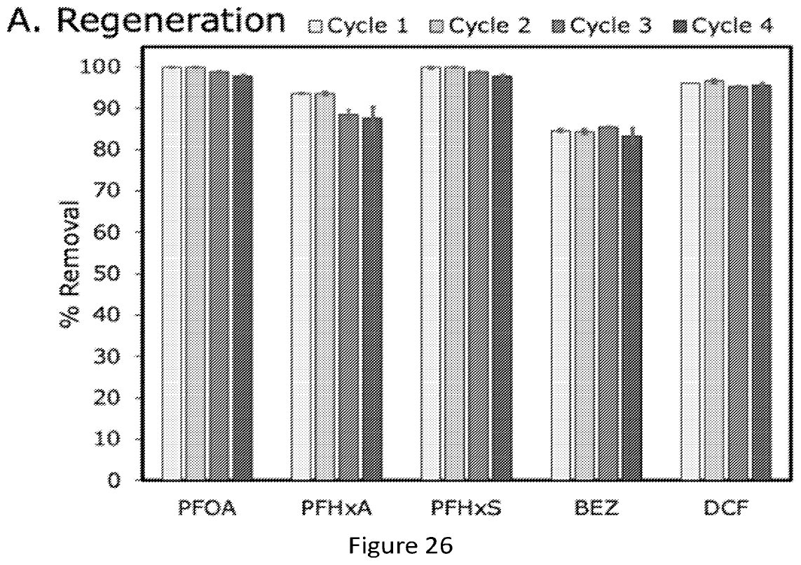

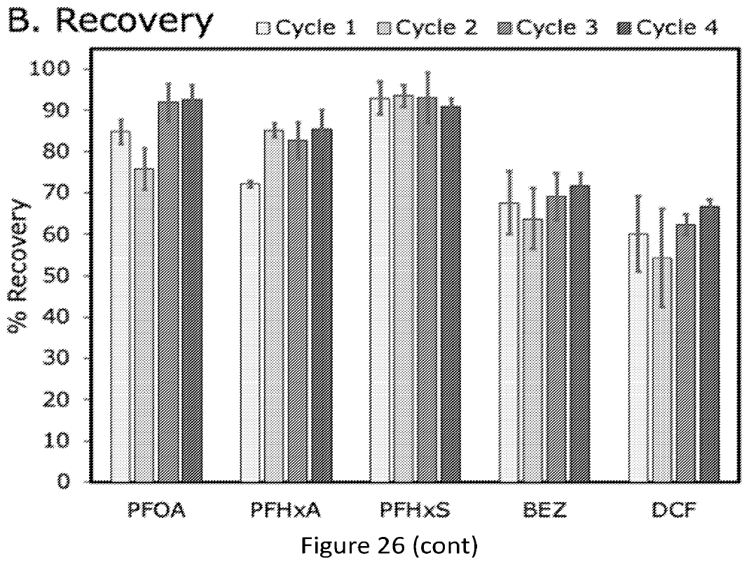

Regeneration is a critical factor when considering adsorbents for practical applications. The spent adsorbent should be readily regenerable using technically and economically feasible methods (e.g., washing with organic solvents) in contrast to the highly energy intensive and degradative regeneration method used for GACs or the single use of PSR2+. The regenerability and reuse of 100 mg L⁻¹ Cationic StyDex in wastewater over four cycles was evaluated using either methanol, ethanol or 10% NaCl brine as the regenerating media. Methanol (FIG. 26) and ethanol were found to be effective regenerating media following an overnight washing process, based on the consistent removal efficiencies of TrOCs over four cycles.

We claim:

1. A mesoporous polymeric material comprising a network of cyclodextrin moieties crosslinked by a plurality of crosslinks, the network comprising 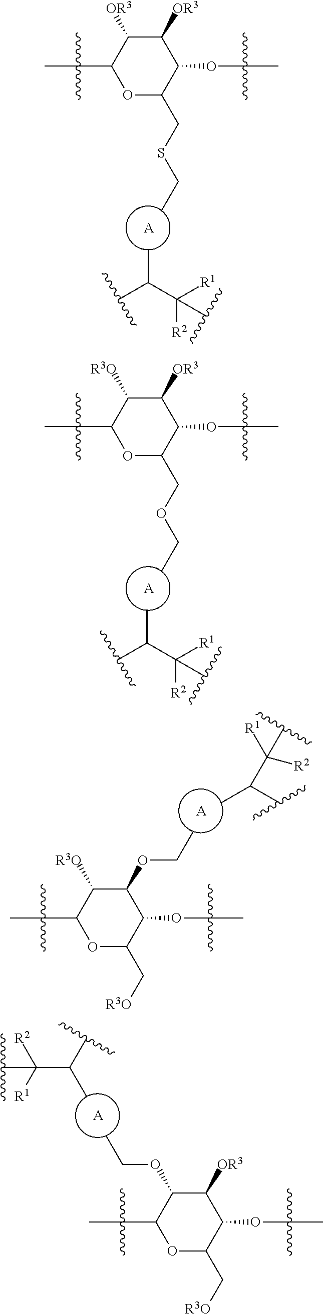 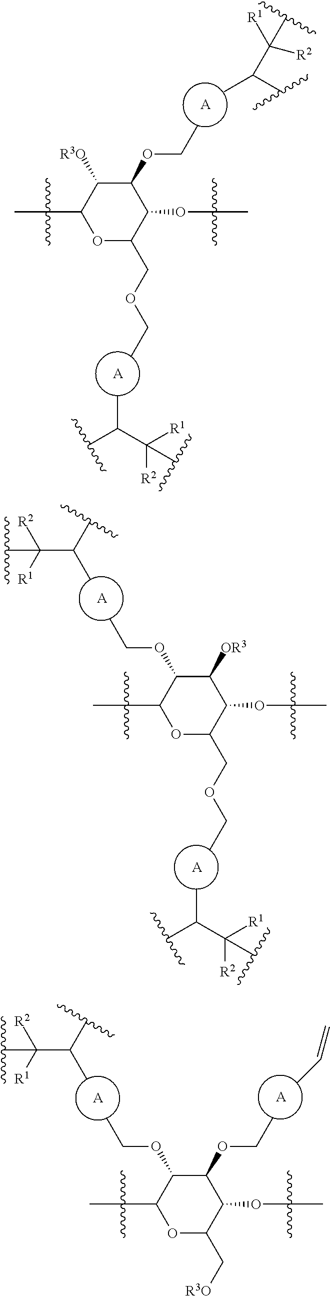 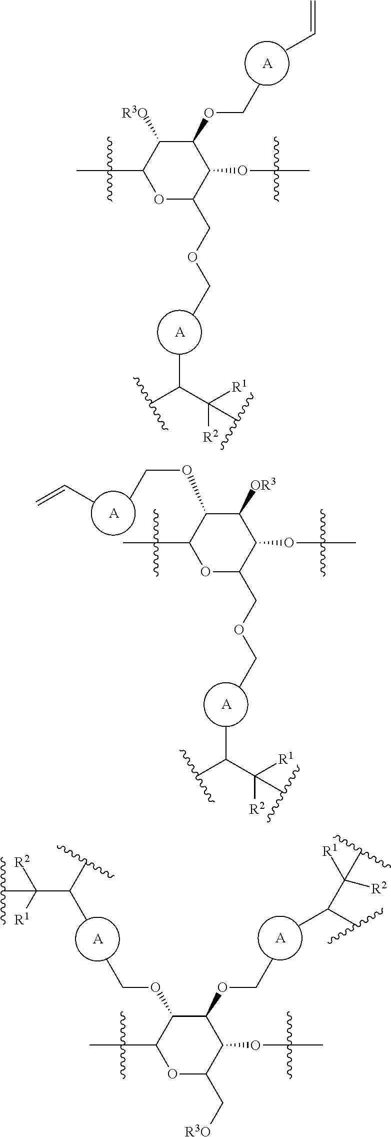 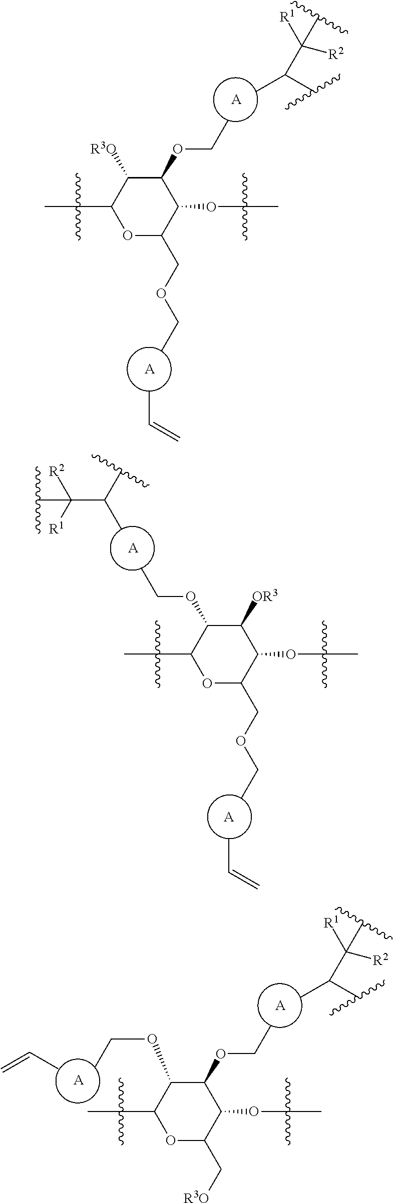 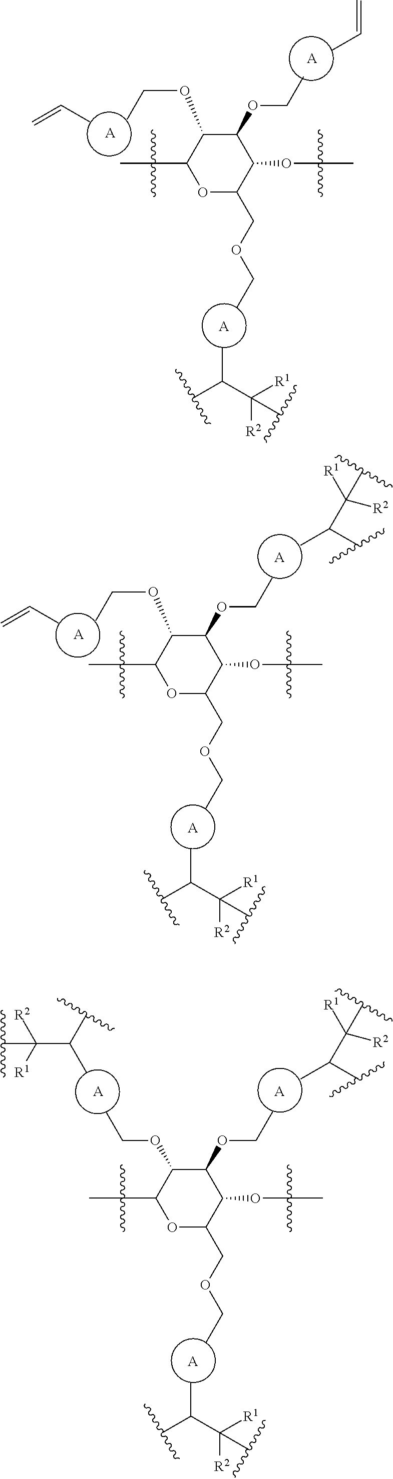 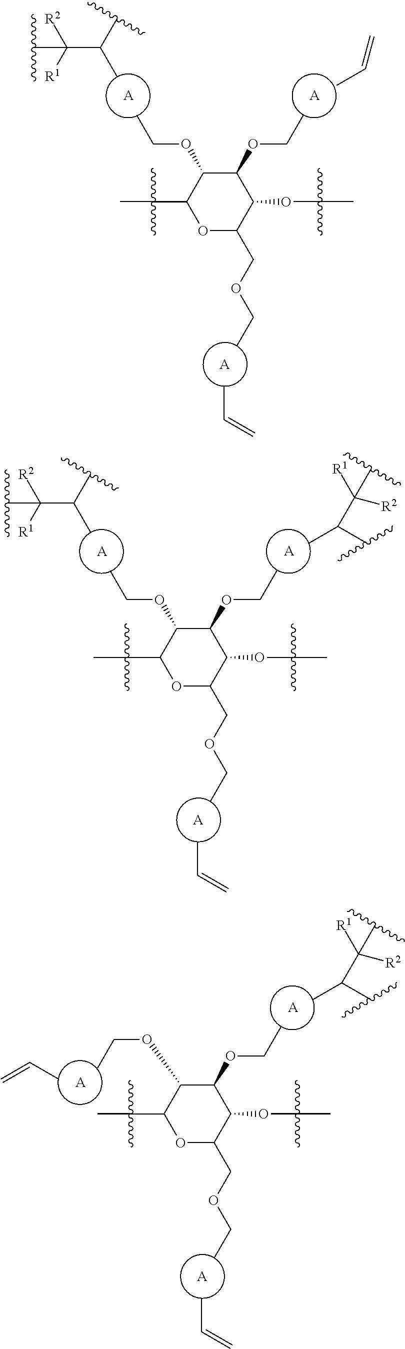 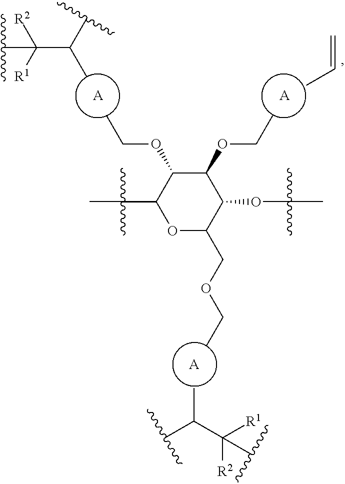
or any combination thereof, wherein—
A is an unsubstituted or substituted aryl or unsubstituted or substituted heteroaryl;
R¹ and R² are independently —C(═O)OR⁴, an unsubstituted or substituted alkyl, an unsubstituted or substituted aryl, an unsubstituted or substituted heteroaryl, or hydrogen;
R³ is independently selected from hydrogen, alkyl, hydroxyalkyl, alkanoyl, or carboxyalkyl; and
R⁴ is a substituted or unsubstituted alkyl.

2. The mesoporous polymeric material of claim 1, wherein A is phenyl.

3. The mesoporous polymeric material of any one of claims 1-2, wherein R¹ and R² are methyl and —C(═O)OCH₂CH₂N+(CH₃)₃.

4. The mesoporous polymeric material of any one of claims 1-2, wherein R¹ and R² are methyl and —C(═O)OCH₃.

5. The mesoporous polymeric material of any one of claims 1-2, wherein R¹ and R² are hydrogen and phenyl.

6. The mesoporous polymeric material of any one of claims 1-5, wherein R³ is hydrogen.

7. The mesoporous polymeric material of any one of claims 1-6, wherein the cyclodextrin moieties comprise beta-CD.

8. A mesoporous polymeric material of any one of claims 1-7, wherein A is covalently bound to the cyclodextrin through a thioether bond.

9. A mesoporous polymeric material of any one of claims 1-7, wherein A is covalently bound to the cyclodextrin through an ether bond

10. wherein the mesoporous polymeric material has a BET surface area greater than 200 m² g⁻¹.

11. A mesoporous polymeric material of any one of claims 1-10 prepared from a functionalized cyclodextrin monomer comprising 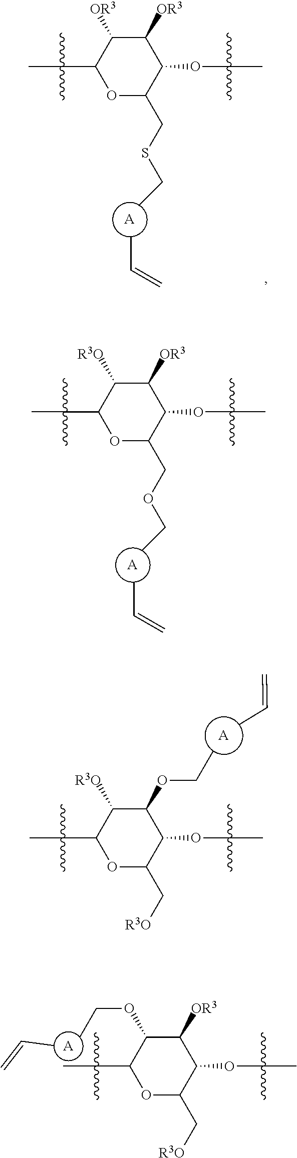 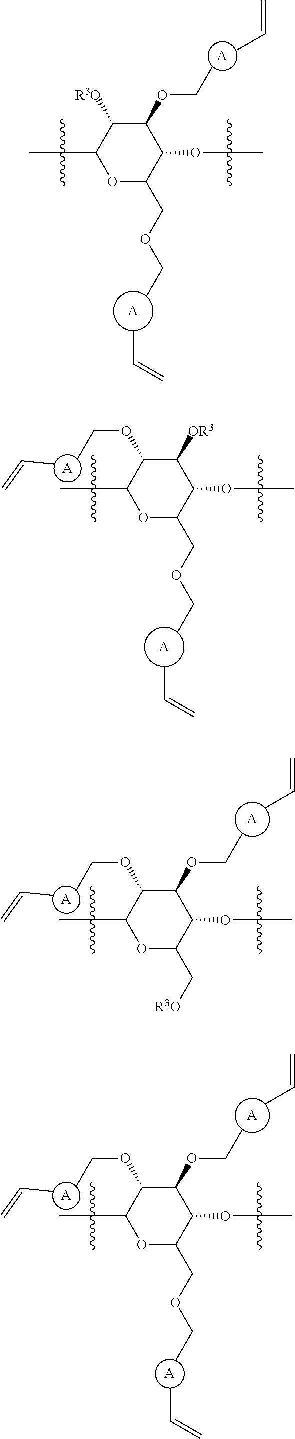
or any combination thereof, and comonomer of formula

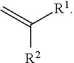

12. The mesoporous polymeric material of claim 11, wherein the comonomer and functionalized cyclodextrin monomer are incorporated into the mesoporous polymeric material in a ratio of 1:1 to 4:1

13. A method of purifying a fluid sample comprising one or more micropollutants, the method comprising contacting the fluid sample with the mesoporous polymeric material of claim 1, whereby at least 50 wt % of the total amount of the one or more pollutants in the fluid sample is adsorbed by the mesoporous polymeric material.

14. The method of claim 13, wherein the pollutant is an anionic micropollutant.

15. The method of claim 13, wherein the anionic micropollutant is a perfluorinated alkyl compound.

16. The method of claim 15, wherein the perfluorinated alkyl compound is selected from a perfluorocarboxylic acid, a perfluorosulfonic acid, or combinations thereof.

17. The method of any one of claims 13-16, wherein the mesoporous polymeric material is the material of any one of claims 2-12.

18. A method of preparing a mesoporous polymeric material comprising a network of cyclodextrin moieties crosslinked by a plurality of crosslinks, the method comprising contacting a functionalized cyclodextrin monomer with a comonomer in the presence of a free radical initiator under conditions sufficient to prepare the network of cyclodextrin moieties crosslinked by a plurality of crosslinks,
wherein the functionalized cyclodextrin monomer comprises 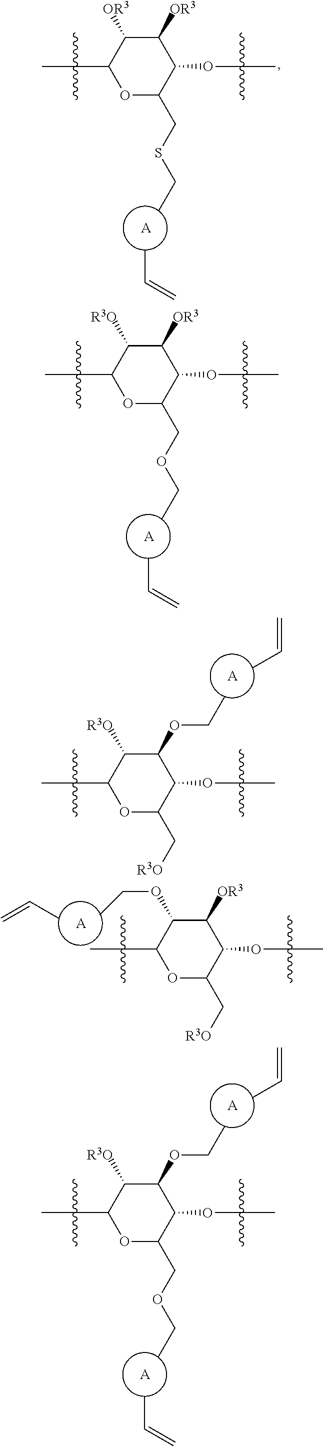 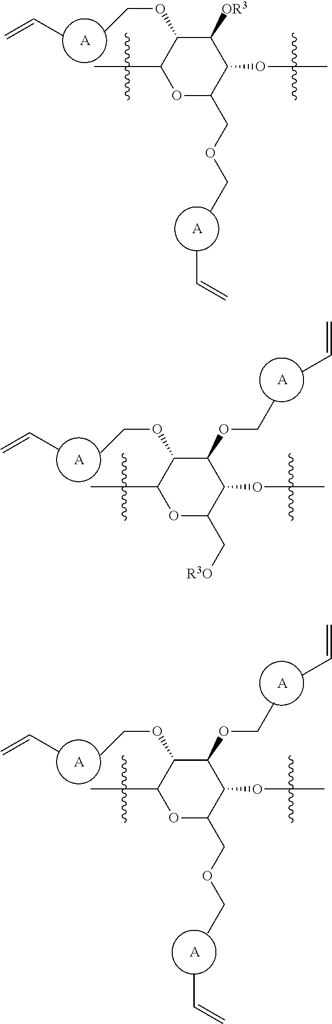
or any combination thereof and the comonomer comprises formula 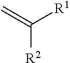
wherein A is an unsubstituted or substituted aryl or unsubstituted or substituted heteroaryl;
wherein R¹ and R² are independently —C(═O)OR⁴, an unsubstituted or substituted alkyl, an unsubstituted or substituted aryl, an unsubstituted or substituted heteroaryl, or hydrogen;
wherein R³ is independently selected from hydrogen, alkyl, hydroxyalkyl, alkanoyl, or carboxyalkyl; and
wherein R⁴ is a substituted or unsubstituted alkyl.

19. The method of claim 15, wherein A is phenyl.

20. The method of any one of claims 18-19, wherein R¹ and R² are methyl and —C(═O)OCH₂CH₂N+(CH₃)₃.

21. The method of any one of claims 18-19, wherein R¹ and R² are methyl and —C(═O)OCH₃.

22. The method of any one of claims 18-19, wherein R¹ and R² are hydrogen and phenyl.

23. The method of any one of claims 18-22, wherein R³ is hydrogen.

24. The method of any one of claims 18-23, wherein the cyclodextrin moieties comprise beta-CD.

25. The method of any one of claims 18-24, wherein A is covalently bound to the cyclodextrin moiety through a thioether bond.

26. The method of any one of claims 18-24, wherein A is covalently bound to the cyclodextrin moiety through an ether bond.

27. The method of any one of claims 18-26, wherein the network comprises the network according to claim 1.

28. The method of any one of claims 18-27, wherein the comonomer and functionalized cyclodextrin monomer are incorporated in a ratio of 1:1 to 4:1.

29. The method of any one of claims 18-28, wherein the free radical initiator is 2,2′-Azobis(2-methylpropionitrile (AIBN).

30. The method of any one of claims 18-29, wherein the molar ratio of the functionalized cyclodextrin monomer to the comonomer is from 1:10 to 2:1.

31. The method of any one of claims 18-30, wherein the conditions comprise a reaction temperature from 40° C. to 100° C.

32. The method of any one of claims 18-31, wherein the conditions comprise a reaction time of less than 1.5 hours.

33. The method of any one of claims 18-32, wherein the conditions comprise a reaction solvent selected from dimethylformamide.

34. The method of any one of claims 18-33, wherein the network of cyclodextrin moieties crosslinked by a plurality of crosslinks is produced in a yield of greater than 90%.

35. The method of any one of claims 18-34, further comprising extracting the network of cyclodextrin moieties crosslinked by a plurality of crosslinks in methanol.

36. The method of any one of claims 18-35, further comprising activating the network of cyclodextrin moieties crosslinked by a plurality of crosslinks with supercritical carbon dioxide.
